(19) United States
(12) Patent Application Publication
(10) Pub. No.: US 2015/0312851 A1
(43) Pub. Date: Oct. 29, 2015

(54) WIRELESS COMMUNICATION SYSTEM, WIRELESS TERMINAL, AND WIRELESS COMMUNICATION METHOD

(71) Applicant: FUJITSU LIMITED, Kawasaki-shi (JP)

(72) Inventor: Takayoshi ODE, Yokohama (JP)

(21) Appl. No.: 14/670,058

(22) Filed: Mar. 26, 2015

(30) Foreign Application Priority Data
Apr. 24, 2014 (JP) 2014-090747

(51) Int. Cl. H04W 48/20; H04W 56/00; H04W 24/08

(52) U.S. Cl. CPC H04W 48/20; H04W 24/08; H04W 56/001

(57) ABSTRACT

A wireless communication system including: at least one base station configured to form each of at least one first cell being a cell to which a wireless terminal is able to couple without coupling to another cell and each of at least one second cell being a cell to which a wireless terminal is unable to couple without coupling to another cell, and a specific wireless terminal configured to: identify, when the specific wireless terminal couples to no cell, at least one known signal being at least a part of at least one first known signal based on a first rule, the at least one known signal being received from the at least one first cell, select a cell being one of the at least one first cell based on the identified at least one known signal, and couple to the selected cell.

### CROSS-REFERENCE TO RELATED APPLICATION

This application is based upon and claims the benefit of priority of the prior Japanese Patent Application No. 2014-090747, filed on Apr. 24, 2014, the entire contents of which are incorporated herein by reference.

### FIELD

The embodiments discussed herein are related to a wireless communication system, a wireless terminal, and a wireless communication method.

### BACKGROUND

In a mobile communication system such as Long Term Evolution (LTE) in the related art, as a cell selection process, a cell (base station) that a terminal connects to or camps on based on wireless quality is selected (for example, refer to Japanese National Publication of International Patent Application Publication No. 7-509826, International Publication Pamphlet No. WO 2011/087022, Japanese Laid-open Patent Publication No. 2011-124732, and International Publication Pamphlet No. WO 2010/134202). Furthermore, carrier aggregation (CA) that performs communication using a primary cell and a secondary cell at the same time is known.

### SUMMARY

According to an aspect of the invention, a wireless communication system includes at least one base station configured to form a plurality of cells including at least one first cell and at least one second cell, each of the at least one first cell being a cell to which a wireless terminal is able to couple without coupling to another cell, each of the at least one second cell being a cell to which a wireless terminal is unable to couple without coupling to another cell, each of the at least one first cell being a cell in which each of at least one first known signal is transmitted in accordance with a first rule, each of the at least one second cell being a cell in which each of at least one second known signal is transmitted in accordance with a second rule, and a specific wireless terminal configured to: identify, when the specific wireless terminal couples to no cell, at least one known signal being at least a part of the at least one first known signal based on the first rule, the at least one known signal being received from the at least one first cell, select a cell being one of the at least one first cell based on the identified at least one known signal, and couple to the selected cell being one of the at least one first cell.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating one example of a system according to a first embodiment;

FIG. 1B is a diagram illustrating one example of a signal flow in the system illustrated in FIG. 1A.

FIG. 1C is a diagram illustrating a modification example of the system according to the first embodiment.

FIG. 1D is a diagram illustrating one example of the signal flow in the system illustrated in FIG. 1C.

FIG. 2 is a diagram illustrating one example of a communication system according to a second embodiment.

FIG. 3A is a diagram illustrating an example 1 of a carrier aggregation.

FIG. 3B is a diagram illustrating an example 2 of the carrier aggregation.

FIG. 3C is a diagram illustrating an example 3 of the carrier aggregation.

FIG. 4A is a diagram illustrating an example 1 of a P cell and an S cell.

FIG. 4B is a diagram illustrating an example 2 of the P cell and S cell.

FIG. 4C is a diagram illustrating an example 3 of the P cell and S cell.

FIG. 5A is a diagram illustrating one example of a hierarchical cell configuration.

FIG. 5B is a diagram illustrating one example of a carrier aggregation in the hierarchical cell configuration.

FIG. 6A is a diagram illustrating an example 1 of a base station that is the S cell.

FIG. 6B is a diagram illustrating an example 2 of the base station that is the S cell.

FIG. 6C is a diagram illustrating an example 3 of the base station that is the S cell.

FIG. 7A is a diagram illustrating one example of contention-based random access.

FIG. 7B is a diagram illustrating one example of noncontention-based random access.

FIG. 8A is a diagram illustrating one example of a base station according to a second embodiment.

FIG. 8B is a diagram illustrating one example of a signal flow in the base station illustrated in FIG. 8A.

FIG. 8C is a diagram illustrating one example of a hardware configuration of the base station according to the second embodiment.

FIG. 9A is a diagram illustrating one example of a terminal according to the second embodiment.

FIG. 9B is a diagram illustrating one example of a signal flow in the terminal illustrated in FIG. 9A.

FIG. 9C is a diagram illustrating one example of a hardware configuration of the terminal according to the second embodiment.

FIG. 10 is a flowchart illustrating one example of P cell connection processing by the terminal according to the second embodiment.

FIG. 11 is a flowchart illustrating a modification example 1 of the P cell connection processing by the terminal according to the second embodiment.

FIG. 12 is a flowchart illustrating one example of S cell connection processing by the terminal according to the second embodiment.

FIG. 13 is a flowchart illustrating one example of the S cell selection processing by the base station (P cell) according to the second embodiment.

FIG. 14 is a flowchart illustrating a modification example of the S cell connection processing by the terminal according to the second embodiment.

FIG. 15 is a diagram illustrating one example of allocation of a cell ID to a P cell and an S cell.

FIG. 16 is a flowchart illustrating one example of the cell connection processing by a terminal according to a third embodiment.

FIG. 17 is a flowchart illustrating one example of the cell connection processing that is performed when the terminal according to the third embodiment makes a cell reselection.

FIG. 18 is a flowchart illustrating one example of the S cell selection processing by a base station (P cell) according to the third embodiment.

FIG. 19A is a diagram illustrating one example of the information on an appropriate use of the cell ID's for every position-registered area.

FIG. 19B is a diagram illustrating one example of movement of the terminal in position-registered areas.

FIG. 20A is a diagram illustrating one example of a base station according to a fourth embodiment.

FIG. 20B is a diagram illustrating one example of a flow signal in the base station illustrated in FIG. 20A.

FIG. 21A is a diagram illustrating one example of a terminal according to the fourth embodiment.

FIG. 21B is a diagram illustrating one example a signal flow in the terminal illustrated in FIG. 21A.

FIG. 22A is a diagram illustrating one example of a reception wireless unit.

FIG. 22B is a diagram illustrating one example of the signal flow in the reception wireless unit illustrated in FIG. 22A.

FIG. 23 is a flowchart illustrating one example of the P cell connection processing by the terminal according to the fourth embodiment.

FIG. 24 is a flowchart illustrating a modification example of the P cell connection process by the terminal according to the fourth embodiment.

FIG. 25 is a flowchart illustrating one example of the S cell connection processing by the terminal according to the fourth embodiment.

FIG. 26 is a flowchart illustrating a modification example 1 of the S cell connection processing by the terminal according to the fourth embodiment.

FIG. 27 is a flowchart illustrating a modification example 2 of the S cell connection processing by the terminal according to the fourth embodiment.

### DESCRIPTION OF EMBODIMENTS

In the described-above technology in the related art, there is a case where erroneous cell selection occurs in a terminal, for example, such as when a cell that does not correspond to connection to or camping-on of a primary cell is selected as the primary cell. That is, there is a case where the erroneous cell selection occurs, such as when a cell that is not suitable for the connection or camping-on is selected.

An object of one aspect of the embodiments is to provide a system, a base station, and a terminal that may suppress erroneous cell selection.

Furthermore, an object of another aspect of the embodiments is to provide a system, a base station, and a terminal that are capable of selecting a suitable cell.

Furthermore, an object of another aspect of the embodiments is to provide a system, a base station, and a terminal that may select a suitable type of cell from among various types of cells.

The system, the base station, and the terminal according to the embodiments will be described in detail below referring to the drawings.

### First Embodiment

### System According to a First Embodiment

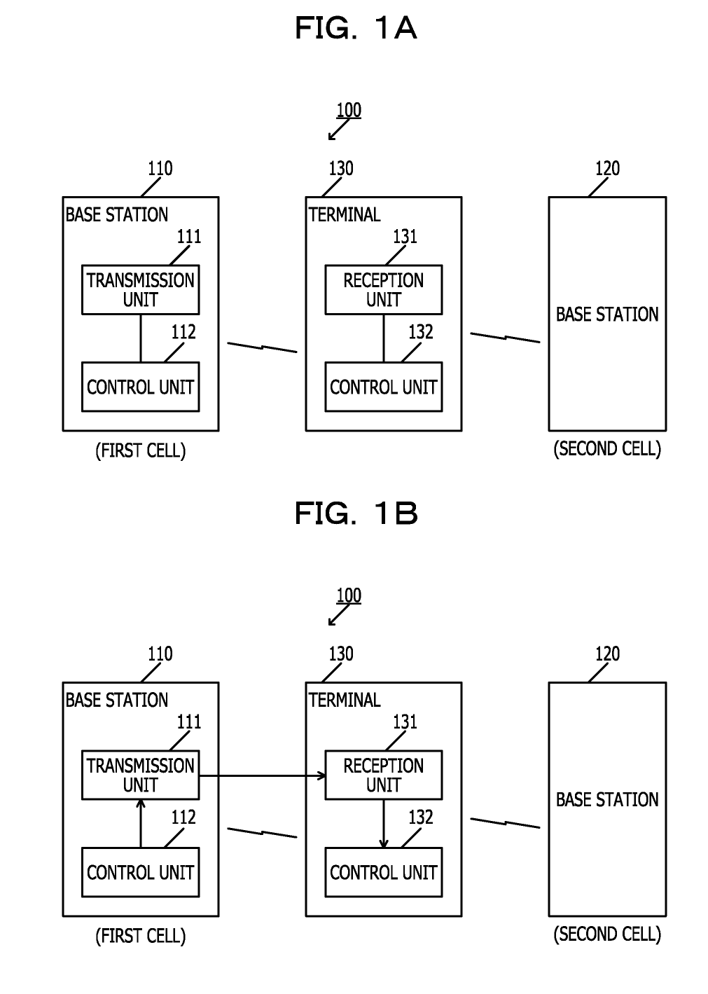

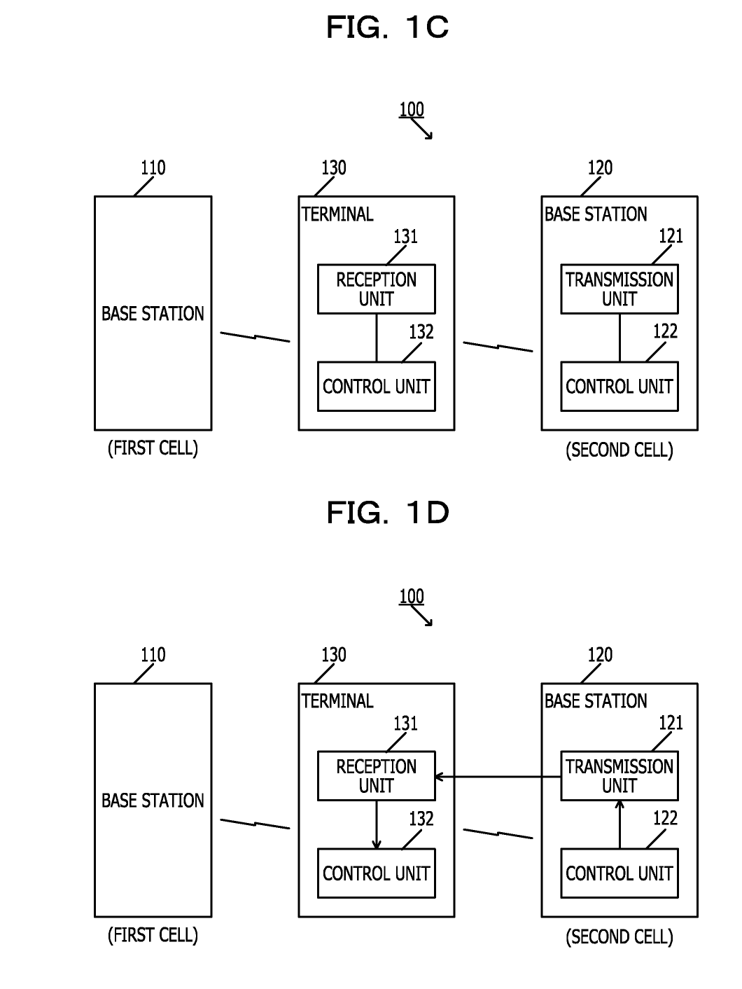

FIG. 1A is a diagram illustrating one example of a system according to a first embodiment. FIG. 1B is a diagram illustrating one example of a signal flow in the system illustrated in FIG. 1A. As illustrated in FIGS. 1A and 1B, a system 100 according to the first embodiment includes a base station 110, a base station 120, and a terminal 130.

In the system 100, the terminal 130 performs wireless communication that uses a first type cell and a second type cell at the same time. The wireless communication is communication that, at the same time, uses multiple cells (or bands) like carrier aggregation as one example. The first type cell is a cell that is available for connection in a stand-alone manner without accompanying a different cell. The second type cell is a cell that is available for connection by accompanying the first type cell and is not available for connection in a stand-alone manner.

In the system 100, one or more first resources are allocated to the first type cell, and one or more second resources are allocated to the second type cell. The second resource is a resource different from the first resource.

For example, the resource is cell identification information. In this case, the first resource is one or more pieces of first identification information, and the second resource is one or more pieces of second identification information that is different from the first identification information. The cell identification information is, for example, cell ID.

Furthermore, the resource may be a parameter in accordance with the cell identification information. In this case, the first resource is one or more first parameters, and the second resource is one or more second parameters that are different from the first parameters. The parameter in accordance with the cell identification information is a value that is calculable, for example, from the cell ID and, as one example, is a value that is equivalent to a quotient or an error that results from dividing the cell ID by a predetermined value.

Furthermore, the resource may be a cell frequency (frequency band). In this case, the first resource is one or more first frequencies, and the second resource is one or more second frequencies that are different from the first frequencies.

The base station 110 is a first base station that forms a first cell of a first type. The base station 110 includes a transmission unit 111 and a control unit 112. By the first cell, the transmission unit 111 transmits a synchronization signal that is based on a resource allocated to the first cell, among the first resources described above. In a case where the terminal 130 selects the first cell as the first type cell for wireless communication, the control unit 112 controls connection of the terminal 130 to the first cell. The control of the connection by the control unit 112 may be performed for example through the transmission unit 111.

The base station 120 is a second base station that is different, for example, from the base station 110. The base station 120 forms a second cell of a second type.

The terminal 130 includes a reception unit 131 and a control unit 132. The reception unit 131 receives the synchronization signal transmitted from the base station 110. Then, the reception unit 131 outputs the received synchronization signal to the control unit 132.

The control unit 132 selects as the first type cell for wireless communication the first cell that is formed by the base station 110, based on the synchronization signal being output from the reception unit 131 and on allocation information indicating allocation of the first resource to the first type cell, and controls the connection of the terminal 130 to the first cell. Furthermore, the control unit 132 selects as the second type cell for wireless communication a second cell that is formed by the base station 120, and controls connection of the terminal 130 to the second cell. Accordingly, the terminal 130 may perform the wireless communication that uses the first type cell and the second type cell at the same time.

In this manner, by the first cell, the base station 110 according to the first embodiment transmits the synchronization signal that is based on the resource allocated to the first cell, among the first resources. Accordingly, by using the allocation information indicating allocation of the first resource to the first type cell, the terminal 130 makes sure that the first resource is the first type cell and may select the first cell as the first type cell for connection. For this reason, the erroneous selection of the first type cell may be suppressed in the terminal 130, for example, such as when the second cell that is not available for connection in a stand-alone manner is selected as a first type. That is, a suitable cell may be selected.

With the suppression of the erroneous cell selection or with the selection of the suitable cell, for example, a failure in the connection may be suppressed and efficiency in the communication may be accomplished. For example, cell reselection, handover processing, or the like in the terminal 130 and the base stations 110 and 120 may be suppressed and transmission speed may be kept from decreasing.

Relationship Between Each Base Station

The case where the base station 110 forms the first cell of the first type, and the base station 120 that is different from the base station 110 forms the second cell of the second type is described, but the base station 120 may be the same as the base station 110. That is, for example, the base station 110 may form the first cell of the first type and the second cell of the second type. In this case, the terminal 130 performs the wireless communication using the first cell and the second cell that are formed by the base station 110.

Furthermore, in a case where the base station 110 and the base station 120 are different base stations, the base station 120, for example, is a base station that is installed within a cell formed by the base station 110 and forms a cell smaller than a cell formed by the base station 110. However, a configuration is not limited to this, and for example, the base station 110 may be a base station that is installed within the cell formed by the base station 120 and forms a cell smaller than a cell formed by the base station 120. Furthermore, the base station 110 may be a base station that forms a cell of which at least a portion overlaps the cell formed by the base station 120.

First Type Cell and Second Type Cell

As one example, in a case where the system 100 is applied to an LTE system, the described-above first type cell may be defined, for example, as a primary cell (a first cell, a first band, a primary band, a primary cell (a main cell, or a master cell), or the like). Furthermore, the second type cell may be defined, for example, as a secondary cell (a second cell, a secondary band, a sub-band, a sub-cell, an extended band, an extended cell or the like).

Moreover, a certain cell may be a first type cell and a second type cell. Furthermore, a certain cell may be a first type cell for a certain terminal and a second type cell for another terminal.

Selection of the First Type Cell that is Based on Wireless Channel Quality

Furthermore, a case where multiple first type cells that are available for the connection to the terminal 130 are present is described. The multiple first type cells are formed by one base station 110 or two or more base stations 110. In this case, based on the synchronization signal transmitted from the base station 110 and the described-above allocation information, the terminal 130 identifies the multiple first type cells and measures each wireless channel quality of the identified multiple first type cells in the terminal 130.

Then, based on a result of the measurement of each wireless quality, the terminal 130 selects the first type cell that is a connection target for wireless communication, from among the multiple first type cells. Accordingly, a cell that has good wireless quality may be selected as the first type cell for wireless communication, from among the multiple first type cells, and an improvement in communication quality may be accomplished.

Selection of the Second Type Cell in the Terminal

By the second cell, the base station 120 may transmit the synchronization signal that is based on the resource allocated to the second cell, among the described-above second resources. In contrast, based on the synchronization signal transmitted from the base station 120 and the information indicating the allocation of the second source to the second type cell, the terminal 130 selects the second cell that is formed by the base station 120, as the second type cell for wireless communication.

Selection of the Second Type Cell that is Based on the Wireless Channel Quality

A case where multiple second type cells that the terminal 130 may select are present is described. The multiple second type cells are formed by one base station 120 or two or more base stations 120. Based on the synchronization signal transmitted from the base station 120 and the described-above allocation information, the terminal 130 identifies the multiple second type cells and measures each wireless channel quality of the identified multiple second type cells in the terminal 130.

Then, based on the result of the measurement of each wireless quality, the terminal 130 selects the second type cell for wireless communication, from among the multiple second type cells. Accordingly, a cell that has good wireless quality may be selected as the second type cell for wireless communication, from among the multiple second type cells, and the improvement in the communication quality may be accomplished.

Furthermore, the terminal 130 may transmit the result of the measurement of each wireless quality to the base station 110. In contrast, based on the result of the measurement transmitted from the terminal 130, the base station 110 selects the second type cell for wireless communication from among the multiple second type cells. Then, the base station 110 notifies the terminal 130 of the selected cell. The terminal 130 selects the cell notified from the base station 110 as the second type cell. Accordingly, a cell that has good wireless quality may be selected as the second type cell for wireless communication, from among the multiple second type cells, and the improvement in the communication quality may be accomplished. Moreover, the multiple cells may be selected as the second type cell.

Relationship Between First Frequency and Second Frequency

In a case where, as described above, the resource is a frequency, the first frequency for the first cell (large-sized cell) formed by the base station 110, for example, may be set to be a frequency lower than the second frequency for the second cell (small-sized cell) formed by the base station 120. Accordingly, a low frequency that has a longer propagation distance is allocated to a large cell, and thus an improvement in communication efficiency may be accomplished.

FIG. 1C is a diagram illustrating a modification example of the system according to the first embodiment. FIG. 1D is a diagram illustrating one example of a signal flow in the system illustrated in FIG. 1C. In FIGS. 1C and 1D, portions that are the same as those in FIGS. 1A and 1B are given the same reference numerals, and descriptions of them are omitted. The base station 120 includes a transmission unit 121 and a control unit 122.

By the second cell, the transmission unit 121 transmits to the second cell the synchronization signal that is based on the resource allocated to the second cell, among the described-above second resources. In a case where the terminal 130 selects the second cell as the second type cell for wireless communication, the control unit 122 controls the connection of the terminal 130 to the second cell. The control of the connection by the control unit 122 may be performed for example, through the transmission unit 121.

The reception unit 131 of the terminal 130 receives the synchronization signal transmitted from the base station 120. Then, the reception unit 131 outputs the received synchronization signal to the control unit 132. The control unit 132 selects as the first type cell for wireless communication the first cell that is formed by the base station 110, and controls the connection of the terminal 130 to the first cell. Furthermore, the control unit 132 selects as the second type cell for wireless communication the second cell that is formed by the base station 120, based on the synchronization signal being output from the reception unit 131 and on allocation information indicating allocation of the second resource to the second type cell, and controls the connection of the terminal 130 to the second cell. Accordingly, the terminal 130 may perform the wireless communication that uses the first type cell and the second type cell at the same time.

In this manner, by the second cell, the base station 120 according to the first embodiment may transmit the synchronization signal that is based on the resource allocated to the second cell, among the second resources. Accordingly, the terminal 130 makes sure that the second cell is the second type cell, and may select the second cell as the second type cell for connection. For this reason, the erroneous selection of the second type cell may be suppressed in the terminal 130, for example, such as when the first cell that is available for connection in a stand-alone manner is selected as the second type. That is, a suitable cell may be selected.

With the suppression of the erroneous cell selection or with the selection of the suitable cell, for example, the failure in the connection may be suppressed and the efficiency in the communication may be accomplished. For example, cell reselection, handover processing, or the like in the terminal 130 and the base stations 110 and 120 may be suppressed and transmission speed may be kept from decreasing.

### Second Embodiment

For example, specifications for the LTE system and the LTE-Advanced system are currently under study in the 3rd Generation Partnership Project (3GPP). Specifications for the LTE system are established as LTE release 8. Additionally, the LTE-Advanced system, which is an advancement over the LTE system, is under study, and initial specifications for the LTE-Advanced system is created as LTE release 10. Additionally, in the 3GPP, LTE release 12 and the like, which is a successor to LTE release 10, is under study.

Communication System According to a Second Embodiment

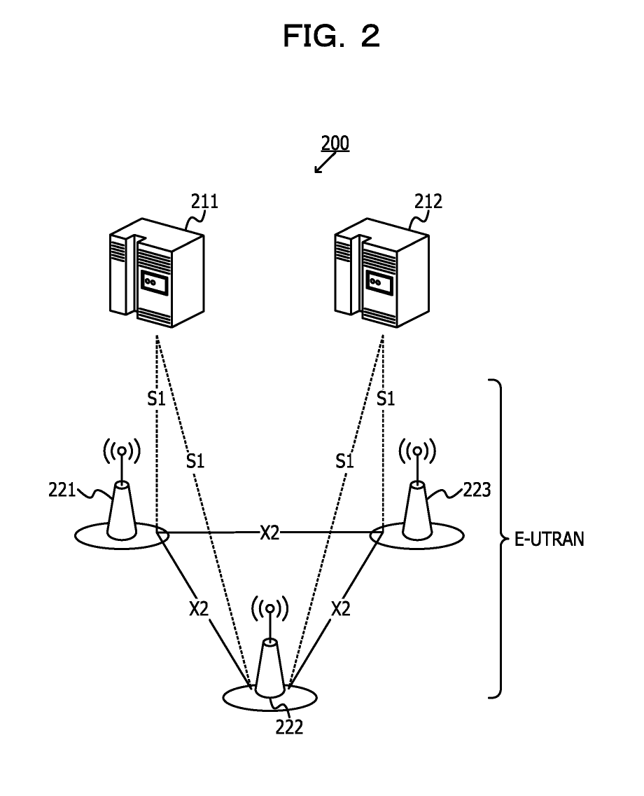

FIG. 2 is a diagram illustrating one example of a communication system according to a second embodiment. As illustrated in FIG. 2, a communication system 200 according to the second embodiment is an LTE system-Advanced (LTE release 10) that includes MME/S-GWs 211 and 212 and base stations 221 to 223 (eNB). Furthermore, the communication system 200 may include a terminal (user equipment (UE)) that performs the wireless communication between the terminal and each of the base stations 221 to 223.

Each of the MME/S-GWs 211 and 212 includes functions of a mobility management entity (MME) and a serving gateway (S-GW) in the LTE system. Furthermore, the MME/S-GW 211 is connected by the base stations 221 and 222 and an S1 interface. Furthermore, the MME/S-GW 212 is connected by the base stations 222 and 223 and the S1 interface.

Each of the base stations 221 to 223 is an eNodeB on an evolved universal terrestrial radio access network (E-UTRAN) of the LTE system. The base stations 221 to 223 are connected to each other by an X2 interface that is an interface between each of the base stations. Furthermore, each of the base stations 221 to 223 performs the data communication between each of the base stations 221 to 223 and the terminal by the wireless communication. Each of the terminals is a mobile terminal (mobile station) such as a portable phone.

A description is provided with the communication system 200 illustrated in FIG. 2 being taken as an example. However, the embodiments are not limited to the communication system 200 illustrated in FIG. 2, and may be applied to various mobile communication systems or wireless communication systems, such as a Global System for Mobile Communications (GSM) system and a Wideband Code Division Multiple Access (W-CDMA) system. Moreover, the GSM is a registered trademark.

Carrier Aggregation

A method of realizing bandwidth expansion that is one attribute of the LTE-Advanced system is described. In the LTE system, it is possible to set an uplink/downlink bandwidth to 1.4 MHz, 3 MHz, 5 MHz, 10 MHz, 15 MHz, and 20 MHz. These are stipulated, for example, in 3GPP TS 36.101, TS 36.104, and the like.

Furthermore, these bandwidths being set is referred to as a component carrier (CC). The reason for setting the multiple bandwidths is because it is assumed that a bandwidth allocated to the GSM system or the W-CDMA system, as it is, is used.

On the other hand, in the LTE system, realization of the high-speed transmission is accomplished through comparison with the GSM system or the W-CDMA system. Therefore, the bandwidth in the LTE system is made wider than that of the GSM system or the W-CDMA system.

Generally, a bandwidth that is used in the wireless communication system varies according to a situation in each country. Furthermore, in Europe, consideration of interference is accomplished because countries terrestrially adjoin one another, and the frequency band that is to be used in each country is adjusted. As a result, a bandwidth that may be used decreases, and is divided into smaller ones. On the other hand, as described above, the bandwidth in the LTE system is made wider.

Then, carrier aggregation is introduced as a method of integrating narrow, small bands for widening of the bandwidth. When the carrier aggregation is implemented, an important cell is set for every terminal. The important cell is referred to as a first cell, a primary cell, a first band, a primary band, a master cell, a main cell, or the like. The important cell is hereinafter referred to as a P cell. For example, the described-above first type cell is a P cell.

Moreover, the cell and the component carrier (band) are originally different in implication from each other, but the cell in the 3GPP is defined as a “cell that makes up one service area using one frequency.” Therefore, one cell is defined as being configured for the component carrier, and because the cell and the component carrier correspond one-to-one to each other, the cell and the component carrier are construed to have the same meaning. Furthermore, because one base station uses only one band, the base station and the component carrier also may be construed to have the same meaning.

In the carrier aggregation, another cell (band) is added to and is integrated into the P cell being set. The cell being added is referred to as a second cell, a secondary cell, a secondary band, a sub-band, a slave cell, a sub-cell, an extended band, an extended cell, or the like. The cell being added is hereinafter referred to as an S cell. As is the case with the P cell, the S cell and the component carrier have the same meaning. For example, the described-above second type cell is an S cell.

Moreover, these cells are capable of implementing scheduling in each of bands that result from dividing a band for one system, and may make up one system. For this reason, each of these cells is different from that in a case where a block (or a cluster) that results from putting together multiple subcarriers is configured in order to implement user multiplexing in Orthogonal Frequency Division Multiplexing Access (OFDMA).

In the carrier aggregation, for example, it is possible to set a maximum of up to seven S cells. That is, the carrier aggregation is possible using a maximum of eight component carriers when combined with the P cell. Moreover, in the LTE-Advanced system, a maximum bandwidth of 100 MHz is assumed. For this reason, in a case where a bandwidth of one component carrier is 20 MHz, the maximum number of S cells is four, and the carrier aggregation is possible using a maximum of five component carriers when the P cell and the S cell are combined.

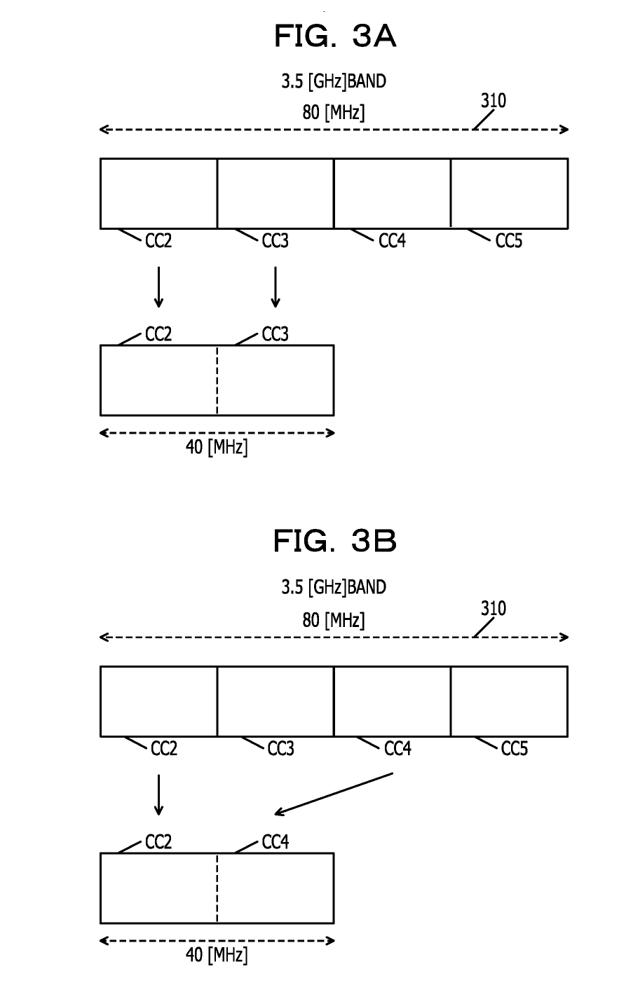

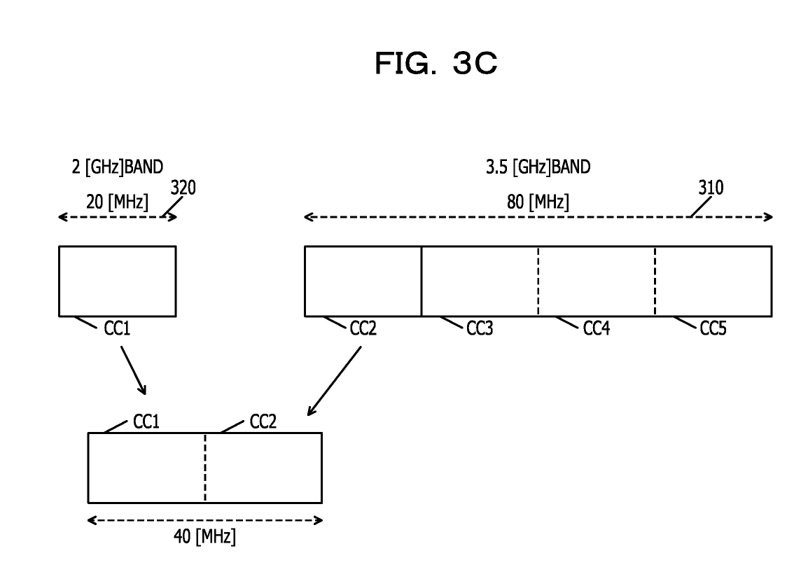

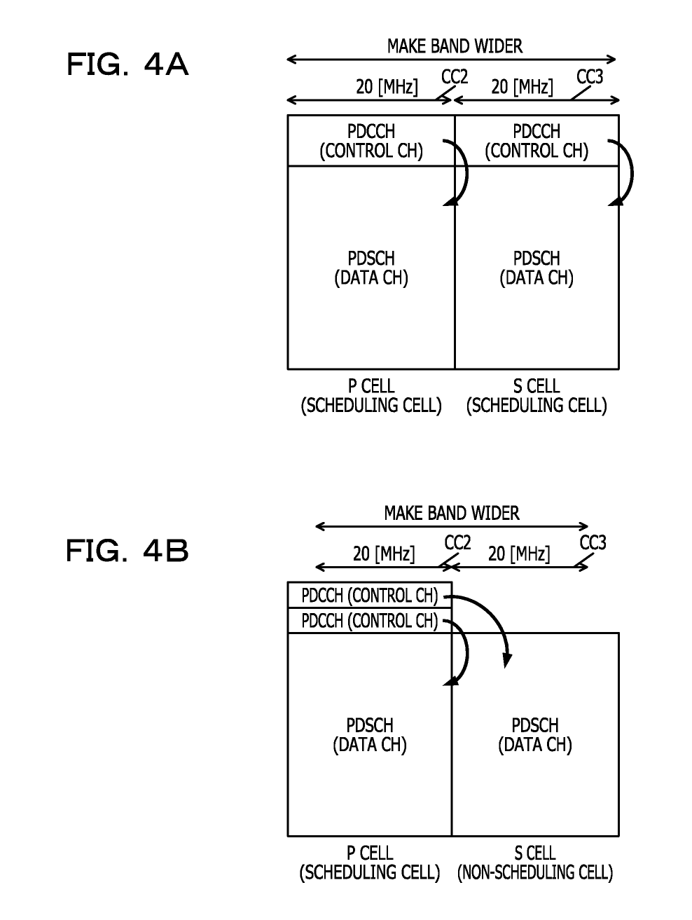

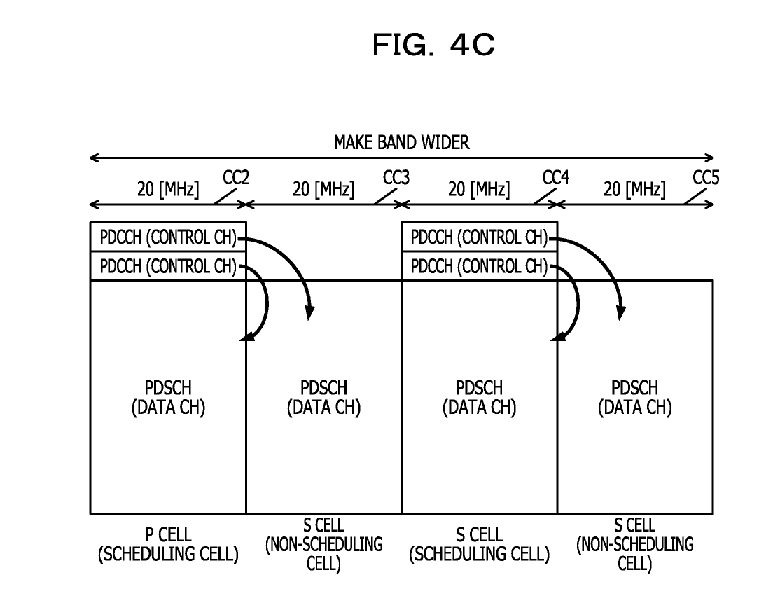

That is, the carrier aggregation results from integrating the P cell and at least one S cell (for example, refer to FIGS. 3A to 3C). For brief description, a case will be described below where the carrier aggregation is implemented with two component carriers (that is, one P cell and one S cell) in one terminal (except for FIG. 4C and the like). However, the carrier aggregation may be implemented with three or more component carriers by adding the second or later S cell (for example, refer to FIG. 4C and the like).

Example of the Carrier Aggregation

FIG. 3A is a diagram illustrating an example 1 of the carrier aggregation. A frequency band of the system band 310 that is illustrated in FIG. 3A is a 3.5 [GMz] band. A bandwidth of the system band 310 is 80 MHz. For example, component carriers CC2 to CC5 are included in the system band 310. Each of the component carriers CC2 to CC5 is 20 MHz.

In the carrier aggregation, for example, as illustrated in FIG. 3A, the component carriers CC2 and CC3 may be integrated for use. In this manner, in the carrier aggregation, for example, the adjacent component carriers may be integrated for use.

FIG. 3B is a diagram illustrating an example 2 of the carrier aggregation. In FIG. 3B, portions that are the same as those in FIG. 3A are given the same reference numerals, and descriptions of them are omitted. In the carrier aggregation, for example, as illustrated in FIG. 3B, the component carriers CC2 and CC4 may be integrated for use. In this manner, in the carrier aggregation, the component carriers that are not adjacent to each other may be integrated for use.

FIG. 3C is a diagram illustrating an example 3 of the carrier aggregation. In FIG. 3C, portions that are the same as those in FIG. 3A are given the same reference numerals, and descriptions of them are omitted. A frequency band of the system band 320 that is illustrated in FIG. 3C is a 2 GHz band. For example, the component carrier CC1 is included in the system band 320. A bandwidth of the component carrier CC1 is 20 MHz.

In the carrier aggregation, for example, as illustrated in FIG. 3C, the component carriers CC1 and CC2 that are included in the system bands 310 and 320, respectively, may be integrated for use. In this manner, in the carrier aggregation, component carriers in different frequency bands may be integrated for use.

Example of the P Cell and S Cell

FIG. 4A is a diagram illustrating an example 1 of the P cell and S cell. In FIG. 4A, portions that are the same as those in FIG. 3A are given the same reference numerals, and descriptions of them are omitted. FIG. 4A illustrates a case where, in the carrier aggregation, the component carrier CC2 is selected as one for a P cell, and the component carrier CC3 is selected as one for an S cell, thereby accomplishing the widening of the bandwidth. Furthermore, in the example that is illustrated in FIG. 4A, a Physical Downlink Control CHannel (PDCCH) that is a control channel and a Physical Downlink Shared CHannel (PDSCH) that is a data channel are included in each of the component carriers CC2 and CC3.

In this case, the component carriers CC2 and CC3 are scheduling cells (serving cells). That is, in each of the component carriers CC2 and CC3, the scheduling is performed, a control signal relating to the scheduling is transmitted on the PDCCH. For example, selection of the terminal, a wireless resource to be used, a modulation scheme, a coding rate, and the like are included in the control signal relating to the scheduling. Moreover, for example, a Downlink Control Channel (DCCH) is used in a downlink control channel as a transport channel.

In the example illustrated in FIG. 4A, the data transmission that uses a downlink radio shared channel and a downlink radio control channel for the data transmission is implemented in each cell, for example, in the same manner as is the case for High Speed Downlink Packet Access (HSDPA) in the W-CDMA. The downlink radio shared channel is, for example, a PDSCH. The downlink radio control channel is, for example, an Enhanced Physical Downlink Control CHannel (E-PDCCH). Here, the data means data dedicated to the terminal. The data dedicated to the terminal is user data or dedicated data.

FIG. 4B is a diagram illustrating an example 2 of the P cell and S cell. In FIG. 4B, portions that are the same as those in FIG. 4A are given the same reference numerals, and descriptions of them are omitted. In the example that is illustrated in FIG. 4B, the PDCCH for the PDSCH in the component carriers CC3 is included in the component carrier CC2. In this case, the component carrier CC2 is a scheduling cell, and the component carrier CC3 is a non-scheduling cell (or a serving cell).

That is, in the component carrier CC2, the scheduling of the component carrier CC3 is performed in a state of being added to the component carrier CC2. Then, each control signal relating to the component carriers CC2 and CC3 is transmitted on the PDCCH in the component carrier CC2.

Furthermore, at this time, information indicating which of the component carriers CC2 and CC3 a control signal relates to is also transmitted in a state of being added to the control signal.

Furthermore, in the component carrier CC3, the scheduling is not performed. Then, the PDSCH in the component carrier CC3 is transmitted based on the control signal that is transmitted on the PDCCH in the component carrier CC2.

A method of transmitting the scheduling and the control signal illustrated in FIG. 4B is referred to as a cross carrier scheduling. In the cross carrier scheduling, the scheduling cell is a P cell or an S cell, and the non-scheduling cell is only an S cell. That is, the P cell is only a scheduling cell.

The example illustrated in FIG. 4B is described with the downlink data being taken as an example. In the scheduling cell (for example, a P cell), a control signal for the data transmission in the scheduling cell is transmitted using the downlink radio control channel (PDCCH). Furthermore, in the scheduling cell, data is transmitted using the downlink radio shared channel (PDSCH), based on the control information that is transmitted on the described-above downlink radio control channel.

The control signal for the data transmission in the non-scheduling cell is transmitted using the downlink radio control channel (PDCCH) in the scheduling cell. In the non-scheduling cell, data is transmitted using the downlink radio shared channel (PDSCH), based on control information for the data transmission in the non-scheduling cell, which is transmitted on the described-above downlink radio control channel.

FIG. 4C is a diagram illustrating an example 3 of the P cell and S cell. In FIG. 4C, portions that are the same as those in FIG. 4A are given the same reference numerals, and descriptions of them are omitted. A component carrier CC5 that is illustrated in FIG. 4C is a component carrier that is adjacent to a high-frequency side component carrier CC4. FIG. 4C illustrates a case where, in the carrier aggregation, the component carrier CC2 is selected as one for a P cell, and the component carriers CC3 to CC5 are selected as ones for S cells.

Furthermore, in the example that is illustrated in FIG. 4C, the PDCCH for the PDSCH in the component carriers CC3 is included in the component carrier CC2. Furthermore, in the example that is illustrated in FIG. 4C, the PDCCH for the PDSCH in the component carriers CC5 is included in the component carrier CC4.

In this case, the component carriers CC2 and CC4 are scheduling cells and the component carrier CC3 and CC5 are non-scheduling cells. That is, in the component carrier CC2, the scheduling of the component carrier CC3 is performed in a state of being added to the component carrier CC2. Then, each control signal relating to the component carriers CC2 and CC3 is transmitted on the PDCCH in the component carrier CC2. Furthermore, at this time, information indicating which of the component carriers CC2 and CC3 a control signal relates to is also transmitted in an added state.

Furthermore, if the scheduling is performed in the component carrier CC3, the PDSCH in the component carrier CC3 is transmitted based on the control signal that is transmitted on the PDCCH in the component carrier CC2.

In the same manner, in the component carrier CC4, the scheduling of the component carrier CC5 is performed in a state of being added to the component carrier CC4. Then, each control signal relating to the component carriers CC4 and CC5 is transmitted on the PDCCH in the component carrier CC4. Furthermore, at this time, information indicating which of the component carriers CC4 and CC5 a control signal relates to is also transmitted in an added state.

Furthermore, if the scheduling is performed in the component carrier CC5, the PDSCH in the component carrier CC5 is transmitted based on the control signal that is transmitted on the PDCCH in the component carrier CC4.

As illustrated in FIG. 4C, two or more S cells may be present with respect to the P cell. Furthermore, as illustrated in FIG. 4C, the cross carrier scheduling may not be applied to all the S cells. That is, in a case where multiple cells are present, it is also possible to apply the cross carrier scheduling to a certain S cell, but not to apply the cross carrier scheduling to a different S cell. Furthermore, as illustrated in FIG. 4C, the downlink control channel (PDCCH) for a different component carrier may be also transmitted in the S cell in the same manner as in the P cell.

As illustrated in FIGS. 4B and 4C, in the scheduling in a case where the cross carrier scheduling is performed, at least three wireless channels (two PDCCHs and one PDSCH) are transmitted in a downlink direction. Furthermore, in addition to these, for example, a Physical Broadcast CHannel (PBCH), a Physical Synchronization CHannel (PSCH), a Physical Control Format Indicator CHannel (PCFICH), and a Physical Hybrid-ARQ Indicator CHannel (PHICH), and the like may be transmitted.

On the other hand, the non-scheduling cell, at least one wireless channel (PDSCH) is transmitted in a downlink direction.

Here, the case is described where, for certain first terminal, a first component carrier is set as a P cell and a second component carrier is set as a S cell. At this time, a case is described where different second terminal that uses only a second component carrier is present.

At this time, in a second terminal, the second component carrier is a P cell. For this reason, in the second component carrier, for the second component carrier that uses only the second terminal, the PBCH, PSCH, PCFICH, PHICH, and the like that are described above are transmitted.

On the other hand, in the first terminal in which the first component carrier is set to be for a P cell, and the second component carrier is set to be for an S cell, the receiving of the PBCH, the PSCH, the PCIFCH, and the like that are transmitted on the second component carrier is optional. For this reason, in the first terminal, in some cases, the receiving of these wireless channels is unnecessary. In this manner, with the second component carrier, for the second terminal in which the second component carrier is set as a P cell, in some cases, the PBCH, the PSCH, the PCFICH, and the like that are unnecessary in the first terminal are also transmitted in a downlink direction.

A component carrier on which the PDCCH for the current cell or a different cell is transmitted is described below as being set as a scheduling cell, and a component carrier on which only the downlink radio shared channel (PDSCH) is transmitted without the PDCCH being transmitted is described below as being set as a non-scheduling cell.

Moreover, in some cases, in the 3GPP, the P cell that is a cell which is first connected when a channel is established is referred to as an anchor component. The channel establishment, for example, channel establishment by random access that is implemented in a cell in which the terminal is selected.

Furthermore, as described above, the terminal may connect to only one cell when a wireless channel is set. For this reason, a cell that is connected when the wireless channel is set is a P cell. However, after the wireless channel is set, it is also possible to change the P cell through handover and the like. Furthermore, it is also possible to add, delete, and change an S cell.

Setting of the S Cell

When the wireless channel is set between the terminal and the base station, a maximum of eight serving cells (scheduling cells) are set with ServCellIndex IE that is a control signal of L3. At this point, ServCellIndex=0 indicates that the current cell is a P cell and ServCellIndex=1 to 7 indicates that the current cell is an S cell (for example, refer to 3GPP TS 36.331).

Moreover, it is possible to add an S cell even when the wireless channel is not set. Furthermore, the wireless channel setting is when the re-establishment or the change occurs by the handover.

Furthermore, ServCellIndex IE is included in CrossCarrierSchedulingConfig IE. CrossCarrierSchedulingConfig IE is included in PhysicalConfigDedicated IE. PhysicalConfigDedicated IE is included in RadioResourceConfigDedicated IE. RadioREsourceConfigDedicated IE is included in RRCConnectionReconfiguration message, and is notified from the base station to the terminal.

Furthermore, an S cell is notified by SCellIndex IE. SCellIndex IE is included in RRCConnectionReconfiguration message, and is notified from the base station to the terminal.

Case Where Carrier Aggregation is Implemented Between Each of the Base Stations

Furthermore, as described above, the implementation of the carrier aggregation between each of the different base stations is under study. In this case, the component carrier is selected that is used in the carrier aggregation by a maximum of seven S cells (ServCellIndex=1 to 7) that are set as described above.

The 3GPP standards stipulate that “a cell is a service area that is configured using one frequency”. According to this definition, one cell corresponds to one base station. However, in the carrier aggregation, in some cases, multiple cells correspond to one base station.

In the carrier aggregation in the related art, multiple component carriers are set to be in the same base station, and the carrier aggregation is implemented with the component carrier of the same base station. The implementation of the carrier aggregation between each of the base stations (between each of the eNB's) is currently under study. This implementation is the same as that of Dual Cell-HSDPA (DC-HSDPA) between each of the base stations.

Moreover, the implementation of the DC-HSDPA between each of the different base stations is referred to as Dual Band-HSDPA (DB-HSDPA) or Dual Band-Dual Cell-HSDPA (DB-DC-HSDPA), and is specified.

Hierarchical Cell Structure

A configuration in which multiple small cells (for example, pico cells, nano cells, or phantom cells) are arranged in a large cell (for example, a macro cell) is under study, starting from W-CDMA release 99. This configuration is referred to as umbrella cell structure or a hierarchical cell structure. The configuration is hereinafter referred to as the hierarchical cell structure.

Moreover, there are two cases for a small cell. One is that an entire area of the small cell is included in a large cell. The other is that only one portion of the area is included. In the latter case, the remaining portions may be included in different large cells.

The hierarchical cell structure is a configuration in which a large cell (a large-sized cell, a high-level cell, or a macro cell) and a small cell (a small-sized, a low-level cell, or a pico cell) overlap each other, that is, is arranged in such a manner as to form multiple layers. Here, a relatively-large cell is referred to as a large-sized cell, and a relatively-small cell is referred to as a small-sized cell.

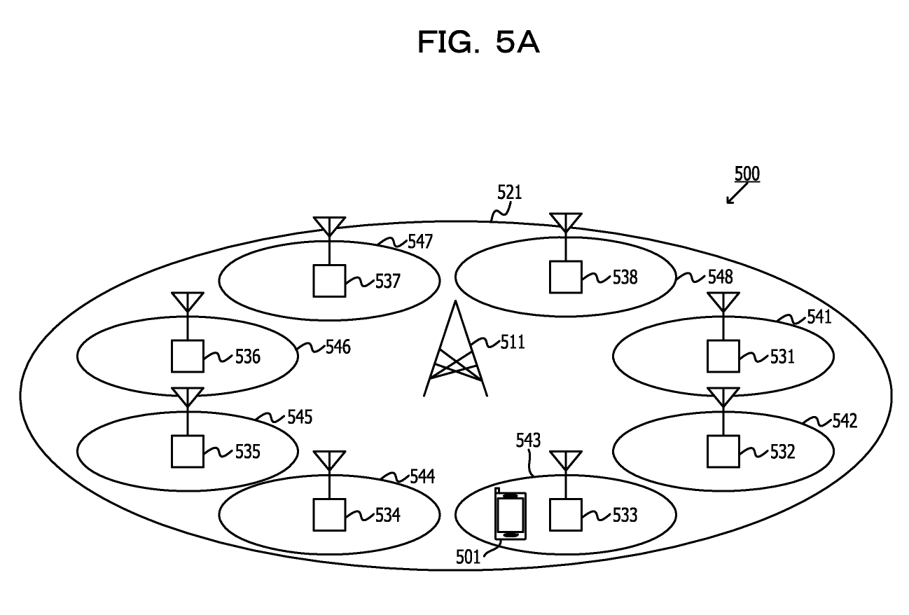

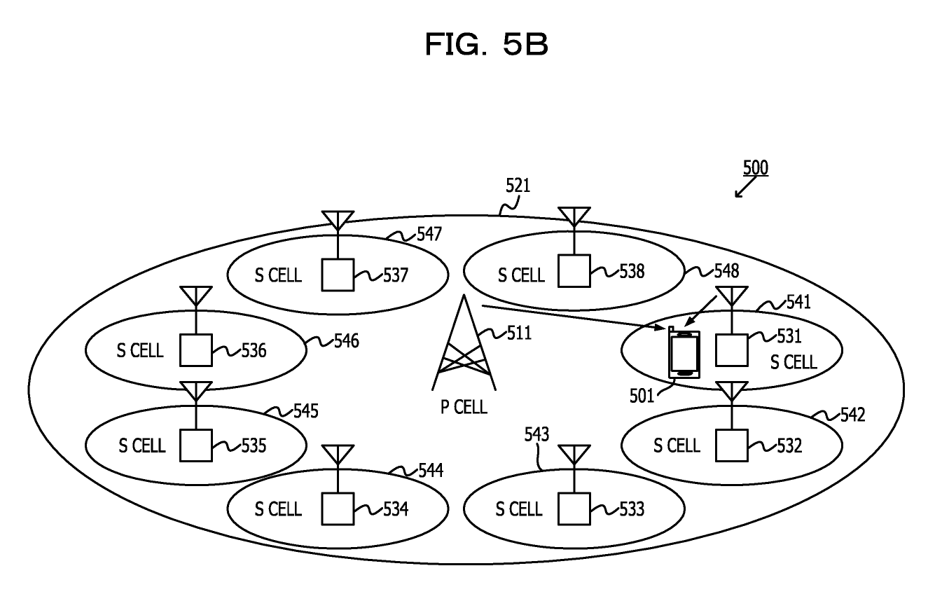

FIG. 5A is a diagram illustrating one example of the hierarchical cell structure. For example, a communication system 500 that is illustrated in FIG. 5A is one example of the communication system 200 illustrated in FIG. 2. The communication system 500 has a hierarchical cell structure in which a terminal 501, a base station 511, and base stations 531 to 538 are included.

As one example, the system 100 illustrated in FIGS. 1A to 1D may be realized in the communication system 500 that is illustrated in FIG. 5A. In this case, the base station 110 illustrated in FIGS. 1A to 1D may be realized, for example, by the base station 511. Furthermore, the base station 120 illustrated in FIGS. 1A to 1D may be realized, for example, by the base stations 531 to 538. Furthermore, the terminal 130 illustrated in FIGS. 1A to 1D may be realized, for example, by the terminal 501.

The base station 511 is a macro base station that has a larger transmission power than the base stations 531 to 538. A large-sized cell 521 is a cell that is served by the base station 511. The base stations 531 to 538 forms pico cells, nano cells, phantom cells, and the like, and are (small-sized) base stations, each of which has a smaller transmission power than the base station 511. Moreover, the small-sized cells are referred to as a pico cell, a nano cell, and a phantom cell, in cell-radius decreasing order. Small-sized cells 541 to 548 are cells that are serviced by the base stations 531 to 538, respectively.

The communication system 500 has the hierarchical cell structure in which the base stations 531 to 538 (small-sized cells 541 to 548) are installed in the large-sized cell 521. Next, a case is described where the carrier aggregation is implemented on the communication system 500 that has the hierarchical cell structure.

FIG. 5B is a diagram illustrating one example of the carrier aggregation in the hierarchical cell structure. For example, as illustrated in FIG. 5B, in the communication system 500, the carrier aggregation is performed in such a manner that the large-sized cell 521 is a P cell and the small-sized cells 541 to 548 are S cells. However, for example, the carrier aggregation may be performed in such a manner that the large-sized cell 521 is an S cell, and the small-sized cells 541 to 548 are P cells.

Furthermore, a cell that is available for connection as a P cell and as an S cell may be present. A case is described below where the carrier aggregation is performed in such a manner that the large-sized cell 521 is a P cell and the small-sized cells 541 to 548 are S cells.

For example, in the communication system 500, a control signal is mainly transmitted in a P cell, and user data is mainly transmitted in an S cell. Accordingly, it is possible to improve spectral efficiency. This effect results from dividing the cell. Furthermore, in an S cell, propagation loss is small because of a short distance between the terminal and the base station. For this reason, in uplink data transmission, transmission power desired to transmit the user data may reduced, and low power consumption by the terminal 501 may be accomplished.

Example of the Base Station that is an S Cell

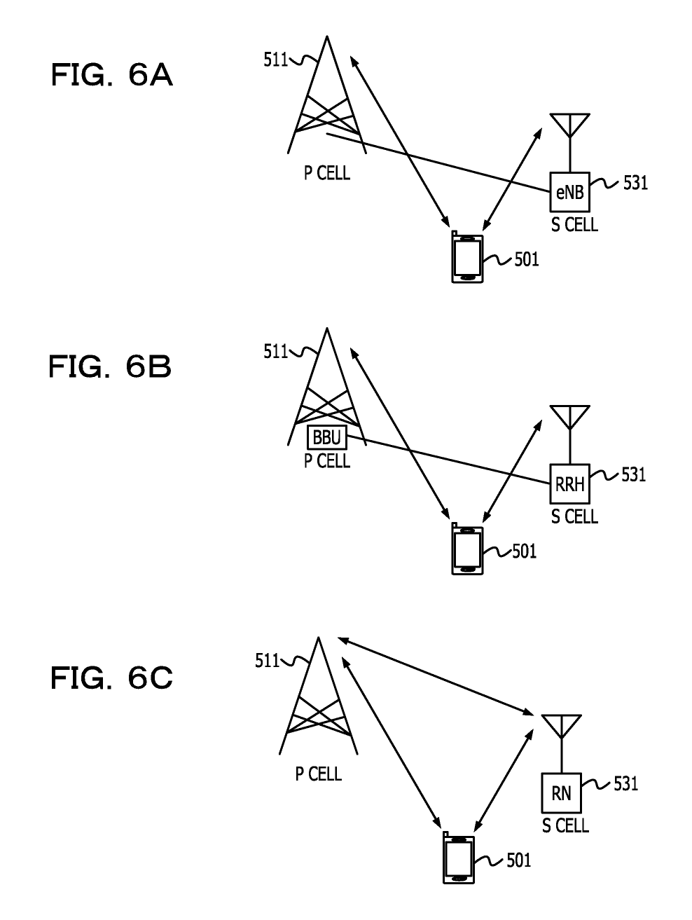

FIG. 6A is a diagram illustrating an example 1 of the base station that is an S cell. In FIG. 6A, portions that are the same as those in FIG. 5A are given the same reference numerals, and descriptions of them are omitted. Here, a case is described where the terminal 501 performs the carrier aggregation in such a manner the base station 511 serves a P cell and the base station 531 serves an S cell.

For example, as illustrated in FIG. 6A, for example, the base station 531 that serves the S cell may be set to be an evolved Node B (eNB) that is connected to the base station 511 (macro base station) in a cable manner. In this case, the base station 511 and the base station 531 are connected to each other, with the Internet, an intranet, or the like that uses Ethernet (a registered trade mark).

Moreover, the base station 511 or the base station 531 may be connected to an MME (for example, MME/S-GW 211 or 212 illustrated in FIG. 2) that manages movement of the terminal 501 that is a high-level apparatus of the base station 511 or the base station 531. Under these circumferences, the base station 531 that makes up the small-sized cell 541 may be connected directly to an MME, and may be connected to the MME through the base station 511 that makes up the large-sized cell 521. Furthermore, the base station 531 may be a femto base station that is connected, for example, with a public switch, and may be a small base station (or a pico base station) or the like that is connected with a dedicated line that is owned by a mobile communication provider.

FIG. 6B is a diagram illustrating an example 2 of the base station that is an S cell. In FIG. 6B, portions that are the same as those in FIG. 6A are given the same reference numerals, and descriptions of them are omitted. As illustrated in FIG. 6B, the base station 531 may be a remote radio head (RRH) that is connected to a baseband unit (BBU) that is provided in the base station 511. The RRH preforms amplification of a transmission signal, a received signal, and the like. The BBU performs processing such as modulation or demodulation, or the like. For example, a dedicated line, for example, such as an optical line, may be used for contact between the BBU and the RRH. Moreover, the RRH is also referred to as an expanded base station.

FIG. 6C is a diagram illustrating an example 3 of the base station that is an S cell. In FIG. 6C, portions that are the same as those in FIG. 6A are given the same reference numerals, and descriptions of them are omitted. As illustrated in FIG. 6C, the base station 531 may be a relay node (RN) that wirelessly relays communication with the base station 511. In this case, the base station 511 and the base station 531 are wirelessly connected to each other.

A configuration illustrated in FIG. 6A will be described below. However, with the configuration illustrated in FIGS. 6B and 6C, the embodiments may be realized in the same manner.

First Cell Section in the Hierarchical Cell Structure

First cell selection in the hierarchical cell structure is described. Here, an example of TS 36.304 that is an LTE specification is described.

For example, in the first cell selection of the P cell, the terminal 501 selects a cell that satisfies described-below Equations (1) to (3).

Srxlev>0 AND Squal>0 (1)

Srxlev=Qᵣₓₗₑᵥₘₑₐₛ−(Qᵣₓₗₑᵥₘᵢₙ+Q_{rxlevminoffset})−Pcompensation (2)

Squal=Q_{qualmeas}−(Q_{qualmin}+Q_{qualminoffset}) (3)

Described-below Equation (1), Srxlev is a post-compensation received power of a target cell in the terminal 501. Squal is post-compensation received quality of the target cell in the terminal 501.

In described-above Equation (2), Qᵣₓₗₑᵥₘₑₐₛ is a result of measurement of the received power of the target cell in the terminal 501. For example, the result of the measurement of the received power is a reference signal received power (RSRP). Qᵣₓₗₑₘᵢₙ is a desired received power. The desired received power is, for example, a minimum received power dBm for satisfying a desired error rate (for example, a bit error rate, BER=0.01 or a block error rate, BLER=0.1) or a desired transmission speed. Moreover, a reference signal (RS) is equivalent to a pilot in a general wireless communication system.

Q_{rxlevminoffset} is an offset of the received power. Pcompensation is a compensation value that depends on the received power of the base station. For example, if the transmission power of the base station decreases, compensation is performed by Pcompensation because the received power decreases. Qᵣₓₗₑᵥₘᵢₙ, Q_{rxlevminoffset}, or the like is broadcast, as a system information (system information block type 1 (SIB1)), to the terminal 501.

In this manner, Srxlev that is a post-compensation received power is a result of received quality evaluation that is based on a result of subtracting a result of adding the desired received power and the offset of the broadcast received power from the measured received power. That is, Srxlev evaluates room for the desired received power, considering the offset of the received power.

In described-above Equation (3) Q_{qualmeas} is a result of measurement of the received quality of a target cell in the terminal 501. The result of the measurement of the received quality is, for example, reference signal received quality (RSRQ). Q_{qualmin} is desired received quality. The desired received quality, for example, minimum received quality for satisfying the desired error rate or the desired transmission speed. The received quality is, for example, a signal noise ratio (SNR) or a signal-to-interference ratio (SIR).

Q_{qualminoffset} is an offset of the desired received quality. Pcompensation is a compensation value that depends on the received power of the base station. For example, if the transmission power of the base station decreases, the compensation is performed by Pcompensation because the received quality decreases. Q_{qualmin}, Q_{qualminoffset}, or the like is broadcast, as the system information (SIB1), to the terminal 501.

In this manner, Squal that is post-compensation received quality is a result of received quality evaluation that is based on a result of subtracting a result of adding the desired received quality and the offset of the broadcast received quality from the measured received quality. That is, Squal evaluates room for the desired received quality, considering the offset of the received quality.

Moreover, Srxlev and Squal are used in a Frequency Division Duplex (FDD) of the W-CDMA system, but only Srxlev is used in a Time Division Duplex (TDD) of the W-CDMA system. Furthermore, only Srxlev is used also for LTE release 8.

Cell Reselection in the Hierarchical Cell Structure

The cell reselection in the hierarchical cell structure is described. The cell reselection is to make a reselection of the cell, in a case where, after the cell selection is made, a state where the communication is not performed or the like continues for a predetermined time or more, or for such reasons as when a channel connection is released after a channel connection (for example, refer to 3GPP TS25.304).

The terminal 501 calculates Hₛ and Hₙ that are illustrated in described-below Equation (4), for example, in the cell reselection of the P cell. Then, the terminal 501 ranks the cells based on Hₛ and Hₙ and selects a cell that has the highest ranking.

Hₛ=Q_{meas,}s−Qhcsₛ

Hₙ=Q_{meas,n}−Qhcsₙ−TOₙ*Lₙ (4)

Hₛ in described-above Equation (4) is a result of the received quality evaluation of a cell (serving cell) in a connecting process. Hₛ is a value that results from subtracting a threshold (Qhcsₛ) of wireless channel quality from the cell in the connecting process from downlink wireless channel quality (Q_{meas,s}) from the cell in the connecting process. Q_{meas,s} is, for example, received quality (CPICH Ec/No) of a shared pilot channel or the like. Moreover, “s” is a suffix indicating a serving cell, that is, a connection destination cell or a camping-on destination cell.

Hₙ in described-above Equation (4) is a result of the received quality evaluation of a neighboring cell, that is, an adjacent cell. Hₙ is a value that results from subtracting a value which results from multiplying a threshold (Qhcsₙ) of the wireless channel quality from the neighboring cell, TOₙ, and Lₙ, from downlink wireless channel quality (Q_{meas,n}) from the neighboring cell. Q_{meas,n}, for example, is received quality (CPICH Ec/No) of the shared pilot channel or the like. Moreover, “n” is a suffix indicating a neighboring cell, that is, an adjacent cell.

TOₙ is an adjustment value (offset) for different measurement timing. Lₙ is a value of 0 in a case where the priority of a cell in the connecting process and the priority of a neighboring base station are different from each other, and is a value of 1 in a case where the priority of the cell and the priority of the neighboring base station do not do so. TOₙ and Lₙ in described-above Equation (4) may be calculated, for example, by described-below Equation (5).

TOₙ=TEMP_OFFSETₙ*W(PENALTY_TIMEₙ−Tₙ)

Lₙ=0(HCS_{—}PRIOₙ=HCS_{—}PRIOₛ)

Lₙ=1(HCS_{—}PRIOₙ≠HCS_{—}PRIOₛ)

W(x)=0(x<0)

W(x)=1(x≧0) (5)

In described-above Equation (5), PENALTY_TIMEₙ is an offset for different measurement timing for the neighboring cell (adjacent cell). TEMP_OFFSETₙ is an offset for a duration time of PENALTY_TIMEₙ. HCS_PRIOₛ is priority of the cell in the connecting cell. HCS_PRIOₙ is priority of the neighboring cell. W(x) is a weighting function. Tₙ is measurement timing for the received quality.

Qhcsₛ, Qhcsₙ, HCS_PRIOₛ, HCS_PRIOₙ, PENALTY_TIMEₙ, and the like are broadcast, as the system information, to the terminal 501 (for example, refer to 3GPP TS 36.304 or TS 36.331).

For example, in a case where measurement timing Tₙ is longer than PENALTY_TIMEₙ, W(x)=0. For this reason, in a case where the downlink wireless channel quality (Q_{meas,n}) from a neighboring cell is greater than a threshold (Qhcsₙ), the result (Hₙ) of the received quality evaluation is a value greater than 0. In the same manner, in a case where the downlink wireless channel quality (Q_{meas,s}) from the cell in the connecting process is greater than the threshold (Qhcsₛ), a result of received quality evaluation (Hₛ) is a value greater than 0.

Measurement of the Wireless Channel Quality

The measurement of the wireless channel quality by the terminal 501 is described. It is possible for the terminal 501 to extract a pilot signal from the base station by symbol synchronization being possible. Then, the terminal 501 measures received signal quality (RSRQ) of the extracted pilot signal. Furthermore, the terminal 501 measures the received signal quality (RSRQ) by comparing a sequence of calculated pilot signals and a sequence of received pilot signal.

Reception of the System Information

The reception of the system information by the terminal 501 is described. It is possible for the terminal 501 to receive the system information being broadcast from a neighboring base station by being synchronized to the transmission signal from the neighboring base station. The system information is a master information block (MIB) and a system information block (SIB), for example, in the LTE system.

The MIB includes information such as a downlink frequency bandwidth or a wireless frame number. Up to now, for the SIB, system information block (SIB) types 1 to 16 have been stipulated. However, it is considered that the SIB is further is supplemented.

These pieces of system information are sent on a broadcast control channel (BBCH), a logical channel. The BCCH is mapped onto a broadcast channel (BCH) that is a transport channel, or a downlink shared channel (DL-SCH).

Additionally, the transmission to the terminal 501 is performed using the PBCH or the PDSCH that is a wireless channel. Moreover, although a downlink radio shared channel as well as a wireless broadcast channel is available, the system information is broadcast, as shared control information, to the terminal 501 that connects to, or camps on the base station or that is available for receiving. Moreover, the broadcast is so-called broadcasting, and the terminal 501 does not transmit a response to a broadcast signal.

Erroneous Cell Selection of a P cell in the Hierarchical Cell Structure

For example, in some cases, with a wireless channel quality threshold of each cell, wireless channel quality, priority, measurement timing, and instead of the base station (for example, a cell that is used as an P cell) in the connection process, a penalty time value, an adjacent cell that may be used as only an S cell is selected as a P cell.

Contention-Based Random Access

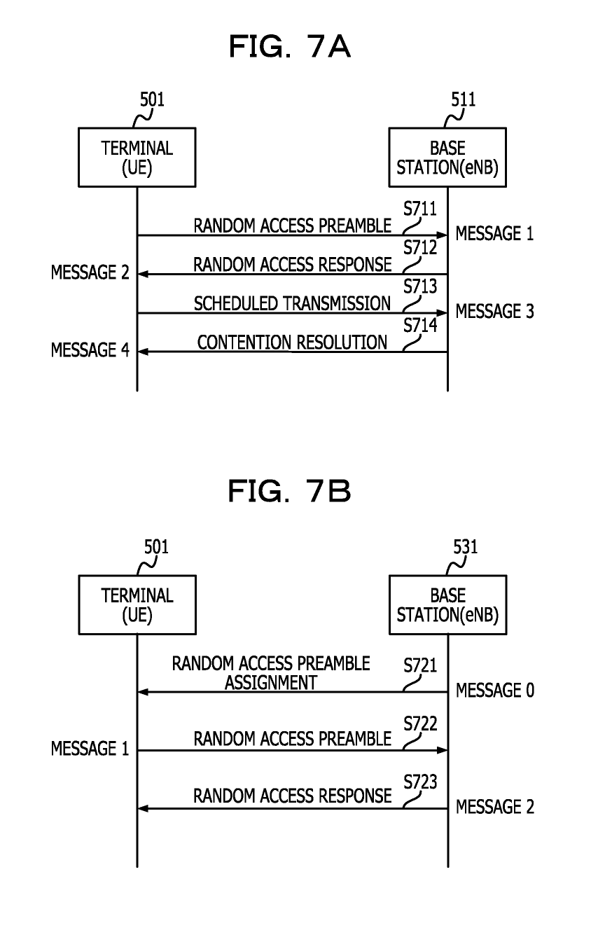

FIG. 7A is a diagram illustrating one example of contention-based random access. Referring to FIG. 7A, a case is described where the terminal 501 (UE) selects the base station 511, which is a large-sized cell, as a P cell, and performs contention-based random access procedure on the selected base station 511. First, the terminal 501 transmit a random access preamble, as a message 1, to the base station 511 (Step S711).

Next, the base station 511 identifies the terminal 501 based on the random access preamble received in Step S711, and sets a cell-radio network temporary identifier (C-RNTI) that is an identifier of the terminal 501. Here, the C-RNTI being set is, for example, a temporary C-RNTI that is a temporary identifier.

Furthermore, the base station 511 sets an uplink transmission grant (UL grant), transmission timing (timing alignment information), a channel quality indicator (CQI) request, and the like for the terminal 501. Then, the base station 511 transmits to the terminal 501 a random access response, as a message 2, which includes these result of the setting and the random access preamble received in Step S711 (Step S712).

Next, the terminal 501 checks whether or not the random access preamble transmitted in Step S711 and the random access preamble received in Step S712 agrees with each other. In a case where the random access preambles do not agree with each other, the terminal 501 determines that the random access response received in Step S712 is destined for a different terminal, and transmits the random access preamble again. Under these circumferences, the terminal 501 may transmit the random access preamble transmitted last time, and may transmit select a different random access preamble for transmission.

In a case where the random access preambles agree with each other, the terminal 501 recognizes that the random access response received in Step S712 is destined for the terminal 501 itself. Then, the terminal 501 transmits scheduling transmission, as a message 3, which includes an RRC connection request and the like, to the base station 511 (Step S713). The transmission in Step S713 is performed with the uplink transmission grant (UL grant) that is included in the random access response received in Step S712, or using a wireless resource and a modulation scheme that are designated by the random access response.

The base station 511 transmits contention resolution that is a response signal (ACK/NACK) to the scheduling transmission received in Step S713, as a message 4 (Step S714). Accordingly, the wireless channel setting between the terminal 501 and the base station 511 is completed.

Noncontention-Based Random Access

FIG. 7B is a diagram illustrating one example of noncontention-based random access. Referring to FIG. 7B, a case is described where the terminal 501 (UE) selects the base station 531, which is a small-sized cell, as an S cell, and performs noncontention-based random access procedure on the selected base station 531.

First, the base station 531 transmits a random access preamble assignment, as a message 0, which includes a dedicated preamble, to the terminal 501 (Step S721). Included in the random access preamble assignment is control information such as the system information that is to be used in order for the base station 531 selected as the S cell and the terminal 501 to implement random access preamble.

Next, the terminal 501 transmits the random access preamble, as the message 1, to the base station 531 (Step S722). The random access preamble that is transmitted in Step S722 is a dedicated preamble that is included in the random access preamble assignment received in Step S721.

Next, the base station 531 transmits the random access response to the dedicated preamble received in Step S722, as the message 2, to the terminal 501 (Step S723). Accordingly, a sequence of noncontention-based random access is terminated, and the channel is established between the terminal 501 and the base station 531. That is, in the terminal 501, an S cell is added, and the carrier aggregation is set.

Moreover, in some cases, only downlink is established for an S cell. For S cell addition in this case, an S cell addition request (that is, a request for allowing for the receiving from the S cell) and information for adding the S cell (for example, information (for example, a cell ID or the like) on the S cell to add) are notified from a P cell to the terminal 501, and the terminal 501 receiving the notification is set in such a manner that the receiving from the S cell is possible. Accordingly, the S cell is added, and the carrier aggregation is set.

Base Station According to a Second Embodiment

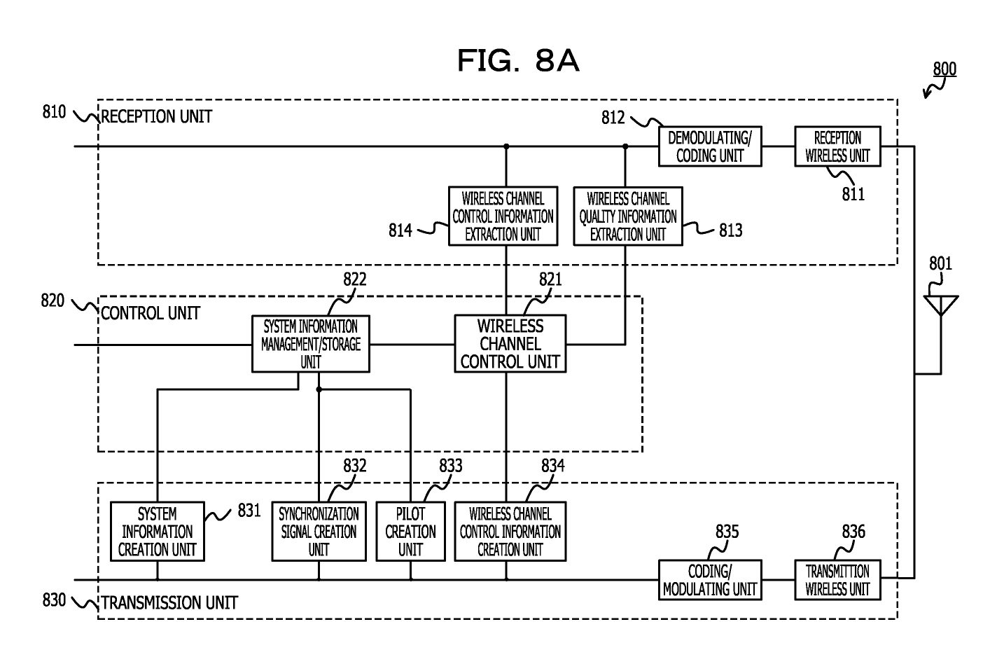

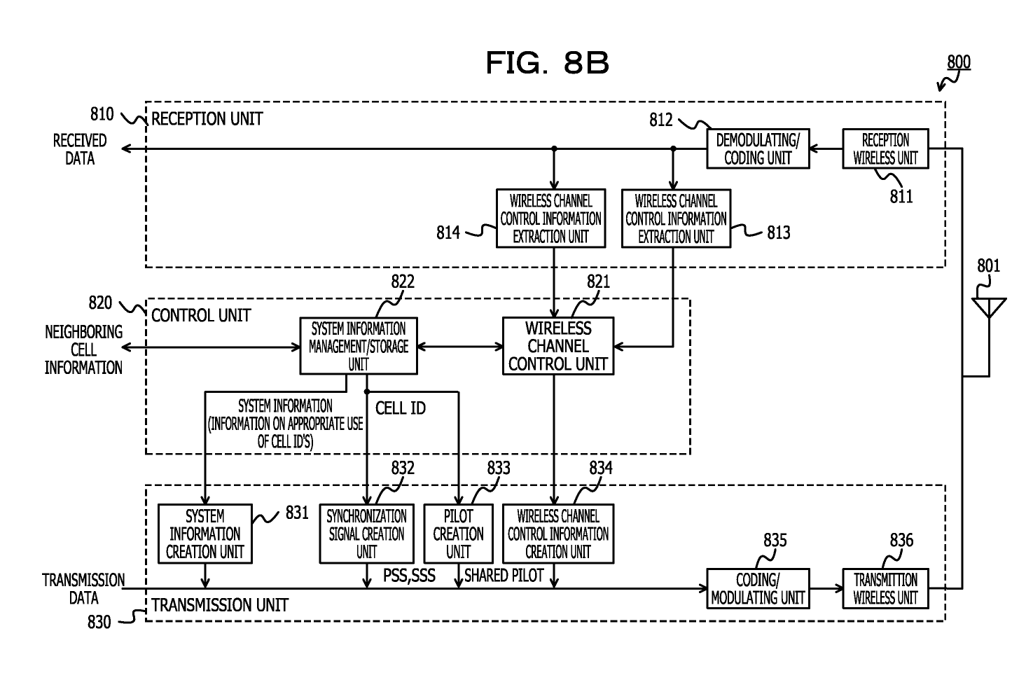

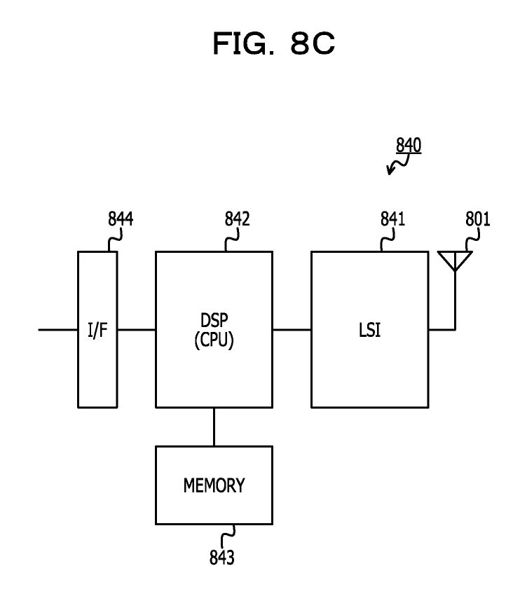

FIG. 8A is a diagram illustrating one example of a base station according to a second embodiment. FIG. 8B is a diagram illustrating one example of a signal flow in the base station illustrated in FIG. 8A. Each of the base stations 511 and 531 to 538 may be realized, for example, as a base station 800 that is illustrated in FIGS. 8A and 8B. The base station 800 includes an antenna 801, a reception unit 810, a control unit 820, and the transmission unit 830. The reception unit 810 includes a reception wireless unit 811, a demodulating/decoding unit 812, a wireless channel quality information extraction unit 813, and a wireless channel control information extraction unit 814.

The control unit 820 includes a wireless channel control unit 821 and a system information management/storage unit 822. The transmission unit 830 includes a system information creation unit 831, a synchronization signal creation unit 832, a pilot creation unit 833, a wireless channel control information creation unit 834, a coding/modulating unit 835, and a transmission wireless unit 836.

The transmission units 111 and 121 illustrated in FIGS. 1A to 1D may be realized, for example, as the antenna 801 and the transmission unit 830. The control units 112 and 122 illustrated in FIGS. 1A to 1D may be realized, for example, as the control unit 820.

The antenna 801 receives a signal that is transmitted from the terminal (for example, the terminal 501) that is positioned within the base station 800, and wirelessly outputs the received signal to the reception wireless unit 811. Furthermore, the antenna 801 wirelessly transmits the signal being output from the transmission wireless unit 836, to the terminal that is positioned within a cell that is served by the base station 800.

The reception wireless unit 811 performs receiving processing of the signal being output from the antenna 801. Included in the receiving processing in the reception wireless unit 811 is, for example, amplification, conversion from a high frequency to a baseband, conversion from an analog signal to a digital signal, and the like. The reception wireless unit 811 outputs the signal on which the receiving processing is performed, to the demodulating/decoding unit 812.

The demodulating/decoding unit 812 performs demodulating and decoding of the signal being output from the reception wireless unit 811. Then, the demodulating/decoding unit 812 outputs received data obtained by demodulating and decoding. The received data being output from the demodulating/decoding unit 812 is output to a high layer processing unit of the reception unit 810, the wireless channel quality information extraction unit 813, and the wireless channel control information extraction unit 814.

The wireless channel quality information extraction unit 813 extracts wireless channel quality information that is included in the received data being output from the demodulating/decoding unit 812. The wireless channel quality information, is, for example the CQI, the RSRP, the RSRQ, or the like. The wireless channel quality information extraction unit 813 outputs the extracted wireless channel quality information to the wireless channel control unit 821.

The wireless channel control information extraction unit 814 extracts wireless channel control information that is included in the received data being output from the demodulating/decoding unit 812. The pieces of wireless channel control information are, for example, a preamble of the random access, each message of the random access, various response signals (ACK/NACK), and the like. The wireless channel control information extraction unit 814 outputs the extracted wireless channel control information to the wireless channel control unit 821.

The wireless channel control unit 821 controls wireless channel control in the base station 800. Used in the wireless channel control is the wireless channel quality information being output from the wireless channel quality information extraction unit 813, the wireless channel control information being output from the wireless channel control information extraction unit 814, the system information (a bandwidth, a preamble) stored in the system information management/storage unit 822, and the like. Furthermore, included in the wireless channel control is, for example, random access control, scheduling of the terminal (for example, the base station 800), a measurement request to the terminal, and the like. For example, the wireless channel control unit 821 notifies the wireless channel control information creation unit 834 of the wireless channel control information that is destined for the terminal in accordance with the wireless channel control.

The system information management/storage unit 822 performs managing or storing of the system information. For example, for storage, the system information management/storage unit 822 acquires the system information obtained by the wireless channel control by the wireless channel control unit 821, from the wireless channel control unit 821. Furthermore, the system information management/storage unit 822 outputs to the wireless channel control unit 821 the system information that is desired in order for the wireless channel control unit 821 to perform the wireless channel control, among the pieces of system information that are stored.

Furthermore, the system information management/storage unit 822 receives from the neighboring cell the system information on the neighboring cell that is served by the base station 800, as neighboring cell information. Furthermore, the system information management/storage unit 822 transmits the system information on the base station 800, as the neighboring cell information, to the neighboring cell that is served by the base station 800.

Furthermore, the system information management/storage unit 822 notifies the system information creation unit 831 of the system information. Included in the system information is, for example, information (for example, a cell ID, a bandwidth, or the like) relating to the base station 800. Furthermore, included in the system information, information (for example, a random access preamble that is usable) that is desired when the random access is implemented. Furthermore, included in the system information is information (priority of a cell or an offset, or the like) relating to the cell selection. Furthermore, included in the system information is information relating to the neighboring base station.

Furthermore, included in the system information is information on the appropriate use of the cell ID's described below. For example, the system information management/storage unit 822 includes in the system information the information on the appropriate use of the cell ID's that is stored in advanced by the base station 800. Furthermore, the system information management/storage unit 822 may include in the system information the information on the appropriate use of the cell ID's, which is received from an apparatus (for example, an MME) that is at a higher level than the base station 800.

These pieces of system information are broadcast, as shared control information, to each terminal within the base station 800, by the base station 800, on the PBCH or the PDSCH, using the BCCH that is a logical channel. In a case where the priority or offset of the cell that is to be used when the cell selection is made is included in the system information, the cell selection is made based on these pieces of information.

Furthermore, the system information management/storage unit 822 outputs a cell ID of the base station 800 to the synchronization signal creation unit 832 and the pilot creation unit 833. The cell ID of the base station 800 is a cell ID that is allocated according to which of the P cell and the S cell the cell that is served by the base station 800 is.

Transmission data that the base station 800 has to transmit is input into the transmission unit 830 from the high layer processing unit of the transmission unit 830. The transmission data being input into the transmission unit 830 is input into the transmission data coding/modulating unit 835.

The system information creation unit 831 creates the system information notified from the system information management/storage unit 822, maps the created system information onto a broadcast channel, and outputs a result of the mapping to the coding/modulating unit 835.

The synchronization signal creation unit 832 creates a primary synchronization signal (PSS) (first synchronization signal) and a secondary synchronization signal (SSS) (second synchronization signal) that are synchronization signals which are based on the cell ID that is output from the system information management/storage unit 822. Then, the synchronization signal creation unit 832 maps the created synchronization signal onto the broadcast channel and outputs a result of the mapping to the coding/modulating unit 835.

The pilot creation unit 833 creates a shared pilot that is a pilot signal which is based on the cell ID that is output from the system information management/storage unit 822. Then, the pilot creation unit 833 maps the created shared pilot to a wireless format in the same manner as is the case with a wireless control channel or a shared channel, and output a result of the mapping to the coding/modulating unit 835. Moreover, the pilot creation unit 833 may map the shared pilot onto a pilot channel, and may map the shared pilot onto the wireless frame in the same manner.

Furthermore, for example, a cell shared pilot that is common to the multiple terminals within a cell may be included in the pilot that is created by the pilot creation unit 833. Furthermore, a dedicated pilot (UE specific RS) that is allocated dedicatedly to a terminal may be included in the pilot that is created by the pilot creation unit 833. Furthermore, a pilot (positioning pilot or positioning RS) for measuring a position may be included in the pilot that is created by the pilot creation unit 833. Furthermore, a pilot (channel state information pilot (CSI-RS)) for measuring the wireless channel quality may be included in the pilot that is created by the pilot creation unit 833. That is, the pilot that is created by the pilot creation unit 833 may be a known signal that is determined in advance, for example, between the base station 800 and the terminal or in the wireless communication system.

The wireless channel control information creation unit 834 creates the wireless channel control information notified from the wireless channel control unit 821, maps the created wireless channel control information onto the broadcast channel or the shared channel, and outputs a result of the mapping to the coding/modulating unit 835.

The coding/modulating unit 835 performs coding or modulating of the transmission data being input, or each piece of information (signal) being output from the system information creation unit 831, the synchronization signal creation unit 832, the pilot creation unit 833, and the wireless channel control information creation unit 834. Then, the coding/modulating unit 835 outputs to the transmission wireless unit 836 a signal obtained by the coding or modulating.

The transmission wireless unit 836 performs transmission processing of the signal being from the coding/modulating unit 835. Included in the transmission processing in the transmission wireless unit 836 is, for example, conversion from a digital signal to an analog signal, conversion from a baseband to a high frequency, amplification, or the like. The transmission wireless unit 836 outputs the antenna 801 a signal obtained by the transmission processing.

FIG. 8C is a diagram illustrating one example of a hardware configuration of the base station according to the second embodiment. In FIG. 8C, portions that are the same as those in FIGS. 8A and 8B are given the same reference numerals, and descriptions of them are omitted. The base station 800 illustrated in FIGS. 8A and 8B may be realized, for example, as a communication apparatus 840 that is illustrated in FIG. 8C. The communication apparatus 840 includes the antenna 801, an LSI 841, a DSP 842, a memory 843, and a communication interface 844 (I/F).

The large scale integration (LSI) 841 is connected to the antenna 801 and the DSP 842. The reception wireless unit 811 and the transmission wireless unit 836 that are illustrated in FIGS. 8A and 8B may be realized, for example, as a circuit such as the LSI 841.

The digital signal processor (DSP) 842 is connected to the LSI 841, the memory 843, and the communication interface 844. The DSP 842 performs control of the entire communication apparatus 840. Included in the memory 843 is, for example, a main memory and an auxiliary memory. The main memory is, for example, a random access memory (RAM). The main memory is used as a work area for the DSP 842. The auxiliary memory is, for example, a nonvolatile memory such as a magnetic disk or a flash memory. Included in the auxiliary memory is various programs that operate the communication apparatus 840. The programs stored in the auxiliary memory are loaded onto the main memory for execution by the DSP 842.

The communication interface 844 is a communication interface that performs communication with an external communication apparatus. For example, a cable communication interface may be used as the communication interface 844.

The demodulating/decoding unit 812, the wireless channel quality information extraction unit 813, the wireless channel control information extraction unit 814, the wireless channel control unit 821, and the system information management/storage unit 822, which are illustrated in FIGS. 8A and 8B, may be realized, for example, as a circuit such as the DSP 842 and as the memory 843. Furthermore, the system information creation unit 831, the synchronization signal creation unit 832, the pilot creation unit 833, the wireless channel control information creation unit 834 and the coding/modulating unit 835, which are illustrated in FIGS. 8A and 8B, may be realized, for example, as a circuit such as the DSP 842 and as the memory 843. Furthermore, an interface for communication with a cell adjacent to the system information management/storage unit 822 illustrated in FIGS. 8A and 8B may be realized, for example, as the communication interface 844.

Furthermore, instead of the DSP 842, a central processing unit (CPU), a combination of the DSP and the CPU, or the like may be used.

Terminal According to the Second Embodiment

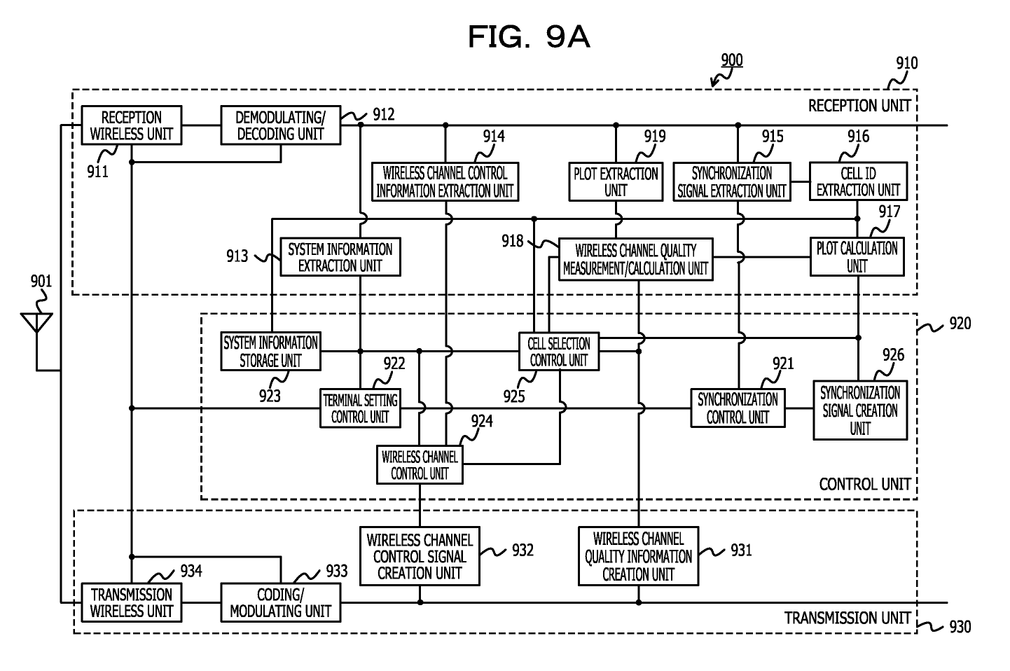

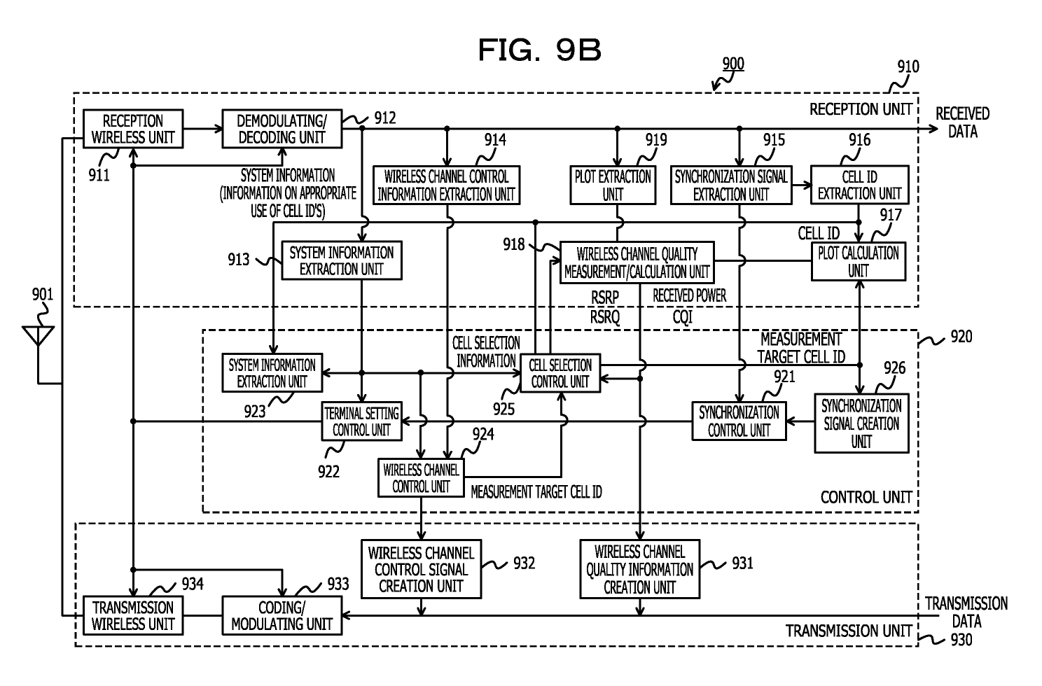

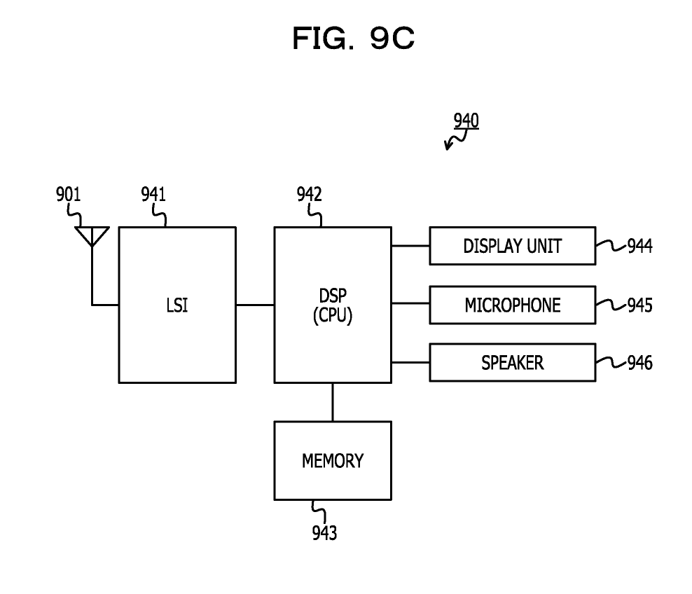

FIG. 9A is a diagram illustrating one example of a terminal according to the second embodiment. FIG. 9B is a diagram illustrating one example of a signal flow in the terminal illustrated in FIG. 9A. The terminal 900 as illustrated in FIGS. 9A and 9B includes an antenna 901, a reception unit 910, a control unit 920, and a transmission unit 930.

The reception unit 910 includes a reception wireless unit 911, a demodulating/decoding unit 912, a system information extraction unit 913, a wireless channel control information extraction unit 914, a synchronization signal extraction unit 915, and a cell ID extraction unit 916. Furthermore, the reception unit 910 includes a pilot calculation unit 917, a wireless channel quality measurement/calculation unit 918, and a pilot extraction unit 919.

The control unit 920 includes a synchronization control unit 921, a terminal setting control unit 922, a system information storage unit 923, a wireless channel control unit 924, a cell selection control unit 925, and the synchronization signal creation unit 926. The transmission unit 930 includes a wireless channel quality information creation unit 931, a wireless channel control signal creation unit 932, a coding/modulating unit 933, and a transmission wireless unit 934.

The reception unit 131 illustrated in FIGS. 1A to 1D may be realized, for example, as the antenna 901 and the reception unit 910. The control unit 132 illustrated in FIGS. 1A to 1D may be realized, for example, as the control unit 920.

The antenna 901 receives a signal transmitted from a base station (for example, the base station 511 or 531, or the base station 800) and outputs the received signal to the reception wireless unit 911. Furthermore, the antenna 901 wirelessly transmits the signal being output from the transmission wireless unit 934, to the base station.

The reception wireless unit 911 performs receiving processing of the signal being output from the antenna 901. Included in the receiving processing in the reception wireless unit 911 is, for example, amplification, conversion from a high frequency to a baseband, conversion from an analog signal to a digital signal, and the like. The reception wireless unit 911 outputs the signal on which the receiving processing is performed, to the demodulating/decoding unit 912.

The demodulating/decoding unit 912 performs demodulating and decoding of the signal being output from the reception wireless unit 911. Then, the demodulating/decoding unit 912 outputs received data obtained by demodulating and decoding. The received data being output from the demodulating/decoding unit 912 is output to a high layer processing unit of the reception unit 910, the system information extraction unit 913, the wireless channel control information extraction unit 914, the synchronization signal extraction unit 915, and the pilot extraction unit 919.

The system information extraction unit 913 extracts the system information that is included in the received data being output from the demodulating/decoding unit 912, and that is transmitted as the broadcast information from the base station 800. Included in the system information is, for example, information relating to the implementation of the carrier aggregation, information on the appropriate use of the cell ID's, and the like. The system information extraction unit 913 outputs the extracted system information to the terminal setting control unit 922 and the cell selection control unit 925.

Furthermore, in a case where, for example, a cell ID, a frequency, and a bandwidth of each small-sized cell under the control of the base station 511 are determined in advance as the system information, the system information extraction unit 913 may store the extracted system information in the system information storage unit 923. In this case, the terminal 900 may not receive the system information thereafter in the large-sized cell 521 that is served by the base station 511. Furthermore, the system information may be stored in advance in the system information storage unit 923.

The wireless channel control information extraction unit 914 extracts the wireless channel control information that is included in the received data being output from the demodulating/decoding unit 912, and outputs the extracted wireless channel control information to the wireless channel control unit 924. Included in the wireless channel control information is a random access response, a handover instruction, or the like.

The synchronization signal extraction unit 915 extracts the PSS and the SSS that are synchronization signals which are included in the reception point being output from the demodulating/decoding unit 912. Then, the synchronization signal extraction unit 915 outputs a result of the extraction of the PSS and the SSS to the cell ID extraction unit 916 and the synchronization control unit 921.

Based on the result of the extraction, which is output from the synchronization signal extraction unit 915, the cell ID extraction unit 916 extracts the cell ID of the cell that is a transmitting source of the PSS and the SSS. Then, the cell ID extraction unit 916 outputs the extracted cell ID to the pilot calculation unit 917, the system information storage unit 923, and the cell selection control unit 925.

The pilot calculation unit 917 calculates a pattern of the pilot that is based on the cell ID being output from the cell ID extraction unit 916. Then, the pilot calculation unit 917 notifies the wireless channel quality measurement/calculation unit 918 of the calculated pattern of the pilot.

The wireless channel quality measurement/calculation unit 918 controls the pilot extraction unit 919 in such a manner that the pattern of the pilot, which is notified from the pilot calculation unit 917, is extracted. Then, the wireless channel quality measurement/calculation unit 918 performs measurement of the wireless channel quality that is based on the pilot being output from the pilot extraction unit 919, and performs calculation of the wireless channel quality information that is based on a result of the calculation. Furthermore, the wireless channel quality measurement/calculation unit 918 outputs the calculated wireless channel quality information to the cell selection control unit 925 and the wireless channel quality information creation unit 931. The pieces of wireless channel quality information are, for example, the CQI, the RSRP, the RSRQ, and the like.

The synchronization control unit 921 accomplishes synchronization between the synchronization control unit 921 and the base station that is a transmitting source of the pilot, based on the result of the extraction, which is output from the synchronization signal extraction unit 915, and on the synchronization signal being output from the synchronization signal creation unit 926. The synchronization is, for example, synchronization of a wireless frame, such as adjustment of the timing of a head of a frame, synchronization of slots that make up the wireless frame, or symbols (or a wireless signal) that make up the slot. Moreover, one wireless frame is configured from 20 slots, or from 10 subframes with two slots making up one subframe.

Based on the timing when the synchronization is accomplished, the synchronization control unit 921 performs synchronization control that control the time of receiving or of transmitting in the terminal 900. For example, the synchronization control unit 921 notifies the terminal setting control unit 922 of the timing when the synchronization is accomplished between the synchronization control unit 921 and the base station.

Based on the timing that is notified from the synchronization control unit 921, the terminal setting control unit 922 performs control of the reception wireless unit 911, the demodulating/decoding unit 912, the coding/modulating unit 933, and the transmission wireless unit 934. For example, the system information being output from the system information extraction unit 913 or the system information stored in the system information storage unit 923 are used for the control by the terminal setting control unit 922. Furthermore, control relating to the carrier aggregation and the like is included in the terminal setting control unit 922.

The wireless channel control unit 924 performs control of the wireless channel for the terminal 900. For example, the random access, the handover, or the like is included in the control of the wireless channel for the terminal 900. The control of the wireless channel for the terminal 900 is performed, for example, based on the system information stored in the system information storage unit 923, the wireless channel control information being output from the wireless channel control information extraction unit 914, or the like. The cell ID that is output from the cell ID extraction unit 916 and is stored in the system information storage unit 923 is also included in the system information stored in the system information storage unit 923. The wireless channel control unit 924 notifies the wireless channel control signal creation unit 932 of the wireless channel control information in accordance with the wireless channel control.

The cell selection control unit 925 makes a selection of the P cell or the S cell to which the terminal 900 is to connect. The cell selection is made by the cell selection control unit 925 based on the wireless channel quality information being output from the wireless channel quality measurement/calculation unit 918, the system information being output from the system information extraction unit 913, cell selection information stored in the system information storage unit 923, or the like.

Furthermore, a measurement-target cell ID being output from the wireless channel control unit 924 is used in the cell selection by the cell selection control unit 925. Then, the cell selection control unit 925 notifies the wireless channel quality information creation unit 931 of the selected cell. Furthermore, the cell selection control unit 925 outputs to the pilot calculation unit 917 and the synchronization signal creation unit 926 the measurement-target cell ID being output from the wireless channel control unit 924.

For example, in a case where a P cell is selected, the cell selection control unit 925 selects a cell that is available for connection as a P cell, based on the information on the appropriate use of the cell ID's that is included in the system information being output from the system information extraction unit 913 and on the cell ID being output from the cell ID extraction unit 916.

Furthermore, in a case where an S cell is selected, the cell selection control unit 925 selects a cell that is available for connection as an S cell, based on the information on the appropriate use of the cell ID's that is included in the system information from the system information extraction unit 913 and on the cell ID from the cell ID extraction unit 916. However, in a case where the S cell to which the terminal 900 is to connect is selected in the base station 800, the cell selection control unit 925 selects an S cell that is indicated by the system information.

Furthermore, based on the measurement-target cell ID being output from the wireless channel control unit 924, the cell selection control unit 925 controls the cell that is a target for the measurement and calculation of the wireless channel quality in the wireless channel quality measurement/calculation unit 918.

The synchronization signal creation unit 926 creates the synchronization signal that is based on the measurement-target cell ID being output from the cell selection control unit 925. Then, the synchronization signal creation unit 926 outputs the created synchronization signal to the synchronization control unit 921.

The transmission data that the terminal 900 has to transmit is input into the transmission unit 930 from the high layer processing unit of the transmission unit 930. The transmission data being input into the transmission unit 930 is input into the transmission data coding/modulating unit 933.

The wireless channel quality information creation unit 931 creates the wireless channel quality information that is based on the wireless channel quality information being output from the wireless channel quality measurement/calculation unit 918 and on the cell that is notified from the cell selection control unit 925. Then, the wireless channel quality information creation unit 931 maps the created wireless channel quality information onto the control channel, and outputs a result of the mapping to the coding/modulating unit 933.

The wireless channel control signal creation unit 932 creates the wireless channel control information notified from the wireless channel control unit 924, maps the created wireless channel control information onto the control channel, and outputs a result of the mapping to the coding/modulating unit 933.

The coding/modulating unit 933 performs coding or modulating of the transmission data being input, or each piece of information (signal) being output from the wireless channel quality information creation unit 931 and the wireless channel control signal creation unit 932. Then, the coding/modulating unit 933 outputs to the transmission wireless unit 934 a signal obtained by the coding or modulating.

The transmission wireless unit 934 performs transmission processing of the signal being from the coding/modulating unit 933. Included in the transmission processing in the transmission wireless unit 934 is, for example, conversion from a digital signal to an analog signal, conversion from a baseband to a high frequency, amplification, or the like. The transmission wireless unit 934 outputs to the antenna 901 a signal obtained by the transmission processing.

FIG. 9C is a diagram illustrating one example of a hardware configuration of the terminal according to the second embodiment. In FIG. 9C, portions that are the same as those in FIGS. 9A and 9B are given the same reference numerals, and descriptions of them are omitted. The terminal 900 illustrated in FIGS. 9A and 9B may be realized, for example, as a communication apparatus 940 that is illustrated in FIG. 9C. The communication apparatus 940 includes an antenna 901, an LSI 941, a DSP 942, a memory 943, a display unit 944, a microphone 945, and a speaker 946.

The LSI 941 is connected to the antenna 901 and the DSP 942. The reception wireless unit 911 and the transmission wireless unit 934 that are illustrated in FIGS. 9A and 9B may be realized, for example, as a circuit such as the LSI 941.

The DSP 942 is connected to the LSI 941 and the memory 943. The DSP 942 performs control of the entire communication apparatus 940. Included in the memory 943 is, for example, a main memory and an auxiliary memory. The main memory is, for example, a RAM. The main memory is used as a work area for the DSP 942. The auxiliary memory is, for example, a nonvolatile memory such as a magnetic disk or a flash memory. Included in the auxiliary memory are various programs that operate the communication apparatus 940. The programs stored in the auxiliary memory are loaded onto the main memory for execution by the DSP 942.

The demodulating/decoding unit 912, the system information extraction unit 913, the wireless channel control information extraction unit 914, the synchronization signal extraction unit 915, and the cell ID extraction unit 916, which are illustrated in FIGS. 9A and 9B, may be realized, for example, as a circuit such as the DSP 942 and as the memory 943. The pilot calculation unit 917, the wireless channel quality measurement/calculation unit 918, and the pilot extraction unit 919, which are illustrated in FIGS. 9A and 9B, may be realized, for example, as a circuit such as the DSP 942 and as the memory 943.

The synchronization control unit 921, the terminal setting control unit 922, the system information storage unit 923, the wireless channel control unit 924, and the cell selection control unit 925, which are illustrated in FIGS. 9A and 9B, may be realized, for example, as a circuit such as the DSP 942 and as the memory 943. The wireless channel quality information creation unit 931, the wireless channel control signal creation unit 932, and the coding/modulating unit 933, which are illustrated in FIGS. 9A and 9B, may be realized, for example, as a circuit such as the DSP 942 and as the memory 943. Furthermore, instead of the DSP 942, a CPU, a combination of the DSP and the CPU, or the like may be used.

The display unit 944, the microphone 945, and the speaker 946 are interfaces between each of them and a user of the communication apparatus 940. The display unit 944 may be, for example, a device that serves also as an input device, such as a touch panel.

Synchronization and Cell ID Calculation

The synchronization such as the frame synchronization or the slot synchronization and the cell ID are described. The PSS and the SSS that are synchronization signals in the LTE system are created based on the cell ID. The cell ID is configured from 168 groups with three cell ID's making up one group, and 504 cell IDS in total are set. N_{ID}(1) indicating a group is an integer value from 0 to 167, and N_{ID}(2) indicating an element in the group is an integer from 0 to 2. When cell ID is expressed by Equation, for example, N_{ID}(cell)=3N_{ID}(1)+N_{ID}(2).

Here, N_{ID}(cell) indicates a cell ID. N_{ID}(1) indicates 168 types of groups (cell groups). N_{ID}(2) indicates three types of identifiers. Accordingly, 504 types of cell ID's may be expressed. In the LTE or LTE-Advanced, if the PSS and the SSS are identified by associating the PSS and the SSS, the cell ID may be identified.

Next, the PSS (route sequence) is described. The PSS is a 62-bit signal sequence. The PSS is generated using a Zadoff-Chu sequence in a frequency domain, and may be expressed, for example, by described-below Equation (6).

$${d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix} \qquad ( 6 )$$

Here, a route index u and an identifier N_{ID}(2) of a cell group are associated. The route index u indicates an index of a Zadoff-Chu route sequence, and three types of route indexes u are defined in advance. The terminal 900 may perform blind estimation of the PSS and specify N_{ID}(2) from a detected sequence.

Therefore, it is understood that three signal lines as the PSS are configured. That is, in a case where the synchronization is implemented using the PSS, three signal lines are prepared in advance, and a signal line may be checked for matching. For example, the terminal 900 checks for a correlation between a signal line of the received PSS and the three signal lines and selects a signal line that has a close correlation, that is, a signal line that is most plausible.

Additionally, the PSS is transmitted on a slot #0 and a slot #10, among 10 subframes (a subframe #0 to a subframe #9) and 20 slots (a slot #0 to a slot #19) that make up a wireless frame. Therefore, a slot in which the PSS is detected is a slot #0 or a slot #10. Based on this, a head of the slot #0 or of the slot #10 may be calculated and the slot synchronization may be implemented. The heads of the subframe #0 including the slot #0 and of the subframe #5 including the slot #10 may be calculated, and the subframe synchronization may implemented. Additionally, the frame synchronization may be implemented starting with the slot #0 that is a head of the wireless frame.

Next, the SSS is described. Like the PSS, the SSS is a 62-bit signal line, and for example, may be expressed by described-blow Equation (7). The SSS has a structure in which a binary sequence that is 31 bits long is interleaved, and is scrambled using a scramble sequence (c₀(n), c₁(n)) that is given with the PSS. However, 0≦n≦30.

$$d ( 2 n ) = \{ \begin{matrix}{s}_{0} ( {m}_{0} ) ( n ) {c}_{0} ( n ) in subframe 0 \\ {s}_{1} ( {m}_{1} ) ( n ) {c}_{0} ( n ) in subframe 5\end{matrix} \\ d ( 2 n + 1 ) = \{ \begin{matrix}{s}_{1} ( {m}_{1} ) ( n ) {c}_{1} ( n ) {z}_{1} ( {m}_{0} ) ( n ) in subframe 0 \\ {s}_{0} ( {m}_{0} ) ( n ) {c}_{1} ( n ) {z}_{1} ( {m}_{1} ) ( n ) in subframe 5\end{matrix} \qquad ( 7 )$$

m₀ and m₁ are associated with N_{ID}(1), and may be expressed by described-below Equation (8).

$${m}_{0} = {m}^{′} mod 31 \\ {m}_{1} = ( {m}_{0} + ⌊ {m}^{′} / 31 ⌋ + 1 ) mod 31 \\ {m}^{′} = {N}_{ID} ( 1 ) + q ( q + 1 ) / 2 , q = ⌊ \frac{{N}_{ID} ( 1 ) + {q}^{′} ( {q}^{′} + 1 ) / 2}{30} ⌋ , {q}^{′} = ⌊ {N}_{ID} ( 1 ) / 30 ⌋ \qquad ( 8 )$$

A relation between m₀ and m₁, and N_{ID}(1) is defined in advance by described-above Equation (8), for example, in the system. Furthermore, s₀(m₀)(n) and s₁(m₁)(n) are generated by cyclic-shifting an m sequence ̂s(n). That is, s₀(m₀)(n) and s₁(m₁)(n) may be expressed by described-below Equation (9).

$$\begin{matrix}{s}_{0} ( {m}_{0} ) ( n ) = \hat{} s ( ( n + {m}_{0} ) mod 31 ) \\ {s}_{1} ( {m}_{1} ) ( n ) = \hat{} s ( ( n + {m}_{1} ) mod 31 )\end{matrix} \hat{} s ( i ) = 1 - 2 x ( i ) 0 \leq i \leq 30 \qquad ( 9 )$$

Furthermore, m sequence ̂s(n) may be expressed by described-below Equation (10).

x((ī+5)=(x(ī+2)+x( i̅))mod 2 (10)

0≦ i̅≦25,x(0)=0,x(1)=0,x(2)=0,x(3)=0, and x(4)=1

Moreover, in an initial state, x(0)=0, x(1)=0, x(2)=0, x(3)=0, and x(4)=1.

Next, c₀(n) and c₁(n) are described. c₀(n) and c₁(n) are a scramble sequence that depends on the PSS, and is expressed as a cyclic shift of an m sequence ̂s(n). That is, c₀(n) and c₁(n) may be expressed, for example, by described-below Equation (11).

$$\begin{matrix}{c}_{0} ( n ) = \hat{} c ( ( n + {N}_{ID} ( 2 ) ) mod 31 ) \\ {c}_{1} ( n ) = \hat{} c ( ( n + {N}_{ID} ( 2 ) + 3 ) mod 31 )\end{matrix} \hat{} c ( i ) = 1 - 2 x ( i ) 0 \leq i \leq 30 \qquad ( 11 )$$

̂c(n), like the m sequence ̂s(n), is expressed as ̂c(i)=1−2x(i), but is different from the m sequence ̂s(n) in that x(i) is as expressed in described-below Equation (12).

x(ī+5)=(x(ī+3)+x( i̅))mod 2 0≦ i̅≦25 (12)

Next, z₁(m₀)(n) and z₁(m₁)(n) are described. z₁(m₀)(n) and z₁(m₁)(n) are also generated by cyclic-shifting the m sequence ̂s(n), and may be expressed, for example, by described-below Equation (13).

z₁(m₀)(n)=̂z((n+(m₀ mod 8))mod 31)

z₁(m₁)(n)=̂z((n+(m₁ mod 8))mod 31) (13)

̂z(i)=1−2x(i),0≦i≦30

̂z(n), like the m sequence ̂s(n), is expressed as ̂z(i)=1−2x(i), but is different from the m sequence ̂s(n) in that x(i) is as expressed in described-below Equation (14).

x(ī+5)=(x(ī+4)+x(ī+2)+x(ī+1)+x(i))mod 2, 0≦i≦25

x(0)=0,x(1)=0,x(2)=0,x(3)=0,X(4)=1 (14)

Because a mechanism (scrambling or the like by the m sequence or the PSS) by which the SSS is generated is known, in the terminal 900, based on these pieces of information, m₀ and m₁ are identified and N_{ID}(1) may be deducted. Then, based on N_{ID}(1) and N_{ID}(2), N_{ID}(cell) may be deducted.

Furthermore, the terminal 900 that receives the SSS divides an even number (d(2n)) of the received SSS by c₀(n) and c₁(n) that are calculated based on N_{ID}(2) which is obtained with the PSS, and thus obtains s₀(m₀)(n) and s₁(m₁)(n).

Furthermore, the terminal 900 calculates a correlation between s₀(m₀)(n) and s₁(m₁)(n) that are created with identified m₀ and m₁, thus may deduct m₀ and m₁ of the received SSS, and may deduct N_{ID}(1). Accordingly, the cell ID is calculable. Furthermore, the slot synchronization and the frame synchronization that are based on the cell ID are possible.

When N_{ID}(cell) is known that is a cell ID on which the slot synchronization (or the frame synchronization) is based, the pilot signal that is transmitted by the neighboring base station may be also deducted. The pilot signal line in the LTE system may be calculated, for example, by described-below Equations (15) to (17).

$$\begin{matrix} η , {n}_{s} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) \\ m = 0 , 1 … , 2 {N}_{RB} ( max , DL ) - 1 & ( 15 ) \\ c ( n ) = ( {x}_{1} ( n + {N}_{C} ) + {x}_{2} ( n + {N}_{C} ) ) mod 2 \\ {x}_{1} ( n + 31 ) = ( {x}_{1} ( n + 3 ) + {x}_{1} ( n ) ) mod 2 \\ {x}_{2} ( n + 31 ) = ( {x}_{2} ( n + 3 ) + {x}_{2} ( n + 2 ) + {x}_{2} ( n + 1 ) + {x}_{2} ( n ) ) mod 2 & ( 16 ) \\ {N}_{C} = 1600 , {x}_{1} ( 0 ) = 1 , {x}_{1} ( n ) = 0 , n = 1 , 2 , … , 30 \\ {c}_{init} = {2}^{10} \cdot ( 7 \cdot ( {n}_{s} + 1 ) + 1 + 1 ) \cdot ( 2 \cdot {N}_{ID} ( cell ) + 1 ) + 2 \cdot {N}_{ID} ( cell ) + {N}_{CP} {c}_{init} & ( 17 )\end{matrix}$$

nₛ indicates a slot number. The slot number may be identified by accomplishing the slot synchronization. I indicates an OFDM symbol number. In the OFDM symbol number, an arrangement of the pilot signals in the time direction is prescribed in advance. c(i) indicates a pseudo random signal line (pseudo-random noise (PN)).

N_{CP} is a normal CP or an extended CP. The extended CP is used in a large cell or in a case where multicast broadcast single frequency network (MBSFN) transmission is performed, and takes less time than the normal CP.

In this manner, when the cell ID is known, the pilot signal line is calculable. For this reason, the terminal 900 that receives the pilot signal line compares the pilot signal line that is created based on the cell ID that is calculated by receiving the synchronization signal, and the received pilot signal line, and thus the synchronization in units (simply referred to as symbols) of OFDM symbols is possible.

As described above, synchronization signal (the PSS and the SSS) in the LTE system is created based on the cell ID. Furthermore, the cell ID has a value from 0 to 503, and a remainder that occurs after dividing the cell ID by 3, that is, N_{ID}(cell) mod 3 is any of 0, 1, and 2. For this reason, the cell ID is divided into three groups because of the remainder that occurs after the division by 3.

Furthermore, the PSS is calculated based on described-above Equation (6), and the SSS is calculated based on described-above Equations (7) to (14). Therefore, the PSS and the SSS are received and the cell ID may be calculated from the synchronization signal of each of the PSS and the SSS.

For example, allocation may be performed on three values (from 0 to 2) of N_{ID}(2), as one example, as expressed in described-below Equation (18).

$${N}_{ID}^{( 2 )} = \{ \begin{matrix}0 \text{:} PCell \\ 1 \text{:} SCell \\ 2 \text{:} PCell , SCell\end{matrix} \qquad ( 18 )$$

In a case where, in described-above Equation (18), N_{ID}(2) is 0, this indicates that the cell from which the corresponding synchronization signal is transmitted is available for connection as a P cell (indicates PCell). In a case where N_{ID}(2) is 1, this indicates that the cell from which the corresponding synchronization signal is transmitted is available for connection as an S cell (indicates SCell). In a case where N_{ID}(2) is 2, this indicates that the cell from which the corresponding synchronization signal is transmitted is available for connection as any one of the P cell and S cell (indicates the PCell and SCell).

Furthermore, the allocation may be performed on three values (From 0 to 2) of N_{ID}(2), as one example, as expressed in described-below Equation (19).

$${N}_{ID}^{( 2 )} = \{ \begin{matrix}0 \text{:} P cell in the heirarchical cell structure \\ 1 \text{:} S cell in the heirarchical cell structure \\ 2 \text{:} P cell or S cell in the normal cell structure\end{matrix} \qquad ( 19 )$$

In a case where, in described-above Equation (19), N_{ID}(2) is 0, this indicates that the cell that has a hierarchical cell structure and from which the corresponding synchronization signal is transmitted is available for connection as a P cell (indicates the PCell). In a case where N_{ID}(2) is 1, this indicates that the cell that has a hierarchical cell structure and from which the corresponding synchronization signal is transmitted is available for connection as an S cell (indicates the SCell). In a case where N_{ID}(2) is 2, this indicates that the cell that has a normal cell structure (non-hierarchical cell structure) and from which the corresponding synchronization signal is transmitted is available for connection as any one of the P cell and S cell (indicates the PCell and SCell).

However, the allocation in described-above Equations (18) and (19) is one example, and as soon as it may be determined whether the cell is available for connection as a P cell, or is available for connection as an S cell, different settings may be possible. Additionally, N_{ID}(1), as described above, may be deducted from the SSS, and it may be determined whether the cell is used as a P cell or is used as an S cell.

For example, the information on the appropriate use of the cell ID's, which indicates the allocation in the described-above Equations (18) or (19) may be stored in advance, as system shared information, in the base station 800 and the terminal 900, and may be, as the system information, broadcast by the base station 800 to the terminal 900. Furthermore, the allocation of the cell ID to the base station 800 is performed in an apparatus that is at a higher level than the base station 800, the information on the appropriate use of the cell ID's may be stored in the high-level apparatus, not the base station 800.

P Cell Connection Processing by the Terminal According to the Second Embodiment

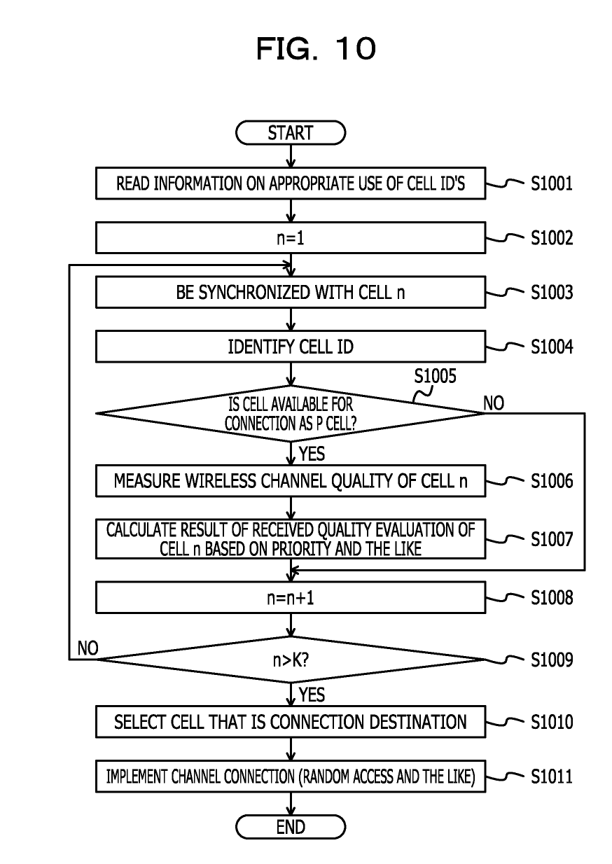

FIG. 10 is a flowchart illustrating one example of P cell connection process by the terminal according to the second embodiment. The terminal 900 implements, for example, each step in FIG. 10, as the P cell connection processing. First, the terminal 900 reads the information on the appropriate use of the cell ID's (Step S1001). The information on the appropriate use of the cell ID's is, for example, information indicating the allocation in described-above Equation (18) or (19). For example, the terminal 900 reads the information on the appropriate use of the cell ID's that is stored in the memory in the terminal 900. Next, the terminal 900 initializes n (n=1) (Step S1002). n is a variable in which an index of a connection candidate cell is stored.

Next, the terminal 900 is synchronized with a cell n (Step S1003). Next, the terminal 900 identifies the cell ID of the cell n the synchronization with which is accomplished in Step S1003 (Step S1004). For example, the terminal 900 calculates N_{ID}(2) from the PSS that is transmitted from the cell n. Furthermore, the terminal 900 calculates N_{ID}(1) from the SSS that is transmitted from the cell n. Then, the terminal 900 identifies the cell ID of the cell n from the calculated N_{ID}(2) and N_{ID}(1). For example, the cell ID, as described above, may be calculated by N_{ID}(cell)=3 N_{ID}(1)+N_{ID}(2).

Next, the terminal 900 determines whether or not the cell n the synchronization with which is accomplished in Step S1003 is available for connection as a P cell (Step S1005). The determination in Step S1005 is performed based on the information on the appropriate use of the cell ID's read in Step S1001 and on the cell ID identified in Step S1004. For example, in a case where the information on the appropriate use of the cell ID's is the information indicating the allocation in described-above Equations (18) or (19), the terminal 900 performs the determination in Step S1005 based on the remainder that occurs after dividing the cell ID by 3, and on the information on the appropriate use of the cell ID's.

In a case where, in Step S1005, a cell is not available for connection as a P cell (No in Step S1005), the terminal 900 proceeds to Step S1008. In a case where a cell is available for connection as a P cell (Yes in Step S1005), the terminal 900 measures the wireless channel quality of the cell n (Step S1006). The wireless channel quality that is measured in Step S1006 is, for example, the RSRQ, the RSRP, or the like.

Next, the terminal 900 calculates the result of the received quality evaluation of the cell n that is based on the wireless channel quality that is measured in Step S1006 (Step S1007). Adjustment information, for example, such as the priority of the cell n, is used in the calculation of the result of the received quality evaluation. The adjustment information, for example, may be acquired from the system information that is received from the cell n after the synchronization with the cell n is accomplished.

Next, the terminal 900 increments n by one (n=n+1) (Step S1008). Next, the terminal 900 determines whether or not n is greater than K (Step S1009). K is the number of candidate cells that are available for the connection to the terminal 900. In a case where n is not greater than K (No in Step S1009), the terminal 900 returns to Step S1003.

In a case where, in Step S1009, n is greater than K (Yes in Step S1009), the terminal 900 selects a cell that is a connection destination, from among the cells that, in Step S1005, are determined as being available for connection as P cells (Step S1010). The selection of the cell as the connection destination is made, for example, based on a result of comparison that is the result of the received quality evaluation calculated in Step S1007.

Next, the terminal 900 implements channel connection, such as random access to the cell selected in Step S1010 (Step S1011) and terminates a sequence of P cell connection processing steps. Because the channel connection in Step S1011 is a connection to the P cell, this is performed, for example, by contention-based random access (for example, refer to FIG. 7A).

For example, the terminal 900 accomplishes the synchronization with the cell that is selected in Step S1010, once more, and receives the system information relating to the channel connection from the selected cell. Included in the system information is, for example, a group of random access preambles that are available for use, a transmission format of the random access preamble, transmission timing of the random access preamble, an initial value of the transmission power for the random access preamble, and the like. In the LTE system, these pieces of information are included, for example, in SIB 2 that is defined in 3GPP TS 36.331.

Based on the information for the channel connection, which is included in the SIB2, for example, the terminal 900 starts the contention-based random access illustrated in FIG. 7A. At this time, the random access preamble is used as information for identifying the terminal 900. Furthermore, in the contention-based random access, the terminal 900 may use configuration information on Random Access CHannel (RACH) or on Physical RACH (PRACH).

Here, the case is described where the terminal 900 identifies the cell ID of the cell n, and the determination is performed in Step S1005 based on the identified cell ID and on the information on the appropriate use of the cell ID's. In contrast, the terminal 900 may perform the determination in Step S1005 based on N_{ID}(2) calculated from the PSS and on the information on the appropriate use of the cell ID's. In this case, the specification of the cell ID in Step S1004 may be omitted, and the specification of the cell ID in Step S1004 may be performed after Step S1005.

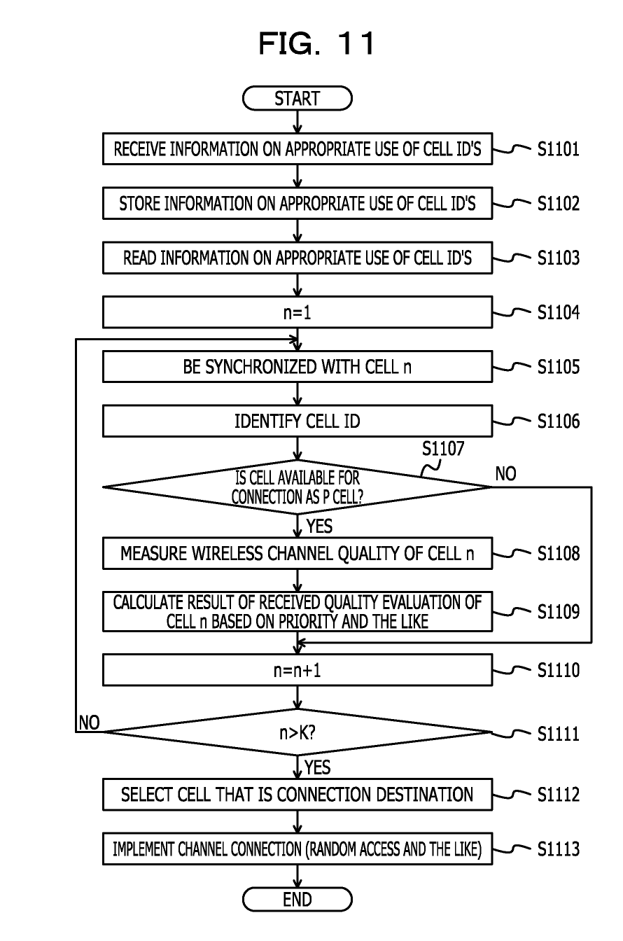

FIG. 11 is a flowchart illustrating a modification example 1 of the P cell connection processing by the terminal according to the second embodiment. The terminal 900 may implement, for example, each step in FIG. 11, as the P cell connection processing. First, the terminal 900 receives the information on the appropriate use of the cell ID's from the base station 800 (Step S1101). For example, in order to camp on or connect to a certain base station, the terminal 900 measures the wireless channel quality from the neighboring base station, and selects the cell that has the best result of the measurement.

For example, the terminal 900 measures the received power, and selects the cell that has the highest level of the received power. The received power may be set to be a received power that is based, for example, on a specific signal (for example, a pilot), such as a received signal strength indicator (RSSI). Furthermore, the received power may be a received power that is based, for example, on envelope detection or the like. Then, the terminal 900 is synchronized with the selected cell, and receives the information on the appropriate use of the cell ID's from the cell the synchronization with which is accomplished.

Next, the terminal 900 stores the information on the appropriate use of the cell ID's, which is received in Step S1101, in the memory in the terminal 900 (Step S1102). Steps S1103 to S1113 that are illustrated in FIG. 11 are the same as Steps S1001 to S1011 illustrated in FIG. 10. However, in Step S1103, the terminal 900 reads the information on the appropriate use of the cell ID's stored in Step S1102.

As illustrated in FIG. 11, the terminal 900 may receive the information on the appropriate use of the cell ID's from the base station 800. Accordingly, for example, even though the information on the appropriate use of the cell ID's varies according to the base station, the information on the appropriate use of the cell ID's, of the base station that performs the wireless communication, may be acquired.

As illustrated in FIGS. 10 and 11, by allocating different cell ID's to the P cell and the S cell, the terminal 900 may determine whether or not the cell is a P cell, using the cell ID identified from the synchronization signal. Accordingly, for example, it is possible to suppress the selection of and the connection to the cell that is not available for connection as a P cell, and to select the most optimal cell as a P cell for connection. Moreover, here, the optimal cell may be a cell that is served by the base station that has the highest level of the received power, and may be a cell that has the best received power quality. Furthermore, the optimal cell may be selected taking into consideration both the quality of the received power and the quality of the received signal.

Furthermore, for example, as illustrated in FIGS. 10 and 11, possibly, the measurement of the wireless channel quality may not be performed on the cell that is not available for connection as a P cell. Accordingly, efficiency of the measurement of the wireless channel quality may be accomplished.

S Cell Connection Processing by the Terminal According to the Second Embodiment

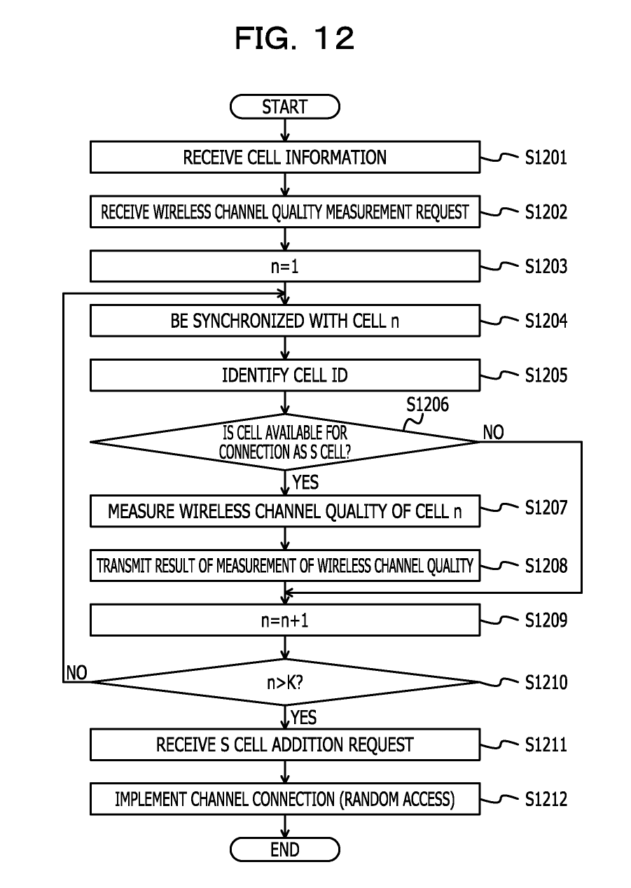

FIG. 12 is a flowchart illustrating one example of S cell connection processing by the terminal according to the second embodiment. The terminal 900 implements, for example, each step that is illustrated in FIG. 12, as the S cell connection processing, in a state where the connection to the P cell (for example, the base station 511) is established through the P cell connection processing illustrated in FIGS. 10 and 11.

First, the terminal 900 receives the cell information on the cell adjacent to the P cell, from the P cell (Step S1201). The cell adjacent to the P cell is a cell that is a candidate for an S cell for the terminal 900. The cell information may include, for example, a frequency of each small-sized cell under the control of the P cell, a bandwidth, system information such as the cell ID, and the like.

Next, the terminal 900 receives a wireless channel quality measurement request that requests the measurement of the wireless channel quality, from the P cell (Step S1202). Moreover, for example, in a case where the terminal 900 periodically performs the measurement of the wireless channel quality, Step S1202 may be omitted from the processing.

Next, the terminal 900 initializes n (n=1) (Step S1203). n is a variable in which an index of a connection candidate cell that is indicated by the cell information received in Step S1201 is stored. Next, the terminal 900 is synchronized with the cell n (Step S1204). The synchronization in Step S1204 may be performed, for example, based on a frequency, a bandwidth, a cell ID, and the like that are included in the cell information received in Step S1201.

Next, the terminal 900 identifies the cell ID of the cell n the synchronization with which is accomplished in Step S1204 (Step S1205). The specification of the cell ID in Step S1205 is, for example, the same as the specification of the cell ID in Step S1004 illustrated in FIG. 10.

Next, the terminal 900 determines whether or not the cell n the synchronization with which is accomplished in Step S1204 is available for connection as an S cell (Step S1206). The determination in Step S1206 is performed based on the information on the appropriate use of the cell ID's, and on the cell ID identified in Step S1205. For example, in a case where the information on the appropriate use of the cell ID's is the information indicating the allocation in described-above Equations (18) or (19), the terminal 900 performs the determination in Step S1205 based on the remainder that occurs after dividing the cell ID by 3, and on the information on the appropriate use of the cell ID's.

The information on the appropriate use of the cell ID's is, for example, the information on the appropriate use of the cell ID's read in Step S1001 illustrated in FIG. 10, or the information on the appropriate use of the cell ID's read in Step S1103 illustrated in FIG. 11. In a case where a cell is not available for connection as an S cell (No in Step S1206), the terminal 900 proceeds to Step S1209.

In a case where, in Step S1206, a cell is available for connection as an S cell (Yes in Step S1206), the terminal 900 measures the wireless channel quality of the cell n (Step S1207). The wireless channel quality that is measured in Step S1207 is, for example, the RSRQ, the RSRP, or the like. The measurement of the wireless channel quality in Step S1207 may be performed, for example, based on a frequency, a bandwidth, an cell ID, and the like that are included in the cell information received in Step S1201. Next, the terminal 900 transmits a result of the measurement of the wireless channel quality in Step S1207 to the P cell in the connection processing (Step S1208).

Next, the terminal 900 increments n by one (n=n+1) (Step S1209). Next, the terminal 900 determines whether or not n is greater than K (Step S1210). K is the number of candidate cells that are available for the connection to the terminals 900, which is indicated by the information received in Step S1201. In the case where n is not greater than K (No in Step S 1210), the terminal 900 returns to Step S1204.

In a case where, in Step S1210, n is greater than K (Yes in Step S1210), the terminal 900 receives an S cell addition request from the P cell (Step S1211). The S cell addition request is a control signal that requests the terminal 900 to add a cell that is selected by the P cell based on the result of the measurement transmitted in Step S1208, as an S cell.

Next, the terminal 900 implements the channel connection, such as the random access that is based on the S cell addition request received in Step S1211 (Step S1212), and terminates a sequence of S cell connection processing steps. Because the channel connection in Step S1212 is a connection to the S cell, this is performed, for example, by noncontention-based random access (for example, refer to FIG. 7B).

For example, included in the S cell addition request is a dedicated preamble of the noncontention-based random access, which is usable in the S cell that is a connection destination. The terminal 900 performs the noncontention-based random access using the dedicated preamble that is included in the S cell addition request, and thus may connect to the S cell selected by the P cell.

Moreover, in the case of the S cell in which only the downlink is established, the terminal 900 implements the channel connection by adding a channel without implementing the random access in Step S1212. That is, the terminal 900 is requested to allow for the receiving form the selected cell, and the terminal 900 that receives the request is set in such a manner as to allow for the receiving from the newly-selected S cell.

S Cell Selection Processing by the Base Station According to the Second Embodiment

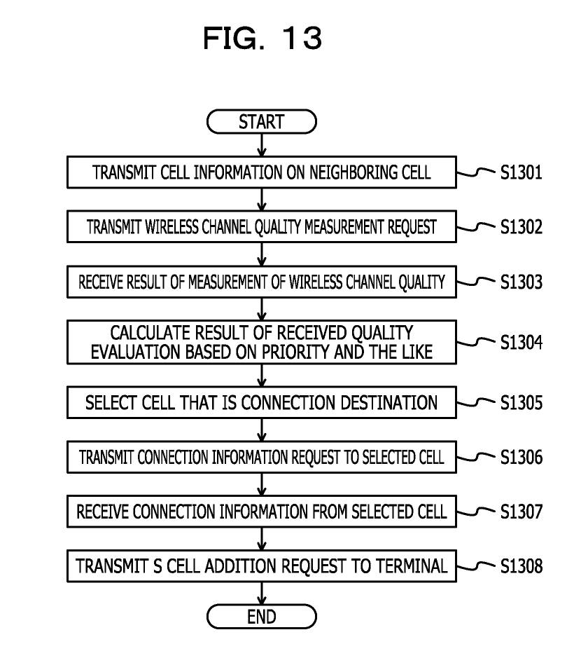

FIG. 13 is a flowchart illustrating one example of S cell selection processing by the base station (P cell) according to the second embodiment. The base station 800 (for example, the base station 511), to which the terminal 900 connects in a state where the P cell is served, implements, for example, each step that is illustrated in FIG. 13 as the S cell selection processing for the terminal 900.

First, the base station 800 transmits to the terminal 900 the cell information on a cell (for example, a cell that is served by the base station 531) adjacent to the cell that is served by the base station 800 itself (Step S1301). Next, the base station 800 transmits the terminal 900 the wireless channel quality measurement request that requests the measurement of the wireless channel quality (Step S1302). Moreover, for example, in the case where the terminal 900 periodically performs the measurement of the wireless channel quality, Step S1302 may be omitted from the processing. Next, the base station 800 receives, for example, a result of the measurement of the wireless channel quality that is transmitted from the terminal 900 in Step S1208 illustrated in FIG. 12 (Step S1303).

Next, the base station 800 calculates a result of the received quality evaluation that is based on the result of the measurement received in Step S1303 (Step S1304). The priority or offset of a cell is used in the calculation of the result of the received quality evaluation. The calculation of the result of the received quality evaluation that is based on the priority, the offset, or the like is, for example, the same as the calculation of the result of the received quality evaluation, which is described above.

Next, the base station 800 selects a cell that is a connection destination of the terminal 900, from among the cells that are available, as an S cell, for the connection to the terminal 900 (Step S1305). The selection of the cell as the connection destination is made, for example, based on the result of comparison that is the result of the received quality evaluation calculated in Step S1304. For example, the base station 800 selects a cell that achieves the best result of the received quality evaluation, or any one of the cells that achieves a result of the received quality evaluation that is equal to or higher than a threshold, as a cell that is a connection destination.

Next, the base station 800 transmits a connection information request that requests connection information to be used in order for the terminal 900 to establish a connection, to the cell (for example, the base station 531) selected in Step S1305 (Step S1306). A dedicated preamble of the noncontention-based random access is included, for example, in the connection information. The dedicated preamble is a random access preamble that is usable by a specific terminal during a specific period, and is also referred to as a dedicated random access preamble.

Next, the base station 800 receives connection information in response to the connection information request transmitted in Step S1306, from the cell selected in Step S1305 (Step S1307). Next, the base station 800 transmits to the terminal 900 the S cell addition request that includes the connection information, such as the dedicated preamble received in Step S1307, and that requests a cell addition (Step S1308), and terminates a sequence of S cell selection processing steps.

S Cell Selection by the Terminal According to the Second Embodiment

The case where the S cell selection is made in the base station 800 is described, but the S cell selection may be made in the terminal 900.

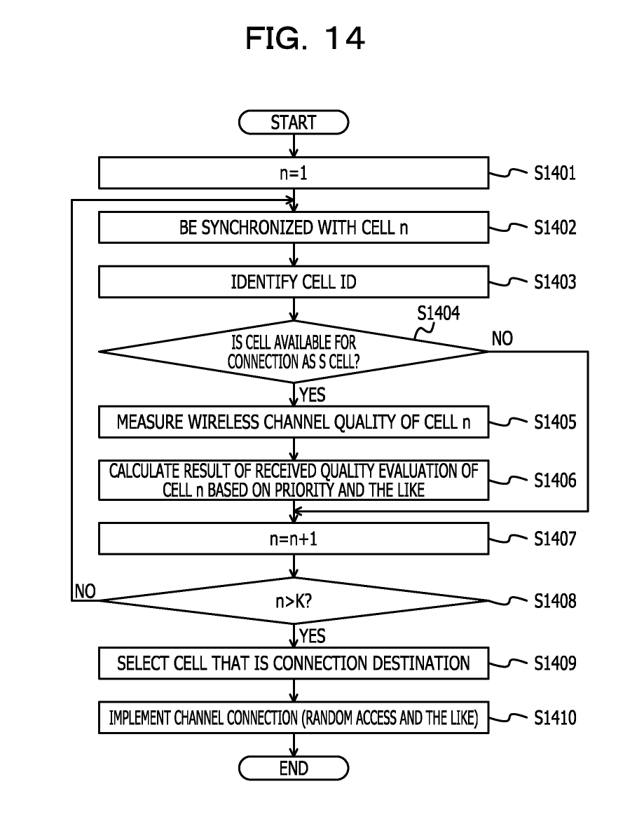

FIG. 14 is a flowchart illustrating a modification example of the S cell connection processing by the terminal according to the second embodiment. The terminal 900 may implement, for example, each step in FIG. 14, as the S cell connection processing. First, the terminal 900 initializes n (n=1) (Step S1401). n is a variable in which an index of a connection candidate cell is stored.

Next, the terminal 900 is synchronized with the cell n (Step S1402). Next, the terminal 900 identifies the cell ID of the cell n the synchronization with which is accomplished in Step S1402 (Step S1403). The specification of the cell ID in Step S1403 is, for example, the same as the specification of the cell ID in Step S1004 illustrated in FIG. 10.

Next, the terminal 900 determines whether or not the cell n the synchronization with which is accomplished in Step S1402 is available for connection as an S cell, based on the cell ID identified in Step S1403 and on the information on the appropriate use of the cell ID's (Step S1404). The determination in Step S1404 is, for example, the same as the determination in Step S1206 illustrated in FIG. 12. In a case where a cell is not available for connection as an S cell (No in Step S1404), the terminal 900 proceeds to Step S1407.

In a case where, in Step S1404, a cell is available for connection as an S cell (Yes in Step S1404), the terminal 900 measures the wireless channel quality of the cell n (Step S1405). The wireless channel quality that is measured in Step S1405 is, for example, the RSRQ, the RSRP, or the like.

Next, the terminal 900 calculates the result of the received quality evaluation of the cell n that is based on the wireless channel quality that is measured in Step S1405 (Step S1406). The adjustment information, such as the priority of the cell n, is used in the calculation of the result of the received quality evaluation. The adjustment information, for example, may be acquired from the system information that is received from the cell n after the synchronization with the cell n is accomplished.

Next, the terminal 900 increments n by one (n=n+1) (Step S1407). Next, the terminal 900 determines whether or not n is greater than K (Step S1408). K is the number of candidate cells that are available for the connection to the terminal 900. In the case where n is not greater than K (No in Step S1408), the terminal 900 returns to Step S1402.

In a case where, in Step S1408, n is greater than K (Yes in Step S1408), the terminal 900 selects a cell that is a connection destination, from among the cells that, in Step S1404, are determined as being available for connection as S cells (Step S1409). The selection of the cell as the connection destination is made, for example, based on a result of comparison that is the result of the received quality evaluation calculated in Step S1406.

Next, the terminal 900 implements channel connection, such as random access to the cell selected in Step S1409 (Step S1410) and terminates a sequence of S cell connection processing steps. The channel connection in Step S1410 is, for example, by the contention-based random access (for example, refer to FIG. 7A). Furthermore, the channel connection in Step S1410 may be by the noncontention-based random access (for example, refer to FIG. 7B).

Here, the case where the appropriate use that is based on N_{ID}(2) is provided to indicate whether a cell is a P cell, or an S cell, or the like is described. In contrast, for example, ID's (0 to 503) may be appropriately used to indicate whether a cell is available for connection as a P cell, or is available for connection an S cell, or is available for connection the P cell and the S cell.

Allocation of the Cell ID to the P Cell and the S Cell

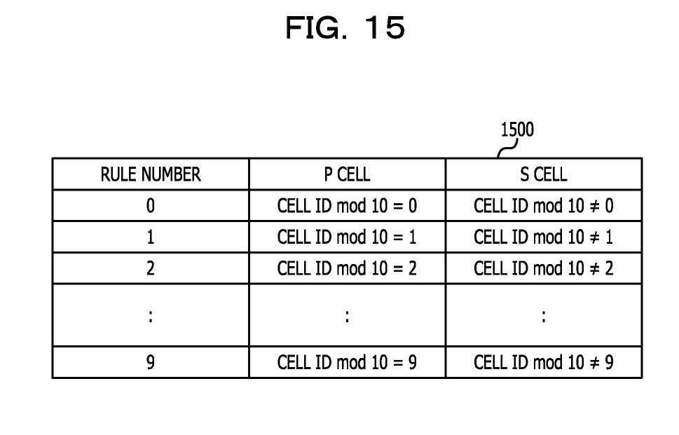

FIG. 15 is a diagram illustrating one example of the allocation of the cell ID to the P cell and the S cell. A table 1500 that is illustrated in FIG. 15 illustrates the allocation of the cell ID to each of the P cell and the S cell. For example, a rule number “0” indicates the allocation in which a cell of which the cell ID is a multiple of 10 is set to be a P cell and a cell that has a different cell ID is set to be an S cell. Furthermore, a rule number “1” indicates the allocation in which a cell of which the cell ID, when divided by 10, has a remainder of 1 is set to be a P cell and a cell of which the cell ID has a different remainder is set to be an S cell.

For example, among rules in the table 1500, the base station 800 broadcasts a rule that is applied in the system including the base station 800, as information on the appropriate use of the cell ID's, and the terminal 900 receives the information on the appropriate use of the cell ID's. Furthermore, the base station 800 and the terminal 900 may store the table 1500 in advance. In this case, among the rules in the table 1500, the base station 800 broadcasts a rule number indicating the rule that is applied in the system including base station 800, as the information on the appropriate use of the cell ID's.

These pieces of information on the appropriate use of the cell ID's are broadcast, for example, as the system information described above. Furthermore, these pieces of information on the appropriate use of the cell ID's may be broadcast, for example, as a list of neighboring cells described below.

Moreover, the allocation of the cell ID to the P cell and the S cell is not limited to the rules illustrated in the table 1500, and various types of allocation may be used. For example, the rules in the table 1500 is based on the allocation according to the remainder that occurs after dividing the cell ID by 10, but, as one example, may be based on the allocation according to the remainder that occurs after dividing the cell ID by 4.

Furthermore, the rules in the table 1500 are not limited to the allocation according to the remainder that occurs after diving the cell ID by a predetermined value, and, the allocation may be performed according to a range of cell ID's, for example, such as when a cell of which the cell ID ranges from 0 to a predetermined value is set to be a P cell, and a cell of which the cell ID ranges from (the predetermined value+1) to 503 is set to be an S cell. Furthermore, for example, the allocation of the cell ID to each of the P cell and the S cell may be allocation that is determined at random. That is, the allocation of the cell ID to each of the P cell and S cell may possibly be allocation by which to determine the appropriate use of the P cell and the S cell from the cell ID, for example, in the terminal 900.

In this manner, according to the second embodiment, in the hierarchical cell structure, an error in the selection of the P cell and the S cell may be suppressed in the terminal 900 by allocating different ID's (resources) for the P cell and the S cell to the transmission of the synchronization signal from the base station 800.

For example, in the LTE system, the W-CDMA system, or the like, information on a cell adjacent to the base station to which the terminal connects is broadcast, as a neighboring cell list, to the terminal. The terminal to which the neighboring cell list is broadcast stores the neighboring cell list. On the occasion of the storage, the terminal stores information relating to the base station to which the terminal connected before and to the cell adjacent to the base station, as a cell list (visited list). Furthermore, in a case where information on the cell that is not included in the cell list in association with movement is received, the terminal additionally stores information on a new cell in the cell list. Then, the terminal implements the measurement of the wireless channel quality of the neighboring cell based on the cell list, and makes a cell selection or makes a cell reselection.

On the other hand, as described above, a configuration in which a macro cell is set to be a P cell and a small cell (for example, a pico cell) under the control of the macro cell is set to be an S cell is under study in the 3GPP. It is considered that control information is transmitted in the P cell and user data (dedicated data) is mainly transmitted in the S cell. Here, the small cell has a smaller area than the macro cell. For this reason, the number of neighboring cells increases in association with the movement of the terminal. That is, contents of the neighboring cell list increase. As a result, the cell list that is stored in the terminal becomes longer.

Furthermore, the LTE-Advanced system that is under discussion in the 3GPP is referred to as “Fourth Generation” and is referred to as IMT-Advanced in the ITU. With the spread of smartphones and with the spread of portable phones in newly emerging countries, a volume of traffic in the wireless communication increases worldwide. On the other hand, there is a limit to frequencies that are available for specification, and usable frequencies are added with a transition from a band of 800 MHz in which a propagation loss is small and which maintains high occupancy to a high frequency that may be widened in bandwidth.

For this reason, in the LTE and TDD, the use of a band of 3.6 GHz has been determined (for example, refer to 3GPP TS 36.104). However, the higher the frequency, the greater the propagation loss. In such a case, the propagation becomes only in the straight line direction and electromagnetic wave diffraction is reduced. For this reason, many dead spots where the communication is not possible is present. Small cells for cover the dead spots are assumed to be arranged. That is, it is assumed that many dead spots are present within a macro cell and that many small cells are arranged.

In a case where many small cells are arranged in this manner, as described above, the cell list in which the terminal has to store becomes longer. Moreover, there are present many cells that are targets for cell selection or cell reselection. As a result, an amount of processing of these tasks is increased in order to implement the measurement and notification of the wireless channel quality.

In contrast, according to the second embodiment, the P cell and the S cell are determined in advance based on the cell ID. That is, the appropriate use of the P cell and the S cell is implemented using the cell ID. For example, a cell of which the cell ID is a multiple of 10 is set to be a P cell and a cell that has a different cell ID is set to be an S cell. The information on the appropriate use of the cell ID's indication these types of allocation is broadcast, as the described-above system information, from the base station 800 to the terminal 900.

With the appropriate use of the cell ID's, a cell that is available only as the S cell may be kept from being erroneously cell-selected as a P cell, or a connection request may be kept from being transmitted to such a cell. Conversely, a cell that is available only as the P cell may be kept from being erroneously cell-selected as an S cell, or the connection request may be kept from being transmitted to such a cell.

Furthermore, when the P cell is selected, possibly, the wireless channel quality possibly, the measurement of may not be performed on the cell that is not available for connection as a P cell. Furthermore, when the S cell is selected, possibly, the wireless channel quality possibly, the measurement of may not be performed on the cell that is not available for connection as a S cell. Accordingly, efficiency of the measurement of the wireless channel quality may be accomplished.

### Third Embodiment

Portions that distinguish a third embodiment from the second embodiment are described.

According to the second embodiment, for example, the appropriate use in which, with N_{ID}(2) or the cell ID, it is indicated whether or not a cell is available for connection as a P cell and an S cell. In the appropriate use, the cell ID is reusable if positions are separated a predetermined space (distance) from one another in such a manner that synchronization signals generated based on the cell ID do not interfere with one another. However, in a case where, as described above, many small cells are arranged, because, for example, only 504 cell ID's are present, there is a concern that the interference will occur.

In contrast, according to a third embodiment, for example, it is assumed that rules for the appropriate use of the cell ID's indicating the P cell and the cell ID indicating the S cell are different from each other, as units of areas such as a position-registered area (tracking area (TA)). Accordingly, a configuration of many small cells is possible.

As one example, in a certain area, a cell of which the cell ID is a multiple of 10 is set to be a P cell and a cell that has a different cell ID is set to be an S cell. Furthermore, in another area, a cell of which the cell ID, when divided by 10, has a remainder of 3 may be set to be a P cell and a cell of which the cell ID has a different remainder may be set to be an S cell.

For example, in a case where the terminal 900 moves straddling the position-registered areas and implements handover, a rule for the appropriate use of the cell ID's is changed. For this reason, a rule change is notified to the terminal 900 before the handover. Moreover, the rule change may be notified before the measurement of the wireless channel quality is performed.

Cell Connection Processing by the Terminal According to the Third Embodiment

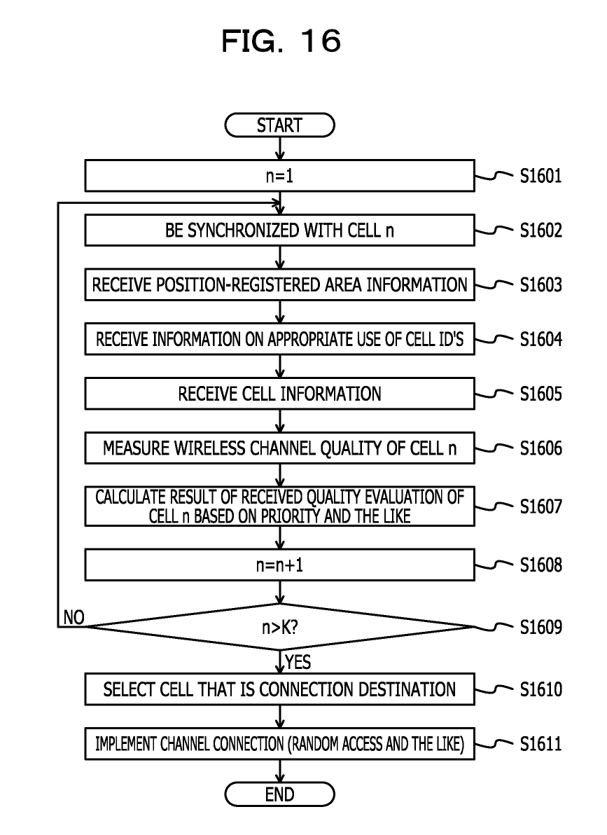

FIG. 16 is a flowchart illustrating one example of cell connection processing by the terminal according to the third embodiment. The terminal 900 according to the third embodiment implements, for example, each step that is illustrated in FIG. 16, as the cell connection processing of the P cell or the S cell. Steps S1601 and S1602 that are illustrated in FIG. 16 are the same as Steps S1002 and S1003 illustrated in FIG. 10.

Subsequent to Step S1602, the terminal 900 receives position-registered area information from the cell n the synchronization with which is accomplished in Step S1602 (Step S1603). Furthermore, the terminal 900 receives the information on the appropriate use of the cell ID's from the cell n the synchronization with which is accomplished in Step S1602 (Step S1604). Furthermore, the terminal 900 receives the cell information such as the priority from the cell n the synchronization with which is accomplished in Step S1602 (Step S1605). The order in which Steps S1603 to S1605 may be performed may be changed. Furthermore, the terminal 900 may arrange the position-registered area information, the information on the appropriate use of the cell ID's, and the cell information into the system information of the cell n, and may receive the resulting system information.

Steps S1606 to S1611 are the same as Steps S1006 to S1011 illustrated in FIG. 10. Furthermore, when connecting to the P cell, for example, in the same manner as in the processing illustrated in FIG. 10, the terminal 900 may determine whether or not the cell n is available for connection as a P cell, based on the information on the appropriate use of the cell ID's received in Step S1604 and on the synchronization signal from the cell n. In this case, the terminal 900 may exclude the cell n that is available for connection as a P cell, from selection candidates in Step S1610. The terminal 900 may exclude the cell n that is not available for connection as a P cell from measurement targets in Step S1606 and calculation targets in Step S1607.

Furthermore, when connecting to the S cell, for example, in the same manner as in the processing illustrated in FIG. 14, the terminal 900 may determine whether or not the cell n is available for connection as an S cell, based on the information on the appropriate use of the cell ID's received in Step S1604 and on the synchronization signal from the cell n. In this case, the terminal 900 may exclude the cell n that is available for connection as an S cell, from selection candidates in Step S1610. The terminal 900 may exclude the cell n that is not available for connection as an S cell from the measurement targets in Step S1606 and the calculation targets in Step S1607.

Cell Connection Processing that is Performed when the Terminal According to the Third Embodiment Makes a Cell Reselection

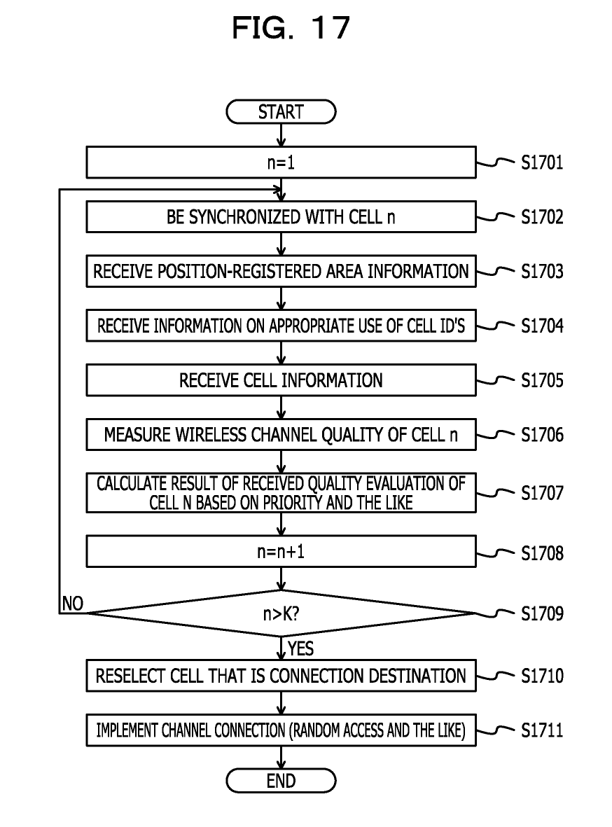

FIG. 17 is a flowchart illustrating one example of cell connection processing that is performed when the terminal according to the third embodiment makes a cell reselection. The terminal 900 according to the third embodiment implements, for example, each step illustrates in FIG. 17, as the cell connection processing that is performed when a cell reselection of the P cell or the S cell is made. Steps S1701 to S1711 that are illustrated in FIG. 17 are the same as Steps S1601 to S1611 illustrated in FIG. 16.

However, for example, when connecting to the P cell, in Step S1710, the terminal 900 reselects a cell that is a connection destination, from among the cells that are determined as being available for connection as P cells. Furthermore, when connecting to the S cell, in Step S1710, the terminal 900 reselects a cell that is a connection destination, from among the cells that are determined as being available for connection as S cells.

As illustrated in FIGS. 16 and 17, the information on the appropriate use of the cell ID's is received from each cell, and it may be determined whether or not the cell n is available for connection as a P cell (or an S cell), based on the information on the appropriate use of the cell ID's, which is received from the cell n. Accordingly, even though the information on the appropriate use of the cell ID's varies from position-registered area to position-registered area, it may be precisely determined whether or not each cell is available for connection as a P cell (or an S cell).

S Cell Selection Processing by the Base Station According to the Third Embodiment

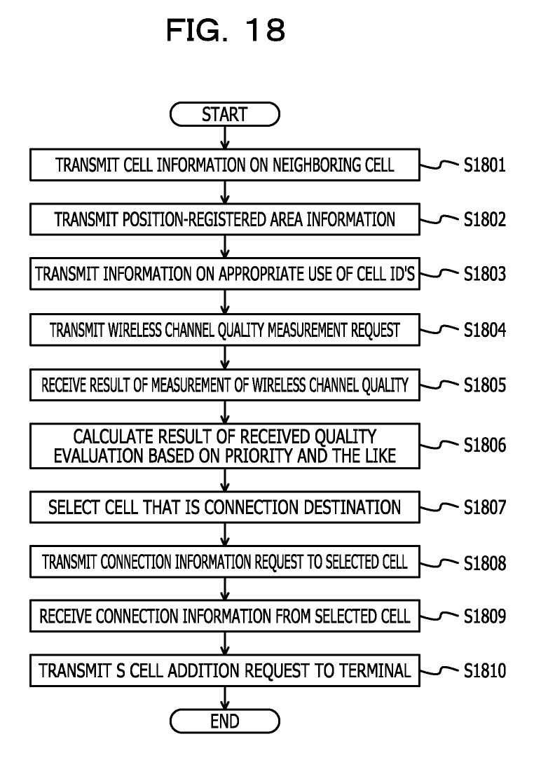

FIG. 18 is a flowchart illustrating one example of the S cell selection processing by the base station (P cell) according to the third embodiment. According to the third embodiment, the base station 800 (for example, the base station 511), to which the terminal 900 connects in a state where the P cell is served, implements, for example, each step that is illustrated in FIG. 18 as the S cell selection processing for the terminal 900. Moreover, the S cell selection processing that is illustrated in FIG. 18 may be also applied, for example, when the handover to the S cell is performed.

Step S1801 that is illustrated in FIG. 18 is the same as Step S1301 illustrated in FIG. 13. Subsequent to Step S1801, the base station 800 transmits the terminal 900 the position-registered area information indicating a position-registered area of a cell that is served by the base station 800 itself (Step S1802). Furthermore, the base station 800 transmits the terminal 900 the information on the appropriate use of the cell ID's corresponding to the position-registered area of the cell that is served by the base station 800 itself (Step S1803).

The order in which Steps S1801 to S1803 may be performed may be changed. Furthermore, the terminal 900 may arrange the position-registered area information, the information on the appropriate use of the cell ID's, and the cell information into the system information of the cell n, and may transmit the resulting system information. Steps S1804 to S1810 that are illustrated in FIG. 18 are the same as Steps S1302 to S1308 illustrated in FIG. 13.

Information on the Appropriate Use of the Cell ID's for Every Position-Registered Area

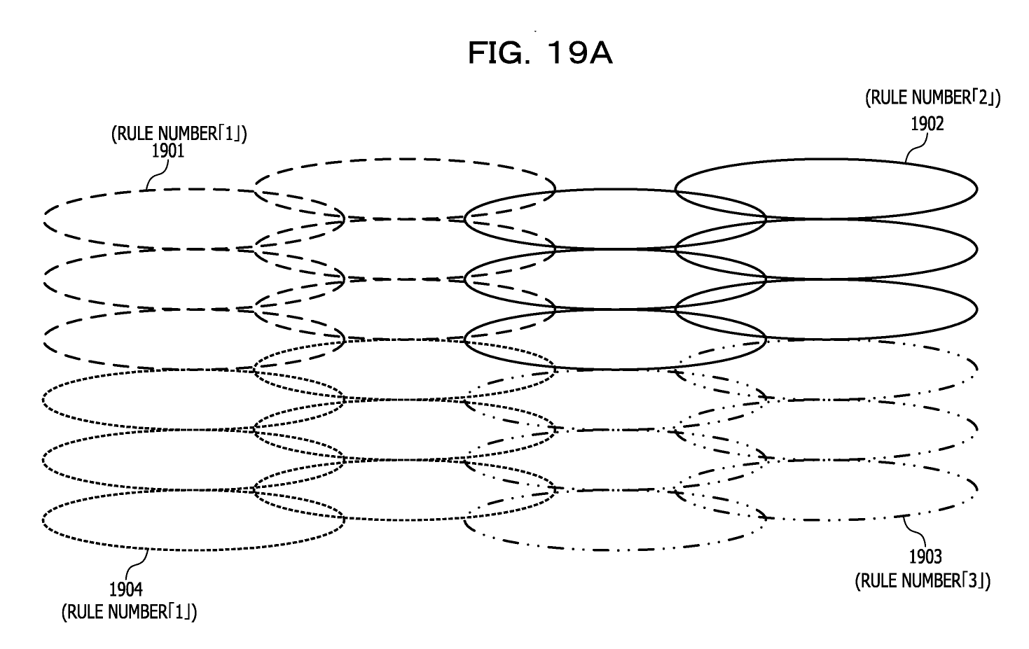

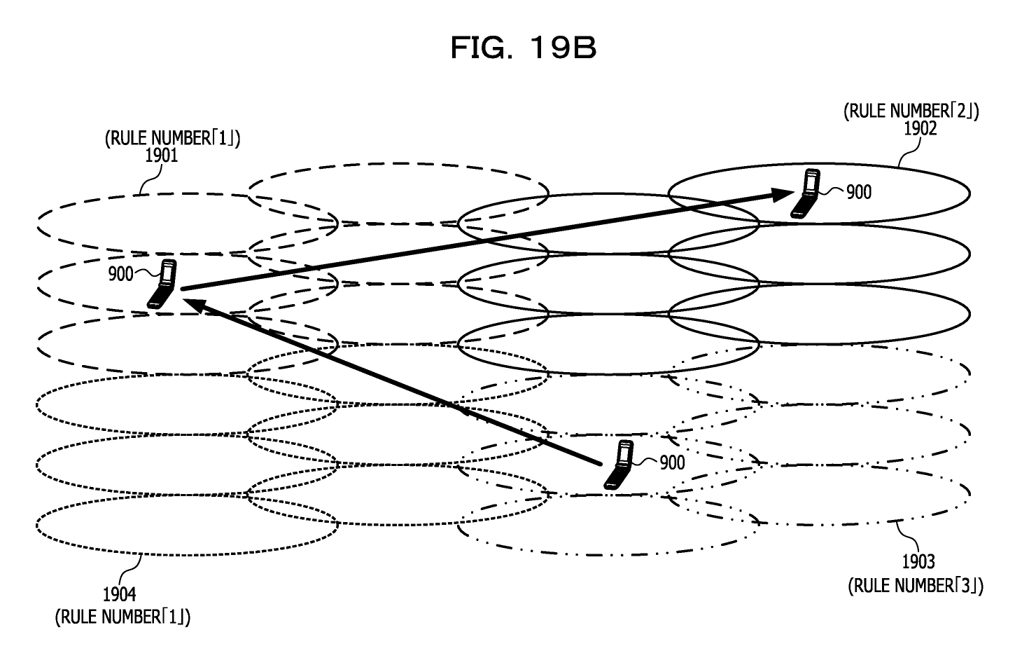

FIG. 19A is a diagram illustrating one example of the information on the appropriate use of the cell ID's for every position-registered area. Multiple P cells (six P cells in an example illustrated in FIG. 19A) are included in each of position-registered areas 1901 to 1904 that are illustrated in FIG. 19A. Furthermore, although not illustrated, one or more S cells are formed in a P cell. The information on the appropriate use of the cell ID's is allocated, for example, to each of the position-registered area 1901 to 1904.

In the example that is illustrated in FIG. 19A, a rule number “1” (refer to FIG. 15) is allocated, as the information on the appropriate use of the cell ID's, to the position-registered areas 1901 and 1904. Furthermore, a rule number “2” is allocated, as the information on the appropriate use of the cell ID's, to the position-registered areas 1902. Furthermore, a rule number “3” is allocated, as the information on the appropriate use of the cell ID's, to the position-registered areas 1903. In this manner, the same information on the appropriate use of the cell ID's may be allocated to some of the multiple position-registered areas (the position-registered areas 1901 and 1904 in the example that is illustrated in FIG. 19A).

FIG. 19B is a diagram illustrating one example of movement of the terminal in the position-registered areas. In FIG. 19B, portions that are the same as those in FIG. 19A are given the same reference numerals, and descriptions of them are omitted. In an example in FIG. 19B, the terminal 900 (for example, the terminal 501) moves from a position-registered area 1903 through the position-registered area 1901 to the position-registered area 1902.

Here, the terminal 900, for example, is assumed to store the table 1500 illustrated in FIG. 15. In this case, in the position-registered area 1903, the terminal 900 first receives a rule number “3” from a cell in the position-registered area 1903, and distinguishes between the P cell and the S cell based on the table 1500 and on the information on the appropriate use of the cell ID's, which is deducted from the rule number “3.”

Next, when moving from the position-registered area 1903 to the position-registered area 1901, the terminal 900 receives the number “1” from the cell in the position-registered area 1901. Then, the terminal 900 distinguishes between the P cell and the S cell based on the table 1500 and on the information on the appropriate use of the cell ID's, which is deducted from the rule number “1.”

Next, when moving from the position-registered area 1901 to the position-registered area 1902, the terminal 900 receives the number “2” from the cell in the position-registered area 1902. Then, the terminal 900 distinguishes between the P cell and the S cell based on the table 1500 and on the information on the appropriate use of the cell ID's, which is deducted from the rule number “2.”

Furthermore, as described above, a pilot sequence (pilot signal line) is created based on the cell ID. It is desirable that the pilot sequences do not interfere with one another, that is, that there is no correlation between the pilot sequences. However, it is difficult to create signal sequences that have not correlation to one another at all, and thus the correlation occurs somewhat. That is, in some cases, the interference occurs between the signal sequences, and is difficult to completely separate (or identify).

For this reason, the pilot sequence is accomplished in which pilot interference does not occur between the neighboring (here, which means being in the vicinity) cells (or a very small amount of pilot interference is present). In order to create the pilot sequence based on the cell ID as described above, it is desirable that the cell ID is selected in such a manner that an small amount of interference is present (the interference is reduced).

As one method for such a selection, for example, it is considered that the rule (the information on the appropriate use of the cell ID's) for the appropriate use of the cell ID's is changed. Furthermore, by implementing the measurement of the wireless channel quality on the P cell and the notification of the result of the measurement, an amount of processing may be reduced, and the time that it takes to make a cell selection may be shortened. Furthermore, in the same manner as when the S cell is added, by implementing the measurement of the wireless channel quality on the S cell and the notification of the result of the measurement, an amount of processing may be reduced, and the time that it takes to make a cell selection may be shortened.

For example, the changing of the position-registered area (for example, the tracking area TA) is possible, for example, by checking a tracking area indicator (TAI).

Moreover, the position registration is implemented with a regular period, and the TAI is checked with a regular period. That is, by comparing the TAI at the time of the last position registration and the TAI as the time of the current position registration, it is possible to check whether or not the position-registered area is changed.

Additionally, as described above, by the terminal 900 maintaining the camp-on state for a given period of time or more, when the channel is reestablished, or when a cell reselection is made, in the same manner, the rule for the appropriate use of the new cell ID's is received, and thus the P cell may be identified in accordance with the rule, and a cell reselection may be implemented. Furthermore, the re-setting of the rule for the appropriate use may be performed even though the rule for the appropriate use of the cell ID's is not changed, such as when the position-registered area is not changed or when the cell reselection is made.

Additionally, when, along the position-registered area, the calling from all the base stations 800 within the position-registered area is implemented on the terminal 900 (when the paging is implemented), the rule for the appropriate use may be notified from the base station 800 or an apparatus at a higher level than the base station 800 to the terminal 900. The apparatus at the higher level than the base station 800 is, for example, an MME in the LTE system. Furthermore, at the time of the handover, in the same manner, the rule for the appropriate use may be notified from the base station 800 or the apparatus at the higher level than the base station 800 to the terminal 900.

In this manner, according to the third embodiment, by setting the rule for the appropriate use of the cell ID's in the P cell and the S cell for every area, for example, the appropriate use for suppressing the interference is also possible in the system in which multiple small cells are installed.

### Fourth Embodiment

Portions that distinguish a fourth embodiment from the second embodiment are described. According to the fourth embodiment, an error in the selection of the P cell and the S cell is suppressed in the terminal 900 by allocating different frequencies (resources) for the P cell and the S cell to the transmission of the synchronization signal from the base station 800.

Base Station According to the Fourth Embodiment

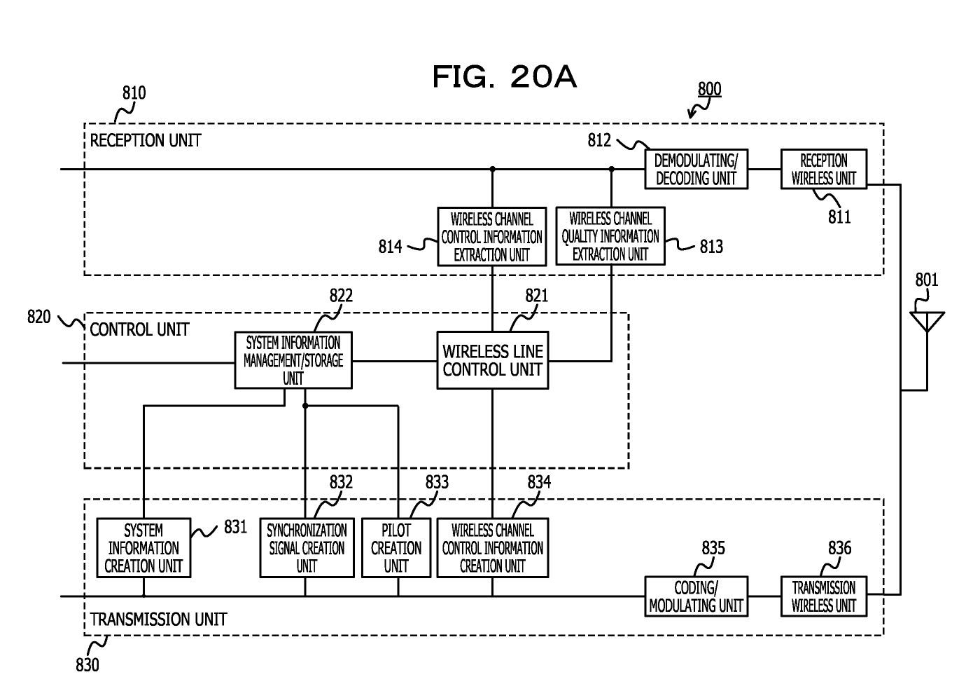

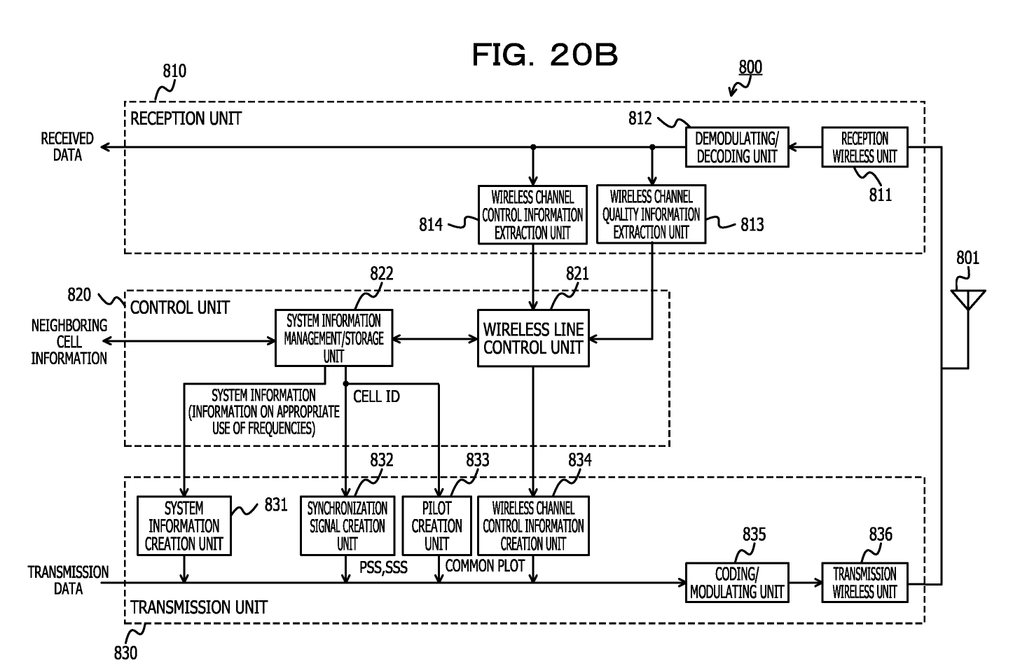

FIG. 20A is a diagram illustrating one example of a base station according to a fourth embodiment. FIG. 20B is a diagram illustrating one example of a signal flow in the base station illustrated in FIG. 20A. In FIGS. 20A and 20B, portions that are the same as those in FIGS. 8A and 8B are given the same reference numerals, and descriptions of them are omitted.

As illustrated in FIGS. 20A and 20B, according to the fourth embodiment, the system information management/storage unit 822 notifies the system information creation unit 831 of the system information including information on the appropriate use of the frequencies, which is described below. For example, the system information management/storage unit 822 includes in the system information the information on the appropriate use of the frequencies that is stored in advanced by the base station 800. Furthermore, the system information management/storage unit 822 may include in the system information the information on the appropriate uses of the frequencies, which is received from an apparatus (for example, an MME) that is at a higher level than the base station 800.

Terminal According to the Fourth Embodiment

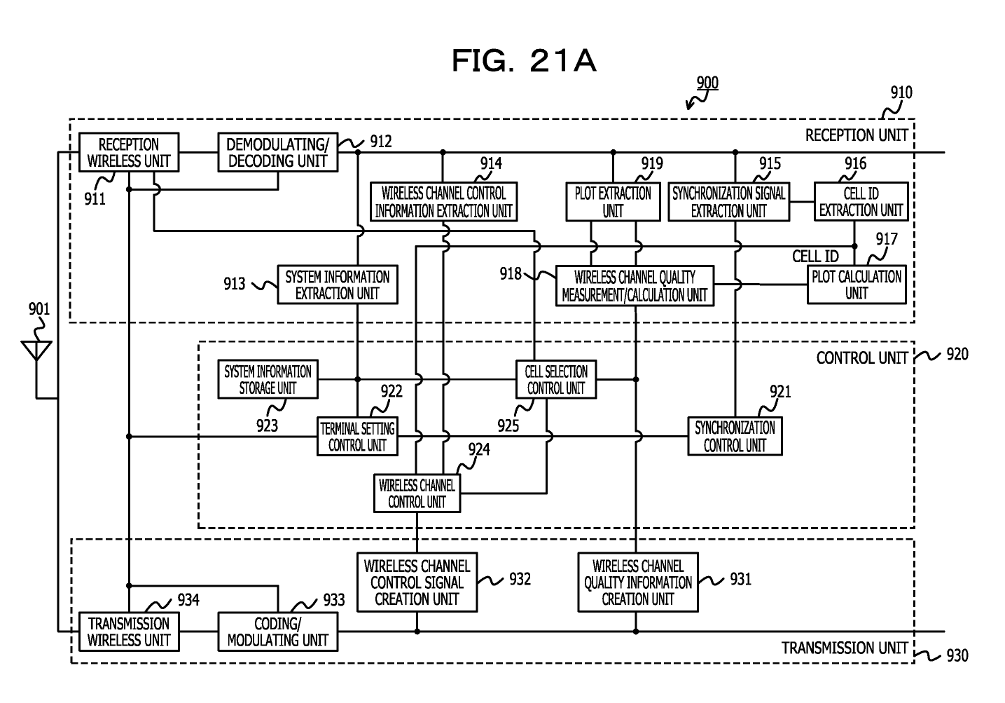

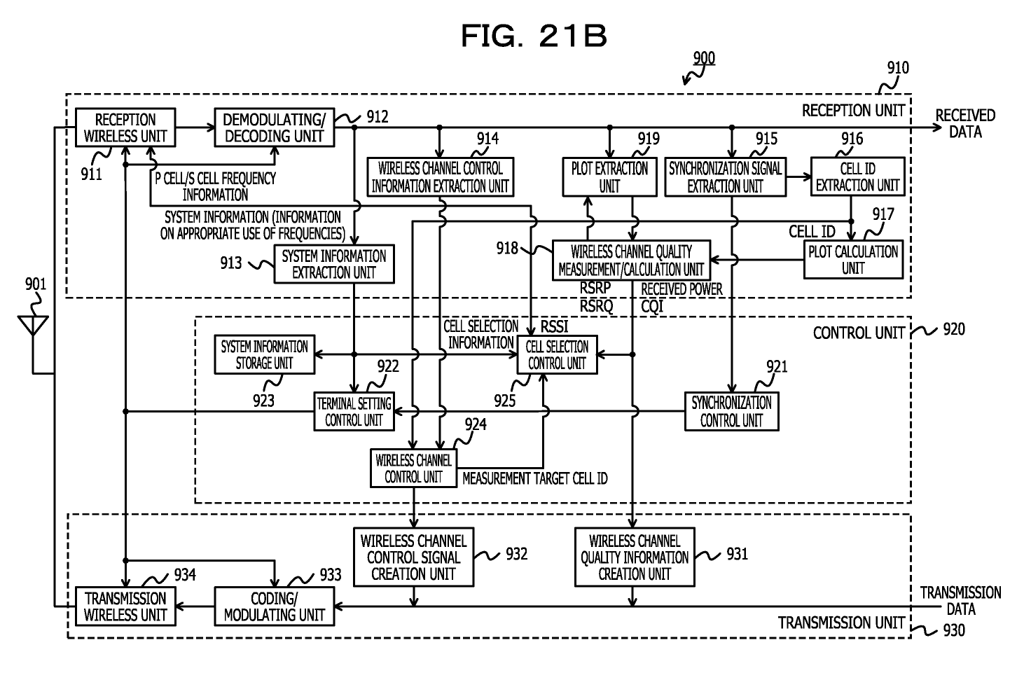

FIG. 21A is a diagram illustrating one example of a terminal according to the fourth embodiment. FIG. 21B is a diagram illustrating one example of a signal flow in the terminal illustrated in FIG. 21A. In FIGS. 21A and 21B, portions that are the same as those in FIGS. 9A and 9B are given the same reference numerals, and descriptions of them are omitted. As illustrated in FIGS. 21A and 21B, the control unit 920 according to the fourth embodiment includes the synchronization control unit 921, the terminal setting control unit 922, the system information storage unit 923, the wireless channel control unit 924, and the cell selection control unit 925.

The described-above information on the appropriate use of the frequencies is included in the system information that is extracted by the system information extraction unit 913 according to the fourth embodiment. The cell selection control unit 925 acquires the information on the appropriate use of the frequencies that is included in the system information being output from the system information extraction unit 913. Furthermore, the cell selection control unit 925 may acquire the information on the appropriate use of the frequencies, which is included in the system information stored in the system information storage unit 923 being output from the system information extraction unit 913.

Then, when selecting a P cell, the cell selection control unit 925 identifies a frequency corresponding to the P cell based on the information on the appropriate use of the frequencies, and outputs P cell frequency information indicating the identified frequency to the reception wireless unit 911. Accordingly, in the reception wireless unit 911, only the frequency corresponding to the P cell is band-searched for, and the RSSI of the frequency corresponding to the P cell is output from the reception wireless unit 911 to the cell selection control unit 925. In contrast, among the frequencies corresponding to the P cell, the cell selection control unit 925 sets a cell corresponding to the frequency, whose RSSI is output from the reception wireless unit 911 and is equal to or greater than a threshold, to be a selection candidate for the P cell.

Furthermore, when selecting an S cell, the cell selection control unit 925 identifies a frequency corresponding to the S cell based on the information on the appropriate use of the frequencies, and outputs S cell frequency information indicating the identified frequency to the reception wireless unit 911. Accordingly, in the reception wireless unit 911, only the frequency corresponding to the S cell is band-searched for, and the RSSI of the frequency corresponding to the S cell is output from the reception wireless unit 911 to the cell selection control unit 925. In contrast, among the frequencies corresponding to the S cell, the cell selection control unit 925 sets a cell corresponding to the frequency, whose RSSI is output from the reception wireless unit 911 and is equal to or greater than a threshold, to be a selection candidate for the S cell.

Reception Wireless Unit

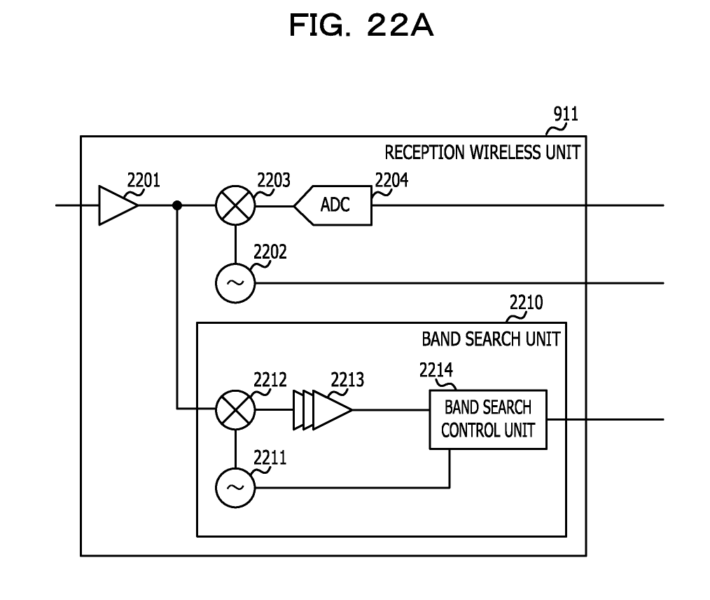

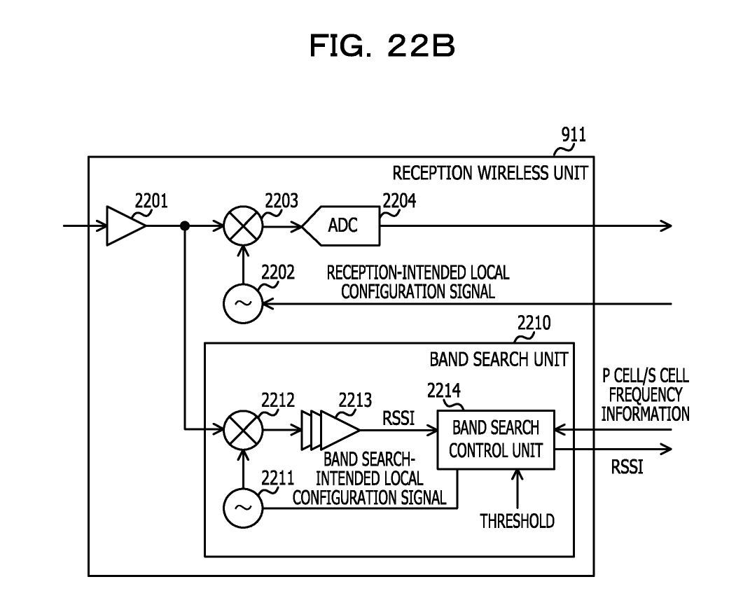

FIG. 22A is a diagram illustrating one example of a reception wireless unit. FIG. 22B is a diagram illustrating one example of a signal flow in the reception wireless unit illustrated in FIG. 22A. As illustrated in FIGS. 22A and 22B, the reception wireless unit 911 includes an amplifier 2201, a local oscillator 2202, a multiplication unit 2203, an ADC 2204, and a band search unit 2210.

The amplifier 2201 amplifies a signal being input into the reception wireless unit 911, and outputs the amplified signal to the multiplication unit 2203 and the band search unit 2210. The amplifier 2201 is, for example, a low noise amplifier (LNA).

The local oscillator 2202 oscillates a signal with a frequency in accordance with a reception-intended local configuration signal being input, and outputs the resulting signal to the multiplication unit 2203. The reception-intended local configuration signal, for example, is input from the terminal setting control unit 922 illustrate in FIGS. 21A and 21B.

The multiplication unit 2203 multiplies a signal being output from the amplifier 2201 and a signal being output from the local oscillator 2202, and a signal resulting from the multiplication to the ADC 2204. Accordingly, frequency conversion of the received signal may be performed.

The analog/digital converter (ADC) 2204 converts a signal being output from the multiplication unit 2203 from an analog signal to a digital signal. Then, the ADC 2204 outputs the digital signal resulting from the conversion to the demodulating/decoding unit 912 (for example, refer to FIGS. 21A and 21B).

The band search unit 2210 performs a band search based on the signal being output from the amplifier 2201. The band search unit 2210 includes a local oscillator 2211, a multiplication unit 2212, an amplifier group 2213, and a band search control unit 2214.

The local oscillator 2211 oscillates a signal with a frequency in accordance with a band search-intended local configuration signal being output from the band search control unit 2214, and outputs the resulting signal to the multiplication unit 2212.

The multiplication unit 2212 multiplies a signal being output from the amplifier 2201 and a signal being output from the local oscillator 2211, and outputs a signal resulting from the multiplication to the amplifier group 2213. Accordingly, the frequency conversion of the received signal may be performed.

The amplifier group 2213 is a multi-stage amplifier, and amplifies a signal being output from the multiplication unit 2212. A signal that results from collecting saturation currents and converting the collected saturation currents into a voltage in the amplifier group 2213 is output, as the RSSI, to the band search control unit 2214.

The band search control unit 2214 outputs to the local oscillator 2211 the band search-intended local configuration signal that is based on the P cell frequency information being output from the cell selection control unit 925 (for example, refer to FIGS. 21A and 21B). Accordingly, the RSSI with a frequency that is indicated by the P cell frequency information is output from the amplifier group 2213. Furthermore, the band search control unit 2214 outputs to the local oscillator 2211 the band search-intended local configuration signal that is based on the S cell frequency information being output from the cell selection control unit 925. Accordingly, the RSSI with a frequency that is indicated by the S cell frequency information is output from the amplifier group 2213.

The band search control unit 2214 compares the RSSI being output from the amplifier group 2213 with a predetermined threshold, and, in a case where the RSSI is equal to or greater than the predetermined threshold, outputs the RSSI, as a result of the band search, to the cell selection control unit 925.

P Cell Connection Processing by the Terminal according to the Fourth Embodiment

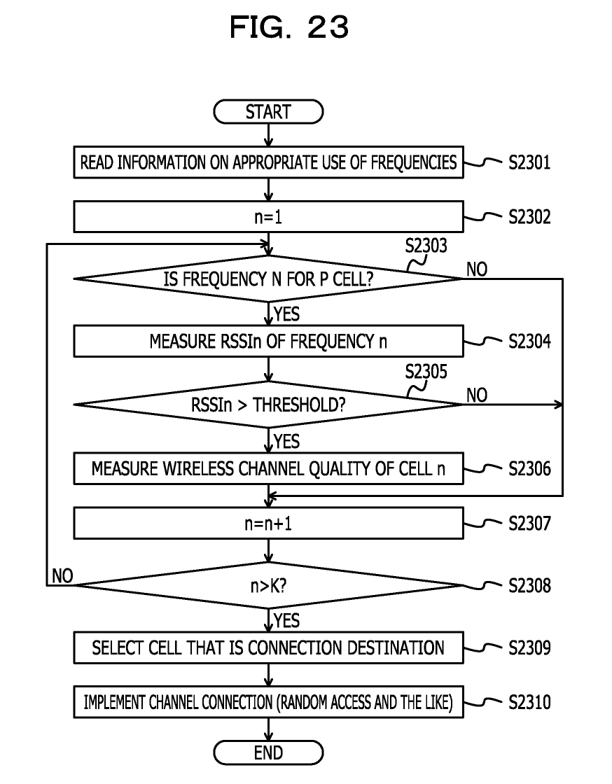

FIG. 23 is a flowchart illustrating one example of the P cell connection process by the terminal according to the fourth embodiment. The terminal 900 according to the fourth embodiment implements, for example, each step that is illustrated in FIG. 23, as the P cell connection processing. First, the terminal 900 reads the information on the appropriate use of the frequencies (Step S2301). For example, the terminal 900 reads the information on the appropriate use of the frequencies that is stored in the memory in the terminal 900. Next, the terminal 900 initializes n (n=1) (Step S2302). n is a variable in which an index of each frequency (cell) that is used within the system is stored.

Next, the terminal 900 determines whether or not a cell that corresponds to a frequency n is available for connection as a P cell, based on the information on the appropriate use of the frequencies, which is read in Step S2301 (Step S2303).

In a case where, in Step S2303, a cell is not available for connection as a P cell (No in Step S2303), the terminal 900 proceeds to Step S2307. In a case where the cell is available for connection as a P cell (Yes in Step S2303), with the band search, the terminal 900 measures an RSSIn of the frequency n (Step S2304).

Next, the terminal 900 determines whether or not the RSSIn measured in Step S2304 is greater than a predetermined threshold (Step S2305). In a case where the RSSIn is not greater than the threshold (No in Step S2305), the terminal 900 proceeds to Step S2307.

In a case where, in Step S2305, the RSSIn is greater than the threshold (Yes in Step S2305), the terminal 900 measures the wireless channel quality of the cell n that corresponds to the frequency n (Step S2306). The wireless channel quality that is measured in Step S2306 is, for example, the RSRQ, the RSRP, or the like.

Next, the terminal 900 increments n by one (n=n+1) (Step S2307). Next, the terminal 900 determines whether or not n is greater than K (Step S2308). K is the number of frequencies (cells) that are used in the system. In the case where n is not greater than K (No in Step S2308), the terminal 900 returns to Step S2303.

In a case where, in Step S2308, n is greater than K (Yes in Step S2308), the terminal 900 selects a cell that is a connection destination, from among the cells that, in Step S2303, are determined as being available for connection as P cells (Step S2309). The selection of the cell as the connection destination is made, for example, based on a result of the comparison of the wireless channel quality measured in Step S2306. Next, the terminal 900 proceeds to Step S2310. Step S2310 is, for example, the same as Step S1011 illustrated in FIG. 10.

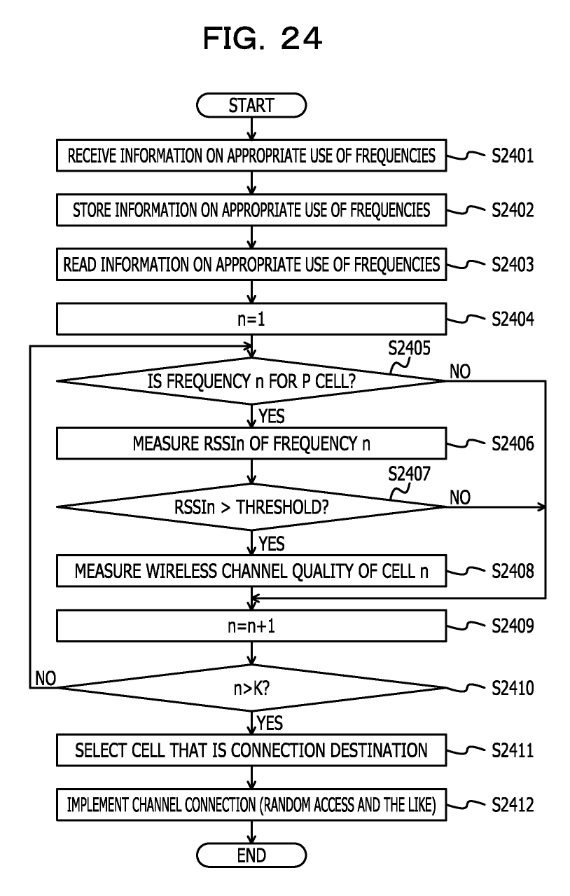

FIG. 24 is a flowchart illustrating a modification example of the P cell connection process by the terminal according to the fourth embodiment. The terminal 900 according to the fourth embodiment may implement, for example, each step that is illustrated in FIG. 24, as the P cell connection processing. First, the terminal 900 receives the information on the appropriate use of the frequencies from the base station 800 (Step S2401). For example, in order to camp on or connect to a certain base station, the terminal 900 measures the wireless channel quality from the neighboring base station, and selects the cell that has the best result of the measurement.

For example, the terminal 900 measures the received power, and selects the cell that has the highest level of the received power. The received power may be set to be a received power that is based, for example, on a specific signal (for example, a pilot), such as the RSSI. Furthermore, the received power may be a received power that is based, for example, on the envelop detection or the like. Then, the terminal 900 is synchronized with the selected cell, and receives the information on the appropriate use of the frequencies from the cell the synchronization with which is accomplished.

Next, the terminal 900 stores the information on the appropriate use of the frequencies, which is received in Step S2401, in the memory in the terminal 900 (Step S2402). Steps S2403 to S2412 that are illustrated in FIG. 24 are the same as Steps S2301 to S2310 illustrated in FIG. 23. However, in Step S2403, the terminal 900 reads the information on the appropriate use of the frequencies stored in Step S2402.

As illustrated in FIG. 24, the terminal 900 may receive the information on the appropriate use of the frequencies from the base station 800. Accordingly, for example, even though the information on the appropriate use of the frequencies varies according to the base station, the information on the appropriate use of the frequencies, of the base station that performs the wireless communication, may be acquired.

As illustrated in FIGS. 23 and 24, by allocating different frequencies to the P cell and the S cell, the terminal 900 may determine whether or not the cell is a P cell, using the frequency of the synchronization signal. Accordingly, for example, it is possible to suppress the selection of and the connection to the cell that is not available for connection as a P cell, and to select the most optimal cell as a P cell for connection. Moreover, here, the optimal cell may be a cell that is served by the base station that has the highest level of the received power, and may be a cell that has the best received power quality. Furthermore, the optimal cell may be selected taking into consideration both the quality of the received power and the quality of the received signal.

Furthermore, for example, as illustrated in FIGS. 23 and 24, possibly, the measurement of the RSSI and the measurement of the wireless channel quality may not be performed on the cell that is not available for connection as a P cell. Accordingly, the efficiency of the measurement of the wireless channel quality may be accomplished.

S Cell Connection Processing by the Terminal According to the Fourth Embodiment

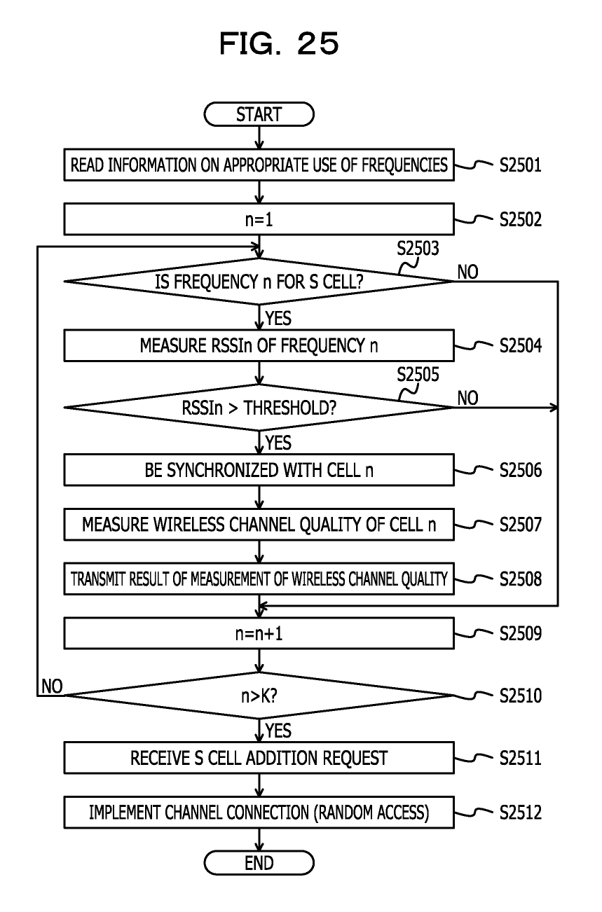

FIG. 25 is a flowchart illustrating one example of S cell connection processing by the terminal according to the fourth embodiment. The terminal 900 according to the fourth embodiment implements, for example, each step that is illustrated in FIG. 25, as the S cell connection processing.

Steps S2501 and S2502 that are illustrated in FIG. 25 are the same as Steps S2301 and S2302 illustrated in FIG. 23. Subsequent to Step S2502, the terminal 900 determines whether or not a cell that corresponds to a frequency n is available for connection as an S cell, based on the information on the appropriate use of the frequencies, which is read in Step S2501 (Step S2503).

In a case where, in Step S2503, a cell is not available for connection as an S cell (No in Step S2503), the terminal 900 proceeds to Step S2509. In a case where the cell is available for connection as an S cell (Yes in Step S2503), with the band search, the terminal 900 measures the RSSIn of the frequency n (Step S2504).

Next, the terminal 900 determines whether or not the RSSIn measured in Step S2504 is greater than a predetermined threshold (Step S2505). In a case where the RSSIn is not greater than the threshold (No in Step S2505), the terminal 900 proceeds to Step S2509.

In a case where, in Step S2505, the RSSIn is greater than the threshold (Yes in Step S2505), the terminal 900 is synchronized with the cell n that corresponds to the frequency n (Step S2506). Next, the terminal 900 measures the wireless channel quality of the cell n the synchronization with which is accomplished in Step S2506 (Step S2507). The wireless channel quality that is measured in Step S2507 is, for example, the RSRQ, the RSRP, or the like.

Next, the terminal 900 transmits a result of the measurement of the wireless channel quality in Step S2507 to the P cell in the connection processing (Step S2508). Next, the terminal 900 increments n by one (n=n+1) (Step S2509). Next, the terminal 900 determines whether or not n is greater than K (Step S2510). K is the number of frequencies (cells) that are used in the system. In the case where n is not greater than K (No in Step S2510), the terminal 900 returns to Step S2503.

In the case where, in Step S2510, n is greater than K (Yes in Step S2510), the terminal 900 proceeds to Step S2511. Steps S2511 and S2512 are, for example, the same as Step S1211 and S1212 illustrated in FIG. 12.

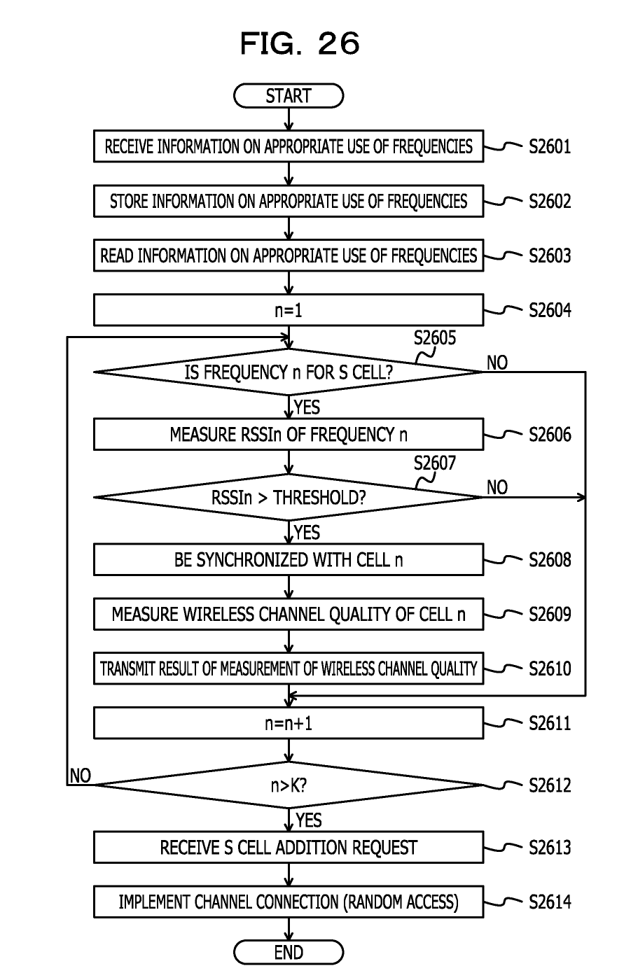

FIG. 26 is a flowchart illustrating a modification example 1 of the S cell connection processing by the terminal according to the fourth embodiment. The terminal 900 according to the fourth embodiment may implement, for example, each step that is illustrated in FIG. 26, as the S cell connection processing. Steps S2601 and S2602 that are illustrated in FIG. 26 are the same as Steps S2401 and S2402 illustrated in FIG. 24.

Steps S2603 to S2614 are the same as Steps S2501 to S2512 illustrated in FIG. 25. However, in Step S2603, the terminal 900 reads the information on the appropriate use of the frequencies stored in Step S2602.

As illustrated in FIGS. 25 and 26, by allocating different frequencies to the P cell and the S cell, the terminal 900 may determine whether or not the cell is an S cell, using the frequency of the synchronization signal. Accordingly, for example, it is possible to suppress the selection of and the connection to the cell that is not available for connection as an S cell, and to select the most optimal cell as an S cell for connection. Moreover, here, the optimal cell may be a cell that is served by the base station that has the highest level of the received power, and may be a cell that has the best received power quality. Furthermore, the optimal cell may be selected taking into consideration both the quality of the received power and the quality of the received signal.

Furthermore, for example, as illustrated in FIGS. 25 and 26, possibly, the measurement of the RSSI and the measurement of the wireless channel quality may not be performed on the cell that is not available for connection as an S cell. Accordingly, the efficiency of the measurement of the wireless channel quality may be accomplished.

In this case, the S cell selection processing by the base station 800, for example, may be set to be the S cell selection processing illustrated in FIG. 13.

S Cell Selection by the Terminal According to the Fourth Embodiment

The case where the S cell selection is made in the base station 800 is described, but the S cell selection may be made in the terminal 900.

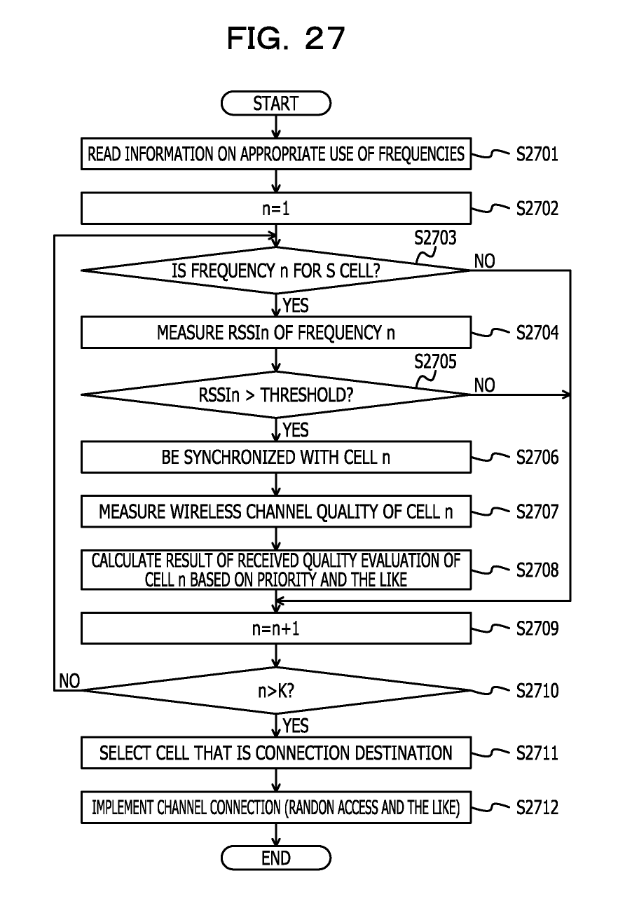

FIG. 27 is a flowchart illustrating a modification example 2 of the S cell connection processing by the terminal according to the fourth embodiment. The terminal 900 may implement, for example, each step in FIG. 27, as the S cell connection processing. Steps S2701 to S2707 that are illustrated in FIG. 27 are the same as Steps S2501 to S2507 illustrated in FIG. 25. Steps S2708 to S2712 are the same as Steps S1406 to S1410 illustrated in FIG. 14.

In this manner, according to the fourth embodiment, in the hierarchical cell structure, an error in the selection of the P cell and the S cell may be suppressed in the terminal 900 by allocating different frequencies (resources) for the P cell and the S cell to the transmission of the synchronization signal from the base station 800.

For example, in the 3GPP (for example, the LTE system), as described below, the in-use frequency band is set. For example, a band 5, an E-UTRAN operating band is used in the U.S. The band 5 ranges from 824 to 849 MHz for the uplink (UL) and ranges from 869 to 894 MHz for the downlink (DL).

Furthermore, for example, a band 20, an E-UTRAN operating band is used in Europe. The band 20 ranges from 832 to 862 MHz for the uplink and ranges from 791 to 821 MHz for the downlink.

Furthermore, for example, a band 1, an E-UTRAN operating band, is used in Japan. The band 1 ranges from 1920 to 1980 MHz for the uplink and ranges from 2110 to 2170 MHz for the downlink.

When a terminal in the related art is powered on, because the terminal does not know which band a base station in the neighborhood of the terminal uses to implement the communication, the terminal searches all usable bands for a frequency that has a received power (for example, the RSRP or the RSSI) equal to or greater than a threshold. This is referred to as the band search. Furthermore, the terminal implements the measurement of the wireless channel quality on the frequency that has the receive power equal to or greater than the threshold.

Furthermore, in a case where the hierarchical cell structure is implemented, at least one portion of an area of a small-sized cell overlaps an area of a large-sized cell. Therefore, when frequencies of the small-sized cell and the large-sized cell are the same, in some cases, the interference occurs, the communication quality deteriorates, and the communication is not possible. Therefore, generally, the frequencies of the small-sized cell and the large-sized cell are made to be different from each other.

In order to reduce an amount of interference, it is desirable that a frequency is different in frequency band from a neighboring frequency. Moreover, a bandwidth of the frequency mentioned here, for example, is 5 MHz in the W-CDMA, and a maximum value of the bandwidth of the frequency is 20 MHz in the LTE. That is, the frequency mentioned here is a frequency with a bandwidth.

In contrast, according to the fourth embodiment, the frequency band that is used in the large-sized cell and the frequency band that is used in the small-sized cell are used appropriately. Accordingly, for example, the small-sized cell may be set not to be selected as a P cell. Furthermore, for example, the large-sized cell may be set not to be selected as an S cell.

For example, for an operator that operates the wireless communication system, multiple bands may be set to be usable. For example, in a case of the LTE system, a band 18 that is an E-UTRA operating band, is set to be a frequency for a P cell, and a band 1 that is an E-UTRA operating band, is set to be a frequency for an S cell. Furthermore, a band 1 may be set to be a frequency for a P cell, and a band 40 may be set to be a frequency for an S cell. The information on the appropriate use of the frequencies is transmitted from the base station 800 to the terminal 900. In contrast, the terminal 900 stores the received information on the appropriate use of the frequencies.

Furthermore, when an operator or a telephone is registered in a subscriber identity module (SIM) card and the like of the terminal 900, the information on the appropriate use of the frequencies may be written. Furthermore, a frequency for the small-sized cell and a frequency for the large-sized cell may be stipulated in units of countries, not in units of operators, and the frequency for the small-sized cell and the frequency for the large-sized cell may be stipulated as LTE specifications.

The terminal 900 implements the band search based on the information on the appropriate use of the frequencies and the threshold that are stored in advance in this manner. For example, the terminal 900 performs the band search based on the information on the appropriate use of the frequencies, in such a manner that the RSSI of the frequency of a cell that is available for connection as a P cell is measured. Then, the terminal 900 compares the measured RSSI with the threshold, and may thus determine a certain cell that has the threshold or above is available for connection as a P cell.

Furthermore, the terminal 900 performs the band search based on the information on the appropriate use of the frequencies, in such a manner that the RSSI of the frequency of a cell that is available for connection as an S cell is measured. Then, the terminal 900 compares the measured RSSI with the threshold, and may thus determine a certain cell that has the threshold or above is available for connection as an S cell.

Moreover, according to the fourth embodiment, an example of the band search in which the RSSI is used is described, but the RSRP or the CQI may be used instead of the RSSI. In this case, for example, based on the information on the appropriate use of the frequencies, the cell selection control unit 925 acquires the RSRP or the CQI of the P cell or the S cell by controlling the wireless channel quality measurement/calculation unit 918, not the band search unit 2210 of the reception wireless unit 911.

### Fifth Embodiment

Portions that distinguish a fifth embodiment from the fourth embodiment are described.

According to the fourth embodiment, the appropriate use in which, with the frequency, it is indicated whether or not a cell is available for connection as a P cell and an S cell. In the appropriate use, the frequency is reusable if positions are a predetermined distance away from each other in such a manner that synchronization signals interfere with each other. However, in a case where, as described above, multiple small cells are arranged, because usable frequencies are limited, there is a concern that the interference will occur.

In contrast, according to the fifth embodiment, for example, it is assumed that rules for the appropriate use of the frequencies of the P cell and of the frequency of the S cell are different from each other as units of areas such as the position-registered area. Accordingly, a configuration of many small cells is possible. The configuration of the rule for the appropriate use of the frequencies for every area is the same as the configuration of the rule for the appropriate use of the cell ID's for every area, which is described according to the fourth embodiment.

As described above, with the system, the base station and the terminal, an erroneous cell selection may be suppressed.

For example, in the related art, the base station notifies the terminal of the priority in the hierarchical cell structure or of an offset in the cell selection information in the cell selection, as the cell selection information. However, although a small cell is set to be selected using the priority or the offset, there is a problem in that the small cell is not necessarily selected. Particularly, as illustrated in FIG. 5B, in a case where, in the hierarchical cell structure, the communication is performed with a large-sized cell being setting to be a P cell and a small-sized cell being setting to be an S cell, when the small-sized cell is selected as the P cell, a communication form that serves a purpose disappears.

For example, in some cases, in the neighborhood of the small-sized cell, the small-sized cell has a greater reception strength than the large-sized cell, and the simple selection of the P cell based on a level of the received strength does not necessarily guarantee that the large-sized cell may be set to be the P cell. Furthermore, in a method in the related art in which the result of the measurement in accordance with the priority is adjusted, with a positional relationship (long or short distance) between the large-sized cell (macro base station) and the terminal, differentiating of the priority of the large-sized cell with respect to the small-sized cell is accomplished. However, in terms of the fact that the configuration information such as the priority is broadcast for delivery, only the same contents are transmitted.

Such a problem will be described in detail below.

Erroneous P Cell Selection

As an example, a case where the cell selection is made based on the received power is described. For example, in a case where the priority of a cell is used, the priority is expressed as a numerical value. Then, it is assumed that the greater the numerical value, the higher the priority. At this time, it is assumed that the cell selection is made based on a value that results from multiplying the priority of the cell and the received power. In this case, if the same received powers are received, a cell that gets higher priority is selected.

However, in this case, it may be estimated that, if there are a cell that gets lower priority but has stronger received power and a cell that gest higher priority but has weaker received power, the selected cells are different from each other. That is, the cell that gets higher priority is not necessarily selected.

Furthermore, as described above, an object in the related art is to preferentially connect to a small-sized cell for low power consumption or for an improvement in spectral efficiency in the terminal. That is, the priority of the small-sized cell is set to be higher than the priority of the large-sized cell. Furthermore, an offset of the small-sized cell is set to be greater than an offset of the large-sized cell. Therefore, in some cases, the small-sized is preferentially selected as a P cell.

In a case where the small-sized cell is selected as the P cell, and only data is set to be transmitted in the small-sized cell, it is difficult to receive a control signal after the channel connection because of the random access and an obstruction occur in a channel configuration such as an S cell addition. Moreover, although the selection is made using the received and the offset, in some cases, the small-sized cell is selected as the P cell in the same manner.

These problems are ones that occurs because the priority and the offset in the related art assumes the no-limitation hierarchical cell structure in which the large-sized is a P cell and the small-sized cell is an S cell.

Erroneous P Cell Selection

In a case where a large-sized cell may be selected as a P cell, it is assumed that a small-sized cell is subsequently selected as an S cell. In the S cell selection, in the same manner as in the P cell selection, the priority or the offset of a cell is used. Here, the priority or the offset in the related art is for selecting one cell, not for using multiple cells.

However, the priority or the offset that is set for the P cell selection is set to be used for the S cell selection as well. As a result, in some cases, the large-sized cell is selected as an S cell, and thus the intended hierarchical cell structure becomes meaningless.

Problem that Occurs Because Only One Offset is Set

First, a case where only one offset may be set is described. For example, a case is considered where if the carrier aggregation is implemented and the macro cell is set to be a P cell and the pico cell is set to be an S cell, when the cell selection is made, an offset that is added to the received power from the P cell is set in such a manner that the P cell is preferentially selected. Moreover, the offset is set to be set regardless of whether or not the carrier aggregation is implemented.

A case is described where the carrier aggregation is implemented and the macro cell (P cell) is preferentially selected. In this case, when (a distance between the terminal and the macro cell)>(a distance between the terminal and the pico cell), in a situation where the propagation loss occurs depending on a distance, the received power R_{X}_{_{—}}_{pico} from the pico cell is stronger than the received power R_{X}_{_{—}}_{macro} from the macro cell.

For this reason, in some cases, despite the fact that the received power offset from the macro cell is set in such a manner that the macro cell is selected, R_{X}_{_{—}}_{macro}+offset<R_{X}_{_{—}}_{pico} and the pico cell is selected instead of the macro cell that has to be selected. Moreover, although (a distance between the terminal and the macro cell)>(a distance between the terminal and the pico cell), in some cases, the pico cell is selected in the same manner.

Furthermore, a case is considered where the described-above offset is set without implementing the carrier aggregation. In a case where (a distance between the terminal and the macro cell)>(a distance between the terminal and the pico cell), although the received power of the macro cell is smaller than the received power of the pico cell, the macro cell is selected by adding the offset.

However, since the carrier aggregation is not implemented, any one of the macro cell and the pico cell may be selected to implement the channel configuration without having to connect to both of the macro cell and the pico cell. Additionally, because the receive power from the pico cell is greater, the wireless channel quality between the terminal and the pico cell is better than the wireless channel quality between the terminal and the macro cell. For this reason, the pico cell has to be selected.

However, the macro cell for implementing the carrier aggregation is preferentially selected and the macro cell that has poor wireless channel quality (or wireless transmission speed) is connected.

In this manner, in some cases, although the offset is set for a certain cell, this does not necessarily guarantee that the cell selection may be implemented as intended. Additionally, when only one offset may be set for a certain cell, supporting of switching, such as one between the implementing and non-implementing of the carrier aggregation is not possible and it is difficult to maintain a flexible operation.

Problem that Occurs Because Only One Offset is Set

Next, a case where only one priority may be set is described. A case is considered where if the carrier aggregation is implemented and the macro cell is set to be a P cell and the pico cell is set to be an S cell, when the cell selection is made, the priority of the macro cell is set to be higher than the priority of the pico cell in such a manner that the P cell is preferentially selected.

Here, for brief description, a case is described where the priority of the macro cell is set to 2 and the priority of the pico cell is set to 1 and the priority of the receive power is multiplied. First, a case is described where the carrier aggregation is implemented and the macro cell is preferentially selected.

In this case, when (a distance between the terminal and the macro cell)>(a distance between the terminal and the pico cell), in a situation where the propagation loss occurs depending on a distance, the received power R_{X}_{_{—}}_{pico} from the pico cell is stronger than the received power R_{X}_{_{—}}_{macro} from the macro cell. In contrast, the priority of the macro cell is set to be higher than the priority of the pico cell in such a manner that the macro cell is selected.

However, in some cases, R_{X}_{_{—}}_{macro}×Pᵣᵢ_{_{—}}_{macro}<R_{X}_{_{—}}_{pico}×Pᵣᵢ_{_{—}}_{pico}, and the pico cell is selected instead of the macro cell that has to be selected. Moreover, Pᵣᵢ_{_{—}}_{macro} is the priority of the macro cell, and Pᵣᵢ_{_{—}}_{pico} is the priority of the pico cell. For example, in some cases, if the priority of the macro cell is set to 2, and the priority of the pico cell is set to 1, when the received power of the macro cell is half or less then half the receive power of the pico cell, the pico cell is selected.

Furthermore, a case is considered where the priority is set without implementing the carrier aggregation. In a case where (a distance between the terminal and the macro cell)>(a distance between the terminal and the pico cell), although the received power of the macro cell is smaller than the received power of the pico cell, the macro cell is selected with the priority.

However, since the carrier aggregation is not implemented, any one of the macro cell and the pico cell may be selected to implement the channel configuration without having to connect to both of the macro cell and the pico cell. Additionally, because the receive power from the pico cell is greater, the wireless channel quality between the terminal and the pico cell is better than the wireless channel quality between the terminal and the macro cell. For this reason, the pico cell has to be selected.

However, the macro cell for implementing the carrier aggregation is preferentially selected and the macro cell that has poor wireless channel quality (or wireless transmission speed) is connected.

In this manner, in some cases, although the priority is set for a certain cell, the cell selection is not selected as intended. Additionally, when only one priority may be set for a certain cell, supporting of switching, such as one between the implementing and non-implementing of the carrier aggregation is not possible and it is difficult to maintain a flexible operation.

Case where it is Difficult to Select a Cell that is Usable as a P Cell when the Cell Reselection is Made

The cell selection on the occasion of the calling is described above. In contrast, there are a case where the terminal is in a camp-on state for a certain cell and does not consecutively receive data for a predetermined time or more, a case where the terminal stops camping on the cell, and a case where the terminal moves to a place other than the previous cell. In these cases, the update or reconfiguration of the channel is accomplished and thus the cell reselection is made. There is a likelihood that, in the cell reselection, in the same manner as in the initial cell selection, the pico cell will be selected and the pico cell is requested to establish the channel connection.

In this manner, in the related art, a problem occurs such as an erroneous cell selection that results from employing the hierarchical cell structure. In contrast, according to each of the embodiment described above, in the hierarchical cell structure, the resource such as the cell ID that varies depending on whether the cell ID is for the P cell or for the S cell is allocated to the transmission of the synchronization signal from the base station, to which the terminal is synchronized. Accordingly, the erroneous selection of the P cell and the S cell in the terminal may be suppressed.

Moreover, according to each of the embodiments described above, a case is described where the carrier aggregation is implemented with two component carriers (that is, the P cell and the S cell). However, the carrier aggregation may be implemented with three or more component carriers by adding the second or later S cell.

Furthermore, a case is described where the embodiments are applied to the LTE-Advanced system. However, the embodiments may be applied, for example, to a system that performs the communication using multiple cells (bands) at the same time with the hierarchical cell structure. Such systems include DC-HSDPA or 4C-HSDPA of the W-CDMA as one example and the like.

Furthermore, in the 3GPP, a structure in which cells are greatly different are arranged is referred to as a heterogeneous network (HetNet), and the hierarchical cell structure is a heterogeneous network as well. That is, it is possible to implement the embodiments on the heterogeneous network.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A wireless communication system comprising:
at least one base station configured to form a plurality of cells including at least one first cell and at least one second cell, each of the at least one first cell being a cell to which a wireless terminal is able to couple without coupling to another cell, each of the at least one second cell being a cell to which a wireless terminal is unable to couple without coupling to another cell, each of the at least one first cell being a cell in which each of at least one first known signal is transmitted in accordance with a first rule, each of the at least one second cell being a cell in which each of at least one second known signal is transmitted in accordance with a second rule; and
a specific wireless terminal configured to:
identify, when the specific wireless terminal couples to no cell, at least one known signal being at least a part of the at least one first known signal based on the first rule, the at least one known signal being received from the at least one first cell,
select a cell being one of the at least one first cell based on the identified at least one known signal, and
couple to the selected cell being one of the at least one first cell.

2. The wireless communication system according to claim 1, wherein
the selecting of a cell being one of the at least one first cell is further based on each channel quality of the at least one first cell measured in the specific wireless terminal.

3. The wireless communication system according to claim 1, wherein
the specific wireless terminal is configured to:
identify, when the specific wireless terminal has coupled to the selected cell being one of the at least one first cell, at least another known signal being at least a part of the at least one second known signal based on the second rule,
select a cell being one of the at least one second cell based on the identified at least another known signal, and
couple to the selected cell being one of the at least one second cell.

4. The wireless communication system according to claim 3, wherein
the specific wireless terminal is configured to:
transmit, when the specific wireless terminal has coupled to the selected cell being one of the at least one first cell, each channel quality of the at least one second cell measured in the specific wireless terminal, to a specific base station forming the selected cell being one of the at least one first cell,
receive information indicating a cell being one of the at least one second cell, from the specific base station, and
couple to the cell indicated by the received information.

5. The wireless communication system according to claim 3, wherein
the selecting of a cell being one of the at least one second cell is further based on each channel quality of the at least one second cell measured in the specific wireless terminal.

6. The wireless communication system according to claim 1, wherein
each of known signals including the at least one first known signal and the at least one second known signal relates to cell identification information of a cell in which each of the known signals is transmitted, and
the first rule and the second rule relate to the cell identification information.

7. The wireless communication system according to claim 1, wherein
the at least one first signal is transmitted using a first frequency band,
the at least one second signal is transmitted using a second frequency band,
the first rule relates to the first frequency band, and
the second rule relates to the second frequency band.

8. The wireless communication system according to claim 7, wherein
the specific wireless terminal is configured to search a frequency band, and
the identifying of the at least one known signal is based on the searched frequency band.

9. The wireless communication system according to claim 7, wherein
the first frequency band is lower than the second frequency band.

10. The wireless communication system according to claim 1, wherein
the specific wireless terminal is configured to receive information indicating the first rule from one of the at least one base station.

11. The wireless communication system according to claim 1, wherein
the first rule and the second rule are based on an area including the at least one first cell and the at least one second cell.

12. The wireless communication system according to claim 1, wherein
each of first coverages of each of the at least one first cell is larger than each of second coverages of each of the at least one second cell, and
each of second coverages is included in at least one of the first coverages.

13. The wireless communication system according to claim 1, wherein
each of the at least one first cell is a primary cell of carrier aggregation (CA) of Long Term Evolution (LTE), and
each of the at least one second cell is a secondary cell of the CA.

14. The wireless communication system according to claim 1,
the at least one first known signal and the at least one second known signal are synchronization signals of Long Term Evolution (LTE).

15. The wireless communication system according to claim 1,
the coupling to the selected cell being one of the at least one first cell corresponds to being RRC_CONNECTED state of Long Term Evolution (LTE).

16. A wireless terminal comprising:
an antenna configured to communicate with at least one base station forming a plurality of cells including at least one first cell and at least one second cell, each of the at least one first cell being a cell to which a wireless terminal is able to couple without coupling to another cell, each of the at least one second cell being a cell to which a wireless terminal is unable to couple without coupling to another cell, each of the at least one first cell being a cell in which each of at least one first known signal is transmitted in accordance with a first rule, each of the at least one second cell being a cell in which each of at least one second known signal is transmitted in accordance with a second rule; and
a processor configured to:
identify, when coupling to no cell, at least one known signal being at least a part of the at least one first known signal based on the first rule, the at least one known signal being received from the at least one first cell,
select a cell being one of the at least one first cell based on the identified at least one known signal, and
couple to the selected cell being one of the at least one first cell.

17. A wireless communication method comprising:
forming a plurality of cells including at least one first cell and at least one second cell by at least one base station, each of the at least one first cell being a cell to which a wireless terminal is able to couple without coupling to another cell, each of the at least one second cell being a cell to which a wireless terminal is unable to couple without coupling to another cell, each of the at least one first cell being a cell in which each of at least one first known signal is transmitted in accordance with a first rule, each of the at least one second cell being a cell in which each of at least one second known signal is transmitted in accordance with a second rule;
identifying by a specific wireless terminal, when the specific wireless terminal couples to no cell, at least one known signal being at least a part of the at least one first known signal based on the first rule, the at least one known signal being received from the at least one first cell;
selecting by the wireless specific terminal, a cell being one of the at least one first cell based on the identified at least one known signal; and
coupling by the specific wireless terminal, to the selected cell being one of the at least one first cell.
